(19) United States
(12) Patent Application Publication
(10) Pub. No.: US 2007/0276537 A1
(43) Pub. Date: Nov. 29, 2007

(54) Products and Processes for Promotions Which Employ a Vending Machine

(75) Inventors: Jay S. Walker, Ridgefield, CT (US); Daniel E. Tedesco, Shelton, CT (US); Paul T. Breitenbach, Wilton, CT (US); Robert C. Tedesco, Fairfield, CT (US); Geoffrey M. Gelman, Brooklyn, NY (US)

Correspondence Address: WALKER DIGITAL MANAGEMENT, LLC, 2 HIGH RIDGE PARK, STAMFORD, CT, 06905, US

(73) Assignee: WALKER DIGITAL, LLC, Stamford, CT (US)

(21) Appl. No.: 10/580,975

(22) PCT Filed: Dec. 8, 2004
(86) PCT No.: PCT/US04/40974

§ 371 Date: Jun. 11, 2007

Related U.S. Application Data
(60) Provisional application No. 60/527,899, filed on Dec. 8, 2003.

(51) Int. Cl. G06F 17/00

(52) U.S. Cl. 700/238

(57) ABSTRACT

Products and processes are provided for receiving, from a customer via a vending machine, a selection of a first product that is available for dispensing by the vending machine. It is then determined, based on profit inventory management data, a set of products that are available for dispensing by the vending machine. A game is output to the customer; Via the game, a selection of a product from the set of products is received. The selected product and the first product are vended.

The present application claims the benefit of priority of Provisional Patent Application, Ser. No. 60/527899. The entirety of this application is incorporated herein by reference as part of the present disclosure.

### BACKGROUND

The prior art does not provide any successful modes of providing a vending machine with game functionality. One impediment is that games requiring a great deal of customer interaction (e.g., customer input, customer attentiveness) can be complicated or can take an unduly long time to play, leading to the formation of lengthy lines of customers. Such impediments can aggravate customers and potential customers, and thus negatively effect profits of the vending machine absent ameliorating mechanisms.

### BRIEF DESCRIPTION OF THE DRAWINGS

FIG. 1 is a block diagram of an embodiment of a vending machine.

FIG. 2 is a block diagram of an embodiment in which software is categorized according to different components.

FIG. 3 is an illustration of potential product entitlement game results.

FIG. 4 is an illustration of potential bonus benefit game results.

FIG. 5 depicts an example display output by a vending machine according to an embodiment of the invention.

FIG. 6 depicts an example display output by a vending machine according to an embodiment of the invention.

FIG. 7 depicts an example display output by a vending machine according to an embodiment of the invention.

FIG. 8 depicts an example display output by a vending machine according to an embodiment of the invention.

FIG. 9 depicts an example display output by a vending machine according to an embodiment of the invention.

FIG. 10 depicts an example display output by a vending machine according to an embodiment of the invention.

FIG. 11 depicts an example display output by a vending machine according to an embodiment of the invention.

FIG. 12 depicts an example display output by a vending machine according to an embodiment of the invention.

FIG. 13 depicts an example display output by a vending machine according to an embodiment of the invention.

FIG. 14 depicts an example display output by a vending machine according to an embodiment of the invention.

### DETAILED DESCRIPTION

In the following description, reference is made to the accompanying drawings that form a part hereof, and in which is shown, by way of illustration, specific embodiments in which the invention may be practiced. These embodiments are described in sufficient detail to enable those skilled in the art to practice the invention, and it is to be understood that other embodiments may be utilized and that structural, logical, software, and electrical changes may be made without departing from the scope of the present invention. The following description is, therefore, not to be taken in a limiting sense.

Numerous embodiments are described in this patent application, and are presented for illustrative purposes only. The described embodiments are not intended to be limiting in any sense. The invention is widely applicable to numerous embodiments, as is readily apparent from the disclosure herein. Those skilled in the art will recognize that the present invention may be practiced with various modifications and alterations. Although particular features of the present invention may be described with reference to one or more particular embodiments or figures, it should be understood that such features are not limited to usage in the one or more particular embodiments or figures with reference to which they are described.

The terms “an embodiment”, “embodiment”, “embodiments”, “the embodiment”, “the embodiments”, “one or more embodiments”, “some embodiments”, and “one embodiment” mean “one or more (but not all) embodiments of the present invention(s)” unless expressly specified otherwise.

The terms “including”, “comprising” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

Further, although process steps, method steps, algorithms or the like may be described in a sequential order, such processes, methods and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously.

It will be readily apparent that the various methods and algorithms described herein may be implemented by, e.g., appropriately programmed general purpose computers and computing devices. Typically a processor (e.g., a microprocessor) will receive instructions from a memory or like device, and execute those instructions, thereby performing a process defined by those instructions. Further, programs that implement such methods and algorithms may be stored and transmitted using a variety of known media.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

The functionality and/or the features of a device may be alternatively embodied by one or more other devices which are not explicitly described as having such functionality/features. Thus, other embodiments of the present invention need not include the device itself.

The term “computer-readable medium” as used herein refers to any medium that participates in providing data (e.g., instructions) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols, such as Bluetooth, TDMA, CDMA, 3G.

Where databases are described, it will be understood by one of ordinary skill in the art that (i) alternative database structures to those described may be readily employed, (ii) other memory structures besides databases may be readily employed. Any schematic illustrations and accompanying descriptions of any sample databases presented herein are exemplary arrangements for stored representations of information. Any number of other arrangements may be employed besides those suggested by the tables shown. Similarly, any illustrated entries of the databases represent exemplary information only; those skilled in the art will understand that the number and content of the entries can be different from those illustrated herein. Further, despite any depiction of the databases as tables, an object-based model could be used to store and manipulate the data types of the present invention and likewise, object methods or behaviors can be used to implement the processes of the present invention.

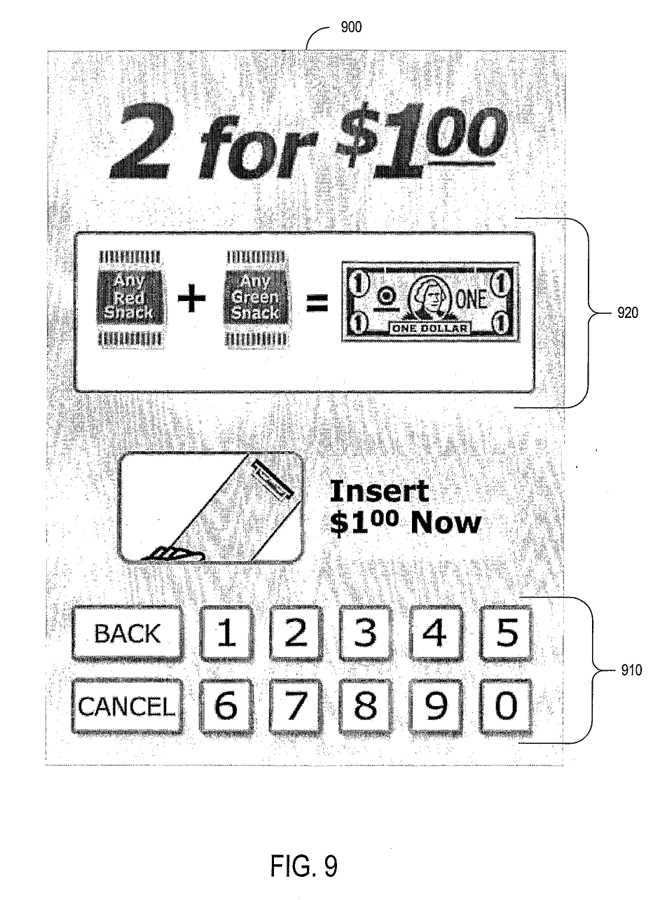

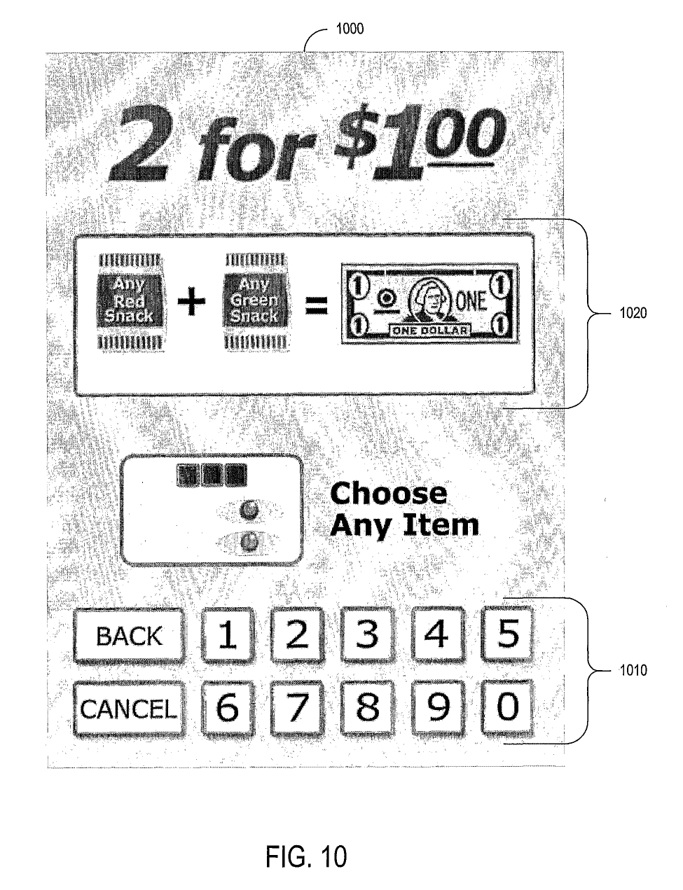

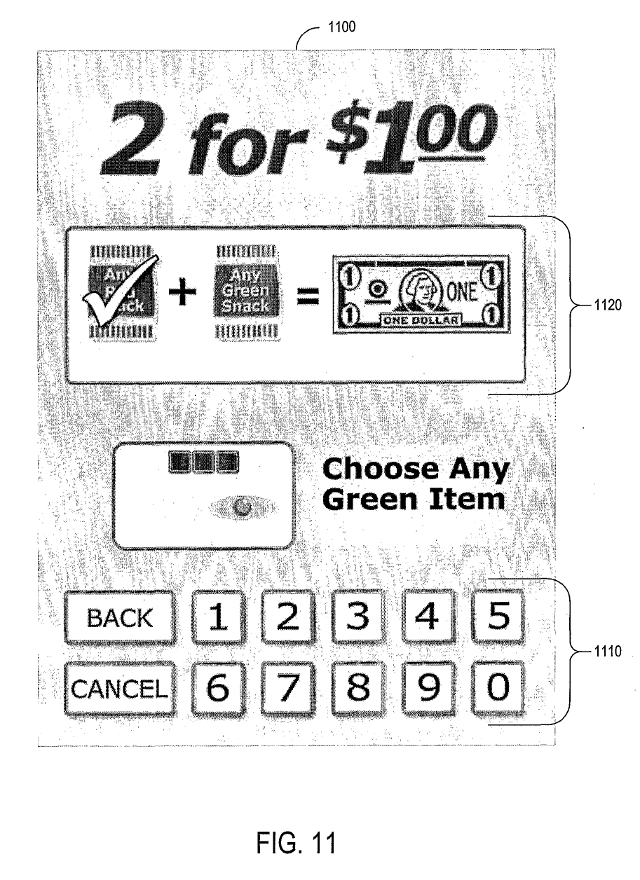

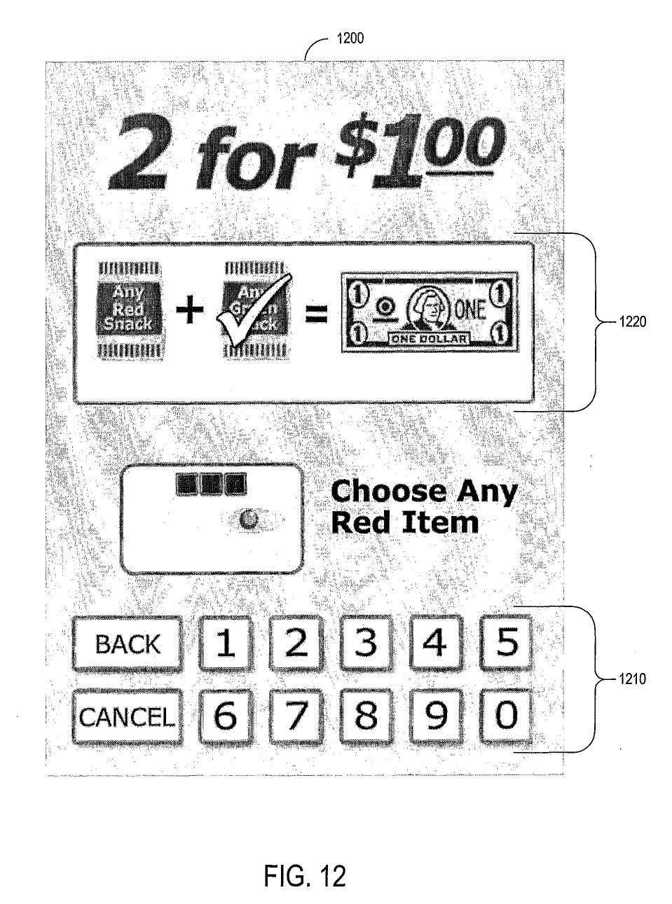

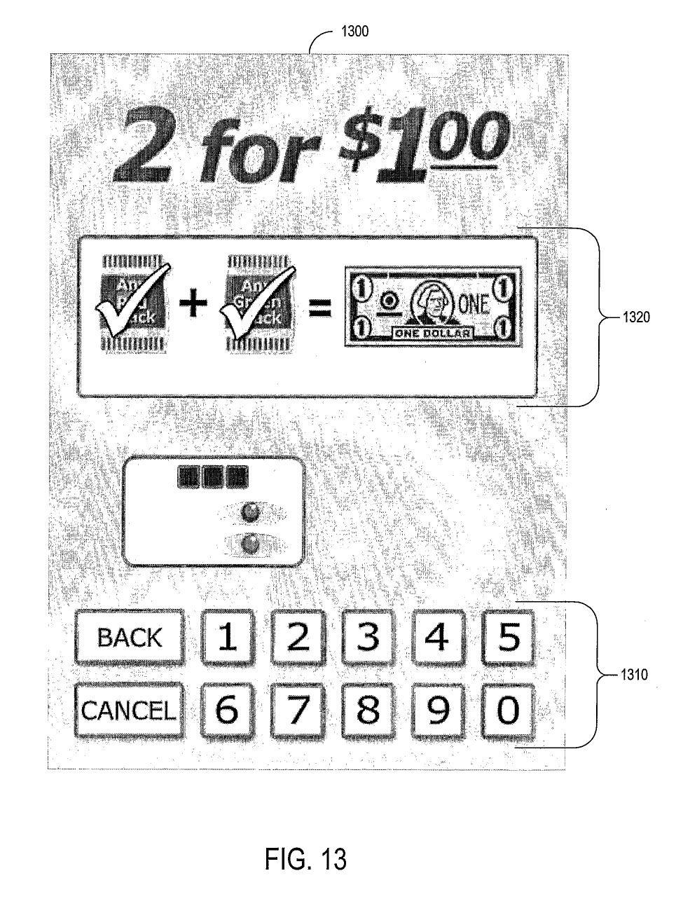

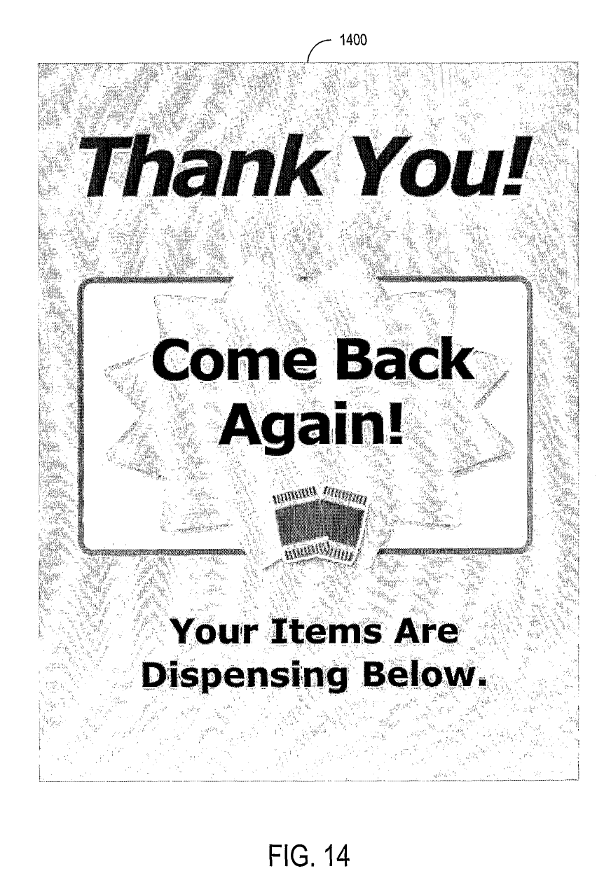

The following terms are defined as indicated below, unless explicitly described otherwise:
Actual Velocity, Actual Sales Rate—The rate at which a given product is sold by a vending machine during a sales period (e.g. 2.5 units per day).
Benefit, Prize—An entitlement that is selected for a customer with the goal of increasing the profitability (e.g., of a particular transaction, of overall vending machine expected profitability). In some embodiments, the entitlement can be so selected and then offered to a customer in accordance with a profit management rule, and by offering certain products or promotions, profit may be increased. In some embodiments, a vending machine may present at least one benefit offer to a customer during a vending machine transaction, which may present the customer with an opportunity to accept and/or redeem one or more benefits. In some embodiments, a benefit may be categorized as either a product benefit or a general benefit.
   A product benefit includes (i) a specific product that a customer may select, and/or (ii) an inventory group from which a customer may select one or more products (e.g. during a vending machine transaction). Inventory groups may be indicated and/or defined as specified in co-pending U.S. patent application Ser. No. 10/902,397, filed on Jul. 29, 2004, the entirety of which is incorporated herein by reference as part of the present disclosure.
   A general benefit is a benefit other than a product benefit, and may comprise one or more of the following: (i) a discount or “promotional price” for one or more products (or a group thereof), (ii) a refund of the purchase price (or portion thereof) of one or more previously selected products, (iii) a dynamically priced upsell, (iv) a fixed price upsell, (v) free or discounted alternate, non-food products (e.g. a phone card not typically sold during routine machine transactions), (vi) a sweepstakes or contest entry, (vii) a free or discounted vending machine subscription or membership, (viii) an opportunity to procure additional benefits (e.g. a “free spin” of a “prize wheel” game-themed presentation), (ix) one or more additional product benefits (e.g. “bonus” products), and/or (x) any other entitlements.
      Accordingly, in some embodiments, the prices and/or promotions of a vending machine may be dynamically constructed in a manner favorable to both consumers (who receive benefits as the result of entertaining game-themed presentations) and vending machine operators (who may experience increased profits).
Dilution, Price Dilution—The negative effect on profitability that may ensue when a product is sold for a price lower than a given customer otherwise would have paid for the product. In some embodiments, the potential for dilution is factored into stored profit management rules for determining benefit offers. Thus, in some embodiments, vending machines may be programmed to eliminate or reduce the effects of dilution by picking those benefit offers (e.g. products) that are less likely to result in dilution, or are more likely to result in less dilution.
Diversion—The negative effect on profitability that ensues when a lower price or lower profit item is sold to a customer instead of a higher price or higher profit product that the customer otherwise may have purchased. In some embodiments, the potential for diversion is factored into stored rules for constructing benefit offers. Thus, in some embodiments, vending machines may be programmed to eliminate or reduce the effects of diversion by picking those benefit offers that are less likely to result in diversion.
Dynamically Priced Upsell, Dynamic Upsell, Spare-Change Upsell, “Round-Up” Offer—An offer to a customer of a first product for the purchase of an additional product in exchange for an additional amount that is equal to an amount of change due back to the customer as a result of the customer's purchase of the first product.
Entitlement, Prize—In some embodiments, entitlements comprise an inventory group from which customers may select one or more products. In some embodiments, entitlements are unique, transaction-specific prices that are determined based on a revenue management process. Also, coupons, discounts, refunds, “free spins,” credit balance increases, phone cards, upsells, package improvements, etc.
Expected Profitability—An anticipated profit amount associated with (i) a particular vending machine transaction, and/or (ii) a particular vending machine sales period (e.g. fill period). In some embodiments, calculating the expected profitability of one or more vending machine transactions involves a probability measure, which may estimate the likelihood that a vending machine may sell one or more product units over a period of time given, for example, one or more particular prices. In some embodiments, a probability measure may be estimated based on historic sales data. For example, if 20 days into a 30-day vending machine fill period, Snickers® has sold at an actual velocity of 1.5 units per day, it may be considered probable that Snickers® will continue to sell at the same velocity for the remainder of the fill period (10 days). Thus, if the margin of Snickers® is $0.20, a vending machine operator might expect that Snickers® sales would generate an additional $3.00 in profit before the fill period is over (1.5 units×10 days×$0.20).
Fill Period, Sales Period—The period of time between restock dates.
Fixed Price Upsell Offer, Fixed Price Upsell—An offer to a customer of a first product for the purchase of an additional product in exchange for an additional amount that is not necessarily correlated with an amount of change due back to the customer as a result of the customer's purchase of the first product. In some embodiments, a customer who has purchased a first product and is thereby due change may be required to deposit additional currency in order to accept a fixed price upsell offer. Thus, the fixed price upsell offer may require that the customer pay an amount equal to his or her change due plus an additional amount of currency.
Full Price, Retail Price—The price conventionally charged by a vending machine operator for the purchase of a given product. In some embodiments, benefit offers may present customers with the opportunity to purchase items at less than full price.
Game-Themed Presentation, Game-Theme Data, Game-Themed Content—In some embodiments, a presentation outputted to a customer via a vending machine output device (e.g. a touch-screen LCD, LED display, etc.). Game-themed presentations may be outputted for several purposes, including but not limited to (i) entertaining a customer, and/or (ii) offering a benefit to a customer (e.g. a game result is “You won a free Snickers® Bar”).
Game Result, Game Outcome—In various embodiments, a game-themed presentation may conclude (e.g. an animation sequence ends) by outputting a game result to a vending machine customer (e.g. via an input/output device). For example, as a “prize wheel” animation concludes (e.g. the wheel stops spinning), a determined benefit is presented to a customer (e.g. the wheel stops on “Pick any blinking green item!”). In some embodiments, a game result may comprise (i) at least one benefit offer, (ii) one or more benefit offers from which a customer may select at least one benefit, (iii) a marketing message (e.g. “Play again tomorrow!”), and/or (iv) any combination of the above. In some embodiments, a game result may be determined before a game-themed presentation is outputted. In other embodiments, a customer may influence a game result (e.g. by pressing a “stop” button during a “prize wheel” game). In further embodiments, a game result may be determined before game-theme data is outputted, though a customer may have a perceived influence over a game result. In still further embodiments, a game result may be determined by a combination of skill (i.e. player influence) and profit management rules.
Ideal Product Velocity, Target Product Velocity, Target Velocity, Target Sales Rate—The desired rate at which a given product should be sold by a vending machine during a sales period. Thus, in some embodiments, an ideal velocity may be set or calculated for each product indicating the rate at which products must be sold in order to deplete the inventory to a certain level by the end of a given sales period (i.e. by the restock time). For example, an ideal product velocity may be calculated by a vending machine control system after an operator inputs a restock date and a desired remaining inventory for the date (e.g. an operator may wish to have only 1 of each item remaining at the restock date so that the machine sells as many items as possible without completely selling out and thereby disappointing customers). Thus, if an operator (a) stocks 50 units of Soda A, (b) inputs a restock date 14 days away, and (c) indicates that only one unit of Soda A should remain at the restock date, the control system may divide 49 by 14 to conclude that, on average, 3.5 units must be sold per day within the sales period in order to realize the ideal product velocity. As discussed herein, a vending machine control system may periodically, substantially continuously, or otherwise determine whether or not actual item velocity is at least equal to the ideal item velocity, and if not, may output one or more benefit offers as discussed herein. An ideal product velocity may be further set so that if such a velocity is reached, the increase in volume will sufficiently offset any discounts afforded to customers through promotions or the provision of one or more benefits.
Operator—The owner (or agent thereof) of a vending machine.
Package Deal, Package Offer, Combo Deal, 2-for-1 Package, 2-for-1 Deal—An offer enabling a customer to purchase (e.g. during one vending machine transaction) at least two products for a single price (i.e. “package price”). Typically, package offers are configured to result in a net-savings to the customer when compared to the sum of the individual component products' retail prices. In some embodiments, a package deal comprising at least two component products may include at least one first component product (e.g. the first product selected by a customer of a “2-for-$1” machine) and at least one additional component product (e.g. the second component product provided by the machine so as to complete a package deal).
Package Deal Machine, “2-for-1” Machine, “2-for-$1 ” Machine, Package Deal Vending Machine, “2-for-1” Vending Machine—In some embodiments, a “2-for-1” machine may be configured exclusively to offer package deals (e.g. customers must purchase at least two products during every transaction). In other embodiments, a “2-for-1” machine may be configured to process standard, one-item transactions as well as package deal transactions. Package deal vending machines may be characterized by appropriate, visible marketing signage (e.g. a placard reading: “2-for-$1 Vending Machine”) so customers may understand that typical transactions exclusively involve the purchase of multiple items for a single price (FIGS. 9-14 illustrate exemplary input/output device “screenshots” of such a vending machine, each with reference to customer directions and customer input buttons). Conversely, signage of a single product vending machine may not explicitly promote package deals (i.e. so that customers assume transactions typically involve the purchase of only one product), though such a machine may indeed be capable of processing package deal transactions.
Product, Item—A good or service sold by a vending machine. Examples of goods sold at vending machines include beverages (e.g. cans of soda) and snacks (e.g. candy bars). Examples of services sold by vending machines include car washes, photography services and access to digital content (e.g. permitting the downloading of MP3 files to a handheld device).
Product Data, General Product Data—Information associated with the inventory of vending machine. Product data may be stored in a product database, which may be updated on a periodic, substantially continuous or event-triggered basis (e.g. after every transaction) so as to reflect changes to product data. In some embodiments, product data may comprise (i) inventory quantity (e.g. n units of product x remain in the machine), (ii) cost data (e.g. the unit cost associated with one or more vending machine products), (iii) sales data (e.g. actual sales rate, ideal sales rate, etc., of one or more vending machine products), and/or (iv) fill period status (e.g. days remaining until the next restock date). In this manner, product data may be retrieved for the purpose of facilitating the profit management of a vending machine.
Profit Inventory Management (PIM)—The practice of managing the sale of products so as to increase a vending machine's profitability during a sales period. In some embodiments, a vending machine is programmed to evaluate sales data in light of stored rules indicative of a profit goal. For example, stored rules may indicate an ideal product velocity that would tend to increase the machine's profitability. The machine may determine that, based on current sales data, the ideal product velocity (for a given product or group of products) will not be achieved based on current promotions, prices, or other sales parameters. In response, the vending machine may execute multi-variant equations to identify, construct and offer a promotion to a customer with the goal of achieving the ideal product velocity (for a given product or group of products).
Profit Management, Profit Management Practice, Revenue Management, Revenue Management Practice—The practice of managing the sale and/or promotion of vending machine products so as to increase a vending machine's profitability (e.g. during a sales period). In some embodiments, a vending machine is programmed to evaluate product data in light of stored profit management rules indicative of a profit goal. For example, stored profit management rules may indicate an ideal product velocity (e.g. for each product of a vending machine) that would tend to increase the machine's profitability. The machine may determine that, based on current product data, the ideal product velocity (for a given product or group of products) may not be achieved based on current prices, promotions and benefit offers. In response, the vending machine may evaluate product data in light of profit management rules to identify, construct and/or offer one or more benefits to a customer (e.g. in the form of game results) with the goal of achieving the ideal product velocity (for a given product or group of products).
Restock Date, Restock Time—The time and/or date that a vending machine is scheduled to be restocked by an operator (or agent thereof) of a vending machine.

### 1. OVERVIEW OF EXAMPLE EMBODIMENTS

According to some embodiments of the present invention, a customer may approach a vending machine that provides “2-for-1” sales (e.g., two items for a dollar). The customer deposits currency (e.g. $1.00) and selects the first of two items to purchase. In response, the vending machine initiates a “game” (e.g., a spinning wheel to indicate one of a plurality of possible results) to automatically determine a “game result”. The game result may be selected from a group that consists of the following results:
1. An inventory group that has been defined and indicated (e.g., as specified in a “reactive grouping” embodiment of co-pending U.S. patent application Ser. No. 10/902,397, filed on Jul. 29, 2004), a second item is selected from the inventory group, and that second item is provided;
2. A second item and another benefit (e.g., coupon, refind, phone card, free spin of the wheel, subscription, fixed-price upsell for additional product, alternate first product offer, free second item) are provided;
3. No second item or other benefit is provided (“game over”);
4. No second item, but a benefit is provided;
5. An inventory group is defined and indicated (e.g., as specified in a “reactive grouping” embodiment of co-pending U.S. patent application Ser. No. 10/902,397, filed on Jul. 29, 2004) and the customer can select one item from this inventory group; and
6. An inventory group is indicated and the customer can select one item from this inventory group, and also another benefit is provided.

According to some embodiments of the present invention, a customer may approach a vending machine that provides “2-for-1” sales (e.g., two items for a dollar). The customer deposits currency (e.g. $1.00) and selects two items to purchase (e.g., one each from a first inventory group and second inventory group). In response, the vending machine initiates a “game” (e.g., a spinning wheel to indicate one of a plurality of possible results) to automatically determine a “game result”. The game result may be selected from a group that consists of the following results:
1. “Improve” a first inventory group (e.g., provide an option allowing the customer to select an alternate to the first product he selected);
2. “Improve” second inventory group (provide an option allowing the customer to select an alternate to the second product he selected);
3. “Improve” both inventory groups (provide an option allowing the customer to select alternates to the products he selected);
4. Provide another benefit as well as one of the above improvements to one or both inventory groups;
5. Provide another benefit.

According to some embodiments of the present invention, a customer may approach a vending machine. The customer deposits currency (e.g. $1.00) and selects an item to purchase (e.g., a $0.65 candy bar). In response, the vending machine initiates a “game” (e.g., a spinning wheel to indicate one of a plurality of possible results) to automatically determine a “game result”. The game result may be selected from a group that consists of the following results:
1. Provide a coupon;
2. Game over (no benefit provided);
3. Provide a non-inventory prize (e.g., provide a phone card);
4. Provide one or more “inventory prizes” (e.g., provide one or more products that might otherwise have been purchased form the vending machine);
5. Provide a subscription to products at the vending machine (“Membership”);
6. Provide a refund on the price of the first product;
7. Provide a discount or “special price” for the first product;
8. Provide a “fixed-priced upsell” (add $0.50 to the credit of the machine, allowing the customer to purchase a second product having a higher price);
9. Provide a “dynamically-priced upsell” (provide a second product for $0.35, thus giving the customer no change form a dollar tendered);
10. Provide one or more additional “spins” (i.e. one or more additional game results);
11. provide any combination of above game results.

According to some embodiments of the present invention, the vending machine initiates a “game” (e.g., a spinning wheel to indicate one of a plurality of possible results) to automatically determine a “game result”. In some embodiments, the customer can influence or appear to influence the game result through various actions, such as:
1. Pressing a button to “stop” a spinning wheel, slot reels or other indicia that a game result is to be determined/to be presented;
2. Answering trivia questions;
3. Choosing numbers, such as lottery/roulette/bingo numbers;
4. Uncovering masked game result (e.g., selecting “Door #3”);
5. Playing a “shell game” (selecting products under hats or shells that are shuffled);
6. “Catching” a game result (e.g. in basket).
   The influence may be actual (i.e., the customer input is used in determining the game result) or perceived (i.e. the customer input is not used in determining the game result).
   1. Introduction

Applicants have previously recognized ways to make vending machines more profitable by, for example, dynamically responding to market forces with variable pricing and promotional offers.

For example, Applicants' co-pending U.S. patent application Ser. No. 08/947,798, filed Oct. 9, 1997, (incorporated herein by reference) enables the automated, dynamic pricing of vended products based on stored rules that consider up-to-date supply and demand data gathered when no human salesperson is present (i.e. during the sales period prior to a restock date). Applicant's co-pending U.S. patent application Ser. No. 10/095,372 filed Mar. 11, 2002, (incorporated herein by reference) enables the automated, dynamic configuration of promotional product combinations based on supply and demand data. Applicant's co-pending U.S. patent application Ser. No. 09/218,085, filed Dec. 22, 1998, (incorporated herein by reference) enables the automatic selection of products for customers based on supply and demand data. Applicant's co-pending U.S. patent application Ser. No. 09/345,092, filed Jun. 30, 1999, (incorporated herein by reference) enables the presentment of offers for substitute products based on supply and demand data.

In some embodiments of Applicant's prior inventions, revenue management or profit management processes for changing prices and promotions are executed by vending machine processors periodically (e.g. every evening) so that all customers within a given time period (e.g. each day) are presented with the same offers. In this manner, customers are less likely to complain that previous customers within the same time period (e.g. other customers that day) were treated more favorably (e.g. offered better prices, more valuable promotions, etc.).

However, Applicants have also recognize that continuous executions of such inventory management processes can be advantageous in some situations, because such executions permit adjustments to prices and promotions that are based on real-time changes in supply and demand, and that are potentially more responsive, dynamic and/or fluid. Accordingly, other embodiments of Applicant's prior inventions permit the substantially continuous or event-triggered (i.e. post-transaction) executions of such processes.

Although many customers may understand and indeed welcome such dynamically changing promotions and prices, customers accustomed to fixed prices may resist dynamically changing prices. When the Coca-Cola Company announced a vending machine that employed a variable price, the public's reaction was less than ideal. Some critics perceived such practices as “unfair” and “exploitive.” See “Coke Tests Vending Unit That Can Hike Prices in Hot Weather”, C. Hayes, THE NEW YORK TIMES, Oct. 28, 1999; see also “Coke's Automatic Price Gouging”, THE SAN FRANCISCO CHRONICLE, Oct. 29, 1999.

Thus, some embodiments of the invention are advantageous in that they can make dynamic executions of revenue management processes more palatable to those customers who may otherwise resist dynamically-changing prices and promotions.

2. Vending Machines

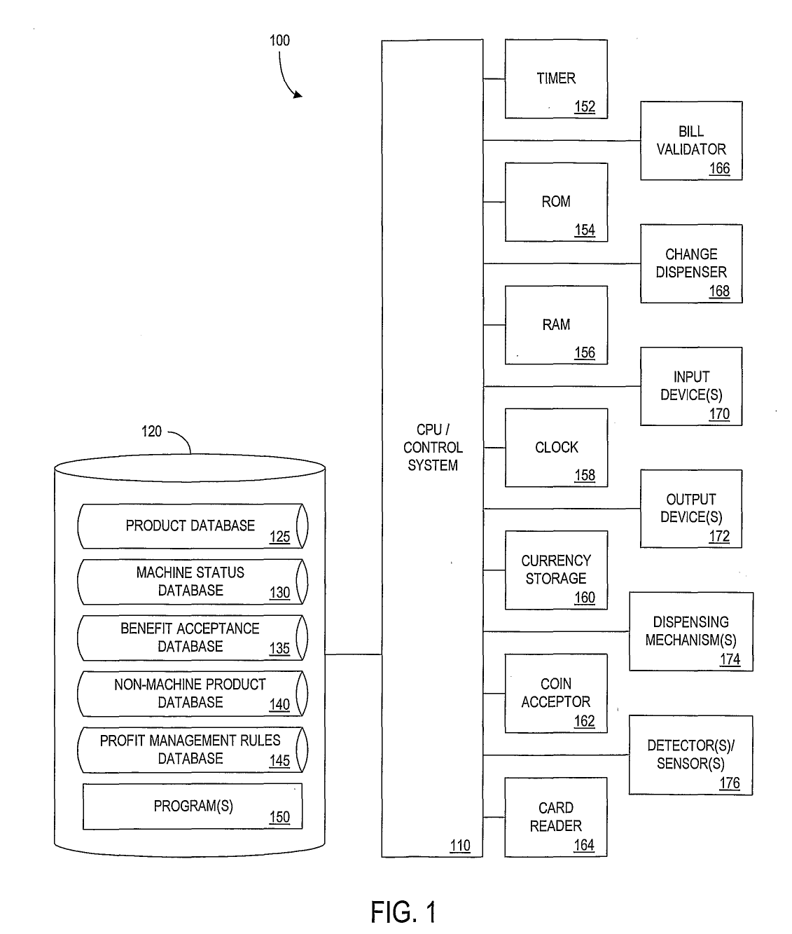

Generally, with reference to FIG. 1, a vending machine 100 may comprise a device, or communicate with a device (e.g., a server, a peripheral device, and/or a peripheral device server), configured to manage sales transactions with customers by, among other things, receiving payment from customers, controlling the pricing and/or distribution (dispensing) of goods and/or controlling entitlements to services.

As used herein, a product is a good or service sold by a vending machine. Examples of goods sold at vending machines include beverages (e.g. cans of soda; bottles of water or iced tea) and snacks (e.g. candy bars; bags of chips). Examples of services sold by vending machines include car washes, photography services and access to digital content (e.g. permitting the downloading of MP3 files or cellular telephone “ring tones” to a handheld device such as an iPod™ device or cellular telephone).

As is well known, an operator is used to denote an owner (or agent thereof) of a vending machine. In one or more embodiments, an operator is a “route driver” or other service person that services one or more vending machines by restocking vending machines, and/or removing or depositing currency in vending machines.

A vending machine may include a processor 110, such as one or more Intel® Pentium® or Centrino™ processors. The processor may include, or be coupled to, (i) one or more clocks or timers, and (ii) one or more communication ports through which the processor may communicate, in accordance with some embodiments, with other devices such as one or more peripherals, controllers and POS terminals. In one or more embodiments, a communication port may comprise a modem (e.g. a cellular modem or otherwise), a wireless transmitter and/or a transponder (e.g. an infrared transmitter/receiver, a radio transmitter/receiver).

The processor may also be in communication with a data storage device 120. The data storage device may include any appropriate combination of magnetic, optical and/or semiconductor memory, and may include, for example, additional processors, communication ports, Random Access Memory (“RAM”), Read-Only Memory (“ROM”), a compact disc and/or a hard disk. The processor and the storage device may each be, for example: (i) located entirely within a single computer or other computing device; or (ii) connected to each other by a remote communication medium, such as a serial port cable, a LAN, a telephone line, radio frequency transceiver, a fiber optic connection or the like. In some embodiments for example, the vending machine may comprise one or more computers (or processors) that are connected to a remote server computer operative to maintain databases, where the data storage device is comprised of the combination of the remote server computer and the associated databases.

The data storage device stores a program 150 for controlling the processor. The processor performs instructions of the program, and thereby can operate in accordance with one or more embodiments of the present invention, and particularly in accordance with the methods described in detail herein. An appropriate computer program can be developed using an object oriented language that allows the modeling of complex systems with modular objects to create abstractions that are representative of real world, physical objects and their interrelationships. However, it would be understood by one of ordinary skill in the art that the embodiments of the invention as described herein can be implemented in many different ways using a wide range of programming techniques as well as general purpose hardware systems or dedicated controllers.

The program may be stored in a compressed, uncompiled and/or encrypted format. The program furthermore may include program elements that may be generally useful, such as an operating system, a database management system and device drivers for allowing the processor to interface with computer peripheral devices. Appropriate general purpose program elements are known to those skilled in the art, and need not be described in detail herein.

Further, the program is operative to execute a number of invention-specific, objects, modules and/or subroutines, as disclosed herein.

According to some embodiments of the present invention, the instructions of the program may be read into a main memory of the processor from another computer-readable medium, such from a ROM 154 to a RAM 156. Execution of sequences of the instructions in the program can cause the processor to perform the process steps of one or more embodiments of the invention. In alternative embodiments, hard-wired circuitry or integrated circuits may be used in place of, or in combination with, software instructions for implementation of the process steps of one or more embodiments of the invention. Thus, embodiments of the present invention are not limited to any specific combination of hardware, firmware, and/or software.

A vending machine may comprise payment processing mechanism(s), which may comprise one or more mechanisms for receiving payment and dispensing change (e.g., a coin acceptor 162, a bill validator 166, a card reader 164, a magnetic stripe reader, a change dispenser 168).

In a manner known in the art, a magnetic stripe card reader may read data on the magnetic stripe of a credit or debit card, and it may cooperate with conventional point-of-sale credit card processing equipment to validate card-based purchases through a conventional transaction authorization network. Suitable card-based transaction processing systems and methods are available from USA Technologies, Inc., of Malvern, Pa.

The coin acceptor, bill validator and change dispenser may communicate with a currency storage apparatus 160 (a “hopper”) and may comprise conventional devices such as models AE-2400, MC5000, TRC200 by Mars, Inc. of West Chester, Pa., or CoinCo model 9300-L.

The coin acceptor and bill validator may receive and validate currency that is stored by the currency storage apparatus. Further, a bill validator or coin acceptor may be capable of monitoring stored currency and maintaining a running total of the stored currency, as is discussed with reference to U.S. Pat. No. 4,587,984, entitled COIN TUBE MONITOR MEANS, the entirety of which is incorporated by reference herein for all purposes. The change dispenser activates the return of coinage to the customer where appropriate. Such apparatus may feature Multidrop Bus (MDB) and/or Micromech peripheral capabilities, as is known in the art.

In another embodiment, a vending machine in accordance with the present invention may be configured to receive payment authorization and product selection commands through a wireless device communication network, directly or indirectly, from a customer device (e.g. a cellular telephone). In such an embodiment, a payment processing mechanism may comprise a cellular transceiver operatively connected to a processor, as described herein. Systems and methods allowing for the selection of and payment for vending machine products through cellular telephones are provided by USA Technologies, Inc. Further, in such an embodiment, a customer cellular telephone may serve as an input/output device, as described herein.

Further details concerning vending machine payment processing mechanisms are well known in the art.

A vending machine may further comprise one or more output devices 172 and one or more input devices 170. Any number of output devices and/or input devices may be included in the vending machine.

In accordance with embodiments of the presenting invention, a vending machine may include an input device for receiving input from a customer, operator, or other person. Also, a vending machine may include one or more output devices for outputting product and/or other information to a customer or operator.

Many combinations of input and output devices may be employed in accordance with embodiments of the present invention. For example, in embodiments which feature touch screens (described herein), input and output functionality may be provided by a single device.

As described, a vending machine may include more than one input device. For example, a vending machine may include an exterior input device for receiving customer input and an interior input device for receiving operator input. In some embodiments, however, the input device provides the dual functionality of receiving input data from both operators and customers.

As also described, a vending machine may comprise more than one output device. For example, a vending machine may include both an Liquid Crystal Display (LCD) screen and several Light Emitting Diodes (LEDs).

An output device may comprise, for example, an LCD and/or one or more LEDs displays (e.g., several alphanumeric LEDs on the shelves of a vending machine, each LED being associated with a row of product inventory).

In one embodiment, an LED display screen may be mounted to a vending machine (e.g., attached thereto, such as via bolts or other mounting hardware). Such a mounted LED display screen and may be used to communicate messages (described herein) to customers. A suitable LED display screen for such an embodiment may be housed in an aluminum case having a length of 27.5″, a height of 4.25″, and a depth of 1.75″. Such a display screen may have a display area capable of showing 13 alphanumeric and/or graphical characters. Further, such an LED display screen may comprise a serial computer interface, such as an RJ45/RS232 connector, for communicating with a processor, as described herein. Further still, such an LED display may be capable of outputting text and graphics in several colors (e.g., red, yellow, green).

Further, in some embodiments, an output device comprises a printer. In one embodiment, a printer is configured to print on card stock paper (e.g. 0.06 mm to 0.15 mm thickness), such as the EPSON EU-T400 Series Kiosk Printer. Further, a printer may be capable of thermal line printing of various alphanumeric and graphical symbols in various font sizes (e.g. raging from 9 to 24 point) on various types of paper. Additionally, such a printer may communicate with a processor (described herein) via an RS232/IEEE 12834 and/or bi-directional parallel connection. Such a printer may further comprise a 4KB data buffer.

Additionally, in some embodiments, an output device comprises an audio module, such as an audio speaker, that outputs information to customers audibly. Speakers may comprise conventional speakers or modern hypersonic speakers. An output device may include unidirectional or hypersonic speakers which can selectively focus sound to particular locations or customers, while not disturbing others who are not in the location of the focused sound. For a description of such speakers, see Suzanne Kantra Kirschner, “We've heard hypersonic sound. It could change everything”, Popular Science, available at http://www.popsci.com/popsci/science/article/0,12543,351353,00.html.

In some embodiments, an output device may comprise a physical device having a game theme, such as a spinning “prize wheel” similar to those featured on the television game show “Wheel of Fortune™” or “The Price is Right™”, a roulette wheel, mechanical slot machine reels, or the like.

Such a wheel may communicate to customers various information. For example, the wheel may spin and stop on an icon which represents, e.g., a prize entitlement. A physical wheel in the general appearance of the wheel on the “Wheel of Fortune” game show may be attached to a vending machine.

Besides a wheel, another output device which is a peripheral device attached to and in communication with the vending machine can communicate game-related information. By utilizing such an output device, conventional vending machines could be retrofitted with a separate device to employ game-themed promotions. The use of removable peripheral devices may be important in certain situations (e.g., where doorways to interior locations are low), as such satellite devices may be removed during transport and attached once vending machines are brought to the intended location. Likewise, such peripheral devices may be side-mounted, where the ceiling height may impair other location of the peripheral. Further, the use of a separate device is advantageous in that it may be in communication with more than one vending machine, allowing many machines to participate in game-themed vending promotions.

An input device may comprise one or more of (1) a set of alpha-numeric keys for providing input to the vending machine, such as the Programmable Master Menu® Keypad, (2) a selector dial, (3) a set of buttons associated with a respective set of item dispensers 174, (4) a motion sensor or other sensor 176, (5) a barcode reader, (6) a Dual-Tone Multi-Frequency (DTMF) receiver/decoder, (7) a wireless device (e.g. a cellular telephone or wireless Personal Digital Assistant), (8) cameras, such as digital video and/or digital still photographic cameras, (9) a voice recognition module, (10) a fingerprint reader, (11) a topical facial pattern scanner/reader, (12) an iris or retinal scanner, (13) a microphone, (14) an infrared receiver, and/or (15) any other device capable of receiving a command from a user and transmitting the command to a processor.

As described, in some embodiments, a touch-sensitive screen may be employed to perform both input and output functions. Suitable, commercially available touch screens for use in accordance with the present invention are manufactured by Elo TouchSystems, Inc., of Fremont, Calif., such as Elo's AccuTouch series touch screens. Such touch screens may comprise: (i) a first (e.g., outer-most) hard-surface screen layer coated with an anti-glare finish, (ii) a second screen layer coated with a transparent-conductive coating, (iii) a third screen layer comprising a glass substrate with a uniform-conductive coating. Further, such touch screens may be configured to detect input within a determined positional accuracy, such as a standard deviation of error less than ±0.080-inch (2 mm). The sensitivity resolution of such touch screens may be more than 100,000 touchpoints/in² (15,500 touchpoints/cm²) for a 13-inch touch screen. For such touch screens, the touch activation force required to trigger an input signal to the processor (described herein) via the touch screen is typically 2 to 4 ounces (57 to 113 g). Additionally, touch screens for use in accordance with embodiments of the present invention may be resistant to environmental stressors such as water, humidity, chemicals, electrostatic energy, and the like. These and other operational details of touch screens (e.g., drive current, signal current, capacitance, open circuit resistance, closed circuit resistance, etc.) are well known in the art.

A vending machine may further comprise one or more inventory storage and dispensing mechanism(s). Product inventory storage and product dispensing functions of a vending machine configured in accordance with a snack machine embodiment of the present invention may include one or more of: (i) a drive motor, (ii) metal shelves, (iii) a product delivery system (e.g. a chute, product tray, product tray door, etc.), (iv) dual spiral (i.e. double helix) item dispensing rods, (v) convertible (i.e. extendable) shelves, and/or (vi) a refrigeration unit.

In some embodiments, a vending machine may be housed in a casing of the model 129 SnackShop manufactured by Automatic Products™. In such embodiments, three removable shelves may be employed, together providing for thirty product rows and an inventory capacity of between 185 and 522 commonly vended snack products.

Inventory storage and dispensing mechanism(s) may comprise one or more of: (i) metal and/or plastic shelving, (ii) item dispensing actuators/motors, (iii) product delivery chutes, and/or (iv) a refrigeration unit. Further details concerning vending machine inventory storage and dispensing mechanisms are well known in the art.

A vending machine may include or be in communication with a peripheral device. A peripheral device may be a device that obtains (e.g., receives or reads) information from (and/or transmits information to) one or more vending machines. For example, a peripheral device may be operable to obtain information about transactions being conducted at a vending machine, such as the initiation of a transaction, an amount of money deposited for a transaction and/or a product selected during a transaction. For example, a peripheral device may monitor activities carried out by a processor of a vending machine. In one embodiment, one or more of the processor, the input device(s), RAM, ROM, output device(s) and a data storage device may be included, wholly or partially, in a peripheral device.

An example of a peripheral device is the e-Port™ by USA Technologies Inc. The e-Port™ is a credit and smart card-accepting unit that controls access to office and MDB vending equipment, and serves as a point of purchase credit card transaction device. The e-Port™ includes an LCD that allows for the display of color graphics, and a touch sensitive input device (touch screen) that allows users to input data to the device. The display may be used to prompt users interactively with, e.g., promotions and information about their transaction status.

A peripheral device may be operable to receive input from customers, receive payment from customers, display messages to customers and/or exchange information with devices, such as a controller, a POS terminal, another vending machine. A peripheral device may be operable to instruct a vending machine that appropriate payment has been received (e.g., via a credit card read by the separate device) and/or that a particular product should be dispensed by the vending machine. Further, a peripheral device may be operable to instruct the vending machine to execute process steps and/or output messages. Further, a peripheral device may be operable to instruct the vending machine to execute game-themed promotions or price changes.

The functions described herein as being performed by a peripheral device controller and/or a peripheral device may, in one or more embodiments, be performed by the controller (in lieu of or in conjunction with being performed by a peripheral device controller and/or a peripheral device).

In one or more embodiments, a peripheral device may be useful for implementing the embodiments of the present invention into the operation of a conventional vending machine. For example, in order to avoid or minimize the necessity of modifying or replacing a program already stored in a memory of a conventional vending machine, an external or internal module that comprises a peripheral device may be inserted in or associated with the vending machine. For example, a conventional vending machine may be retrofitted with a peripheral device in order to implement one or more embodiments of the present invention.

A peripheral device may include (i) a communications port (e.g., for communicating with one or more vending machines, peripheral device controller, another peripheral device, and/or controller); (ii) a display (e.g., for graphics and/or text associated with a promotion), (iii) another output means (e.g., a speaker, light, or motion device to communicate with a customer), (iv) a benefit providing means (e.g., a printer and paper dispensing means), and/or (v) an input means.

In one or more embodiments, the peripheral device may direct a vending machine to perform certain functions. For example, a program stored in a memory of peripheral device may cause a processor of a vending machine to perform certain functions. For example, a program stored in a memory of peripheral device may cause a processor of a vending machine to dispense one or more products, dispense a monetary amount, refrain from dispensing a monetary amount, refrain from outputting a product, and/or communicate with another device.

Note that, in one or more embodiments, a vending machine and a peripheral device that is associated with the vending machine may not communicate with one another at all. In some embodiments, however, each may communicate with a computer or other device. For example, a vending machine may communicate with a controller and an associated peripheral device may communicate with a controller. For example, if both the vending machine and the peripheral device are in communication with a controller, each may obtain information associated with the other through the controller.

A vending machine may include a cabinet constructed from, for example, any combination of (1) commercial grade (e.g., sixteen-gauge) steel (e.g., for exterior panels and internal shelving), (2) transparent materials such as glass or Plexiglas (e.g., for product display window), (3) rubber (e.g., for waterproofing insulation), (4) plastic, (5) aluminum, and/or (6) any suitable material.

Many commercially available machine cabinets can be modified to work in accordance with the embodiments of the present invention. For example, in snack machine embodiments, a suitable machine casing may comprise the 129 SnackShop™ manufactured by Automatic Products International, Ltd.™ of Saint Paul, Minn., which stands at 72″/1829 mm wide, has a width of 38⅞″/988 mm, and a depth of 35″/889 mm. Other suitable snack machine casings include the A La Carte™ machine from Automatic Products™, and the GPL SnackVendor™ model #159 from Crane Merchandising Systems/Crane Co.™ of Stamford, Conn.

In beverage machine embodiments, machine cabinets commercially available from Dixie Narco™, Inc. of Williston, S.C. may be employed. Beverage machine cabinets may comprise a “cooler” or “glass front” style front panel, featuring a transparent front panel (e.g. glass) enabling customers to see inventory for sale. Alternatively, beverage machine casings may comprise a “bubble front” style front panel, featuring a decorative front panel, typically used to advertise a logo of a product manufacturer commercially interested in the vending machine's operation.

Other embodiments are contemplated as well, including combination snack and beverage vending machine embodiments, such as those available from Crain Co.™. Further details concerning the suitability of machine casing/cabinetry are well known in the art, and need not be described in further detail herein.

Embodiments of the present invention can be configured to work in a network environment including a computer that is in communication, via a communications network, with one or more vending machines. The computer may communicate with the vending machines directly or indirectly, via a wired or wireless medium such as the Internet, LAN, WAN or Ethernet, Token Ring, or via any appropriate communications means or combination of communications means. One or more of the vending machines may comprise computers, such as those based on the Intel® Pentium® processor, that are adapted to communicate with other computers. Any number and type of machines may be in communication with any computer.

Communication between the vending machines and the computer, and among the vending machines, may be direct or indirect, such as over the Internet through a Web site maintained by computer on a remote server or over an on-line data network including commercial on-line service providers, bulletin board systems and the like. In yet other embodiments, the vending machines may communicate with one another and/or the computer over RF, cable TV, satellite links and the like.

Some, but not all, possible communication networks that may comprise the network or be otherwise part of the system include: a local area network (LAN), a wide area network (WAN), the Internet, a telephone line, a cable line, a radio channel, an optical communications line, and a satellite communications link. Possible communications protocols that may be part of the system include: Ethernet (or IEEE 802.3), SAP, ATP, Bluetooth™, and TCP/IP. Communication may be encrypted to ensure privacy and prevent fraud in any of a variety of ways well known in the art.

Those skilled in the art will understand that vending machines and/or computers in communication with each other need not be continually transmitting to each other. On the contrary, such vending machines and/or computers need only transmit to each other as necessary, and may actually refrain from exchanging data most of the time. For example, a vending machine in communication with another machine via the Internet may not transmit data to the other machine for weeks at a time.

In an embodiment, a server computer may not be necessary and/or preferred. For example, embodiments of the present invention may be practiced on a stand-alone vending machine and/or a vending machine in communication only with one or more other vending machines. In such an embodiment, any functions described as performed by the computer or data described as stored on the computer may instead be performed by or stored on one or more vending machines.

In other embodiments, a vending machine may be in communication with a remote computer, such as a server, that provides the vending machine with and/or receives from the vending machine, e.g., all or some of the data and/or functionality described herein. Thus, in certain embodiments, the server may comprise certain elements or portions of certain elements such as a data storage device/memory.

In such an embodiment, a remote computer could be accessible, directly or indirectly, via a second computer (communicating over the Internet or other network) by a customer or another operator. Accordingly, a customer or other operator of the second computer (e.g. an owner of the vending machine) could communicate with the remote computer via a Web browser. The second computer could, e.g., receive from the remote computer messages described herein as being output by the vending machine, and/or transmit to the remote computer input described herein as being provided to the vending machine. Similarly, various data described herein as received through an input device of a vending machine may be received through a Web browser communicating with a remote server, which in turn communicates with the vending machine. Thus, an owner/operator of the vending machine can operate a remote device to remotely poll and/or report; to transmit new business rules to the vending machine; and the like.

In one embodiment, a software-based control system executes instructions for managing the operation of the vending machine, and in particular in accordance with the inventive functionality described herein. Such vending machine operations include, but are not limited to: (1) item pricing (e.g. displaying prices via an LED, changing such prices where appropriate, etc.), (2) processing vending transactions by (i) receiving customer selections via an input device, (ii) processing payment via a payment processing mechanism, and (iii) actuating corresponding item dispensing mechanisms, (3) configuring benefit offers, (4) outputting benefit offers to customers via output devices (including display of game-themed graphics/content on LCD and LED displays), and (5) recording transaction information (inventory levels, acceptance rates for promotions, etc.).

In some embodiments, machine peripherals (e.g. machine hardware, including mechanical hardware such as input devices, output devices, inventory dispensing mechanisms, and payment processing mechanisms including coin acceptors, bill validators, card readers, change dispensers, etc.) will be controlled by the software-based control system through a standard RS-232 serial interface. In such embodiments, embedded API/devices may be used to enable the software to actuate/control vending machine peripherals via RS-232 connectivity. Such vending machine peripherals may be operatively connected to the control system directly or indirectly, in any manner that is practicable.

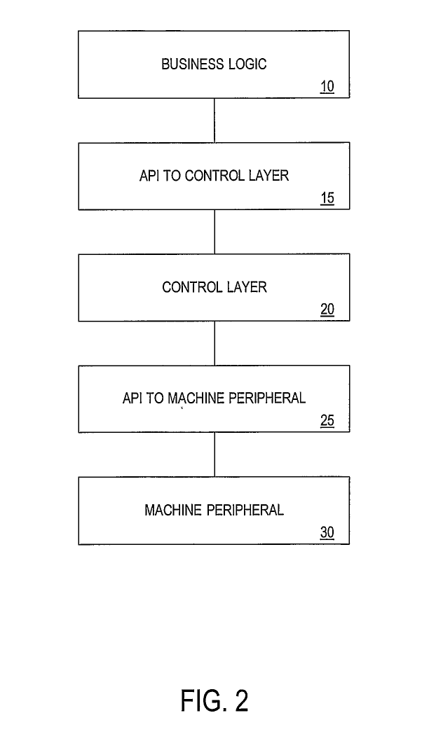

As illustrated by FIG. 2, in one embodiment, control software can be divided into three abstract components. Such division may provide a clear partition of tasks, which may be desirable so that any future modification and new programming can be applied without disrupting other components. Turning to FIG. 2, the three abstract components are illustrated, including a Business Logic component 10, a Control Layer component 20, and an exemplary Machine Peripheral component 30. As stated earlier, more machine peripherals may be employed. The Business Logic component 10 is connected to Control Layer component 20 via API 15; Control Layer component 20 is connected to Machine Peripheral component 30 via API 25.

The Business Logic component 10 visually represents the portion of the software that determines benefit offers, as discussed herein. Such a component may access a rules database and an inventory database to perform such functions. The Control Layer component 20 visually represents the portion of the software which interfaces with at least one Machine Peripheral component 30, and thereby transmits commands to perform such functions as: (i) outputting offer information via an output device (i.e. a Machine Peripheral component 30), (ii) dispensing products via a product dispensing mechanism (i.e. a Machine Peripheral component 30), (iii) dispensing change due to a customer via a payment processing mechanism, which may include a change dispenser and a currency storage apparatus (i.e. several Machine Peripheral components 30). As stated, the Machine Peripheral component 30 generally represents machine hardware, including mechanical hardware such as input devices, output devices, inventory dispensing mechanisms, and payment processing mechanisms including coin acceptors, bill validators, card readers, change dispensers, etc.

3. Process Steps

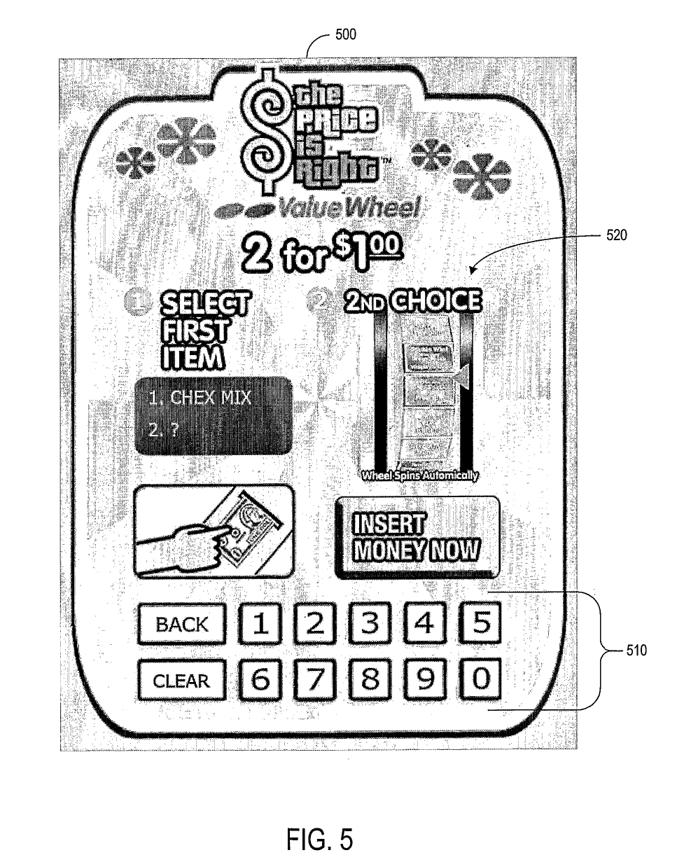

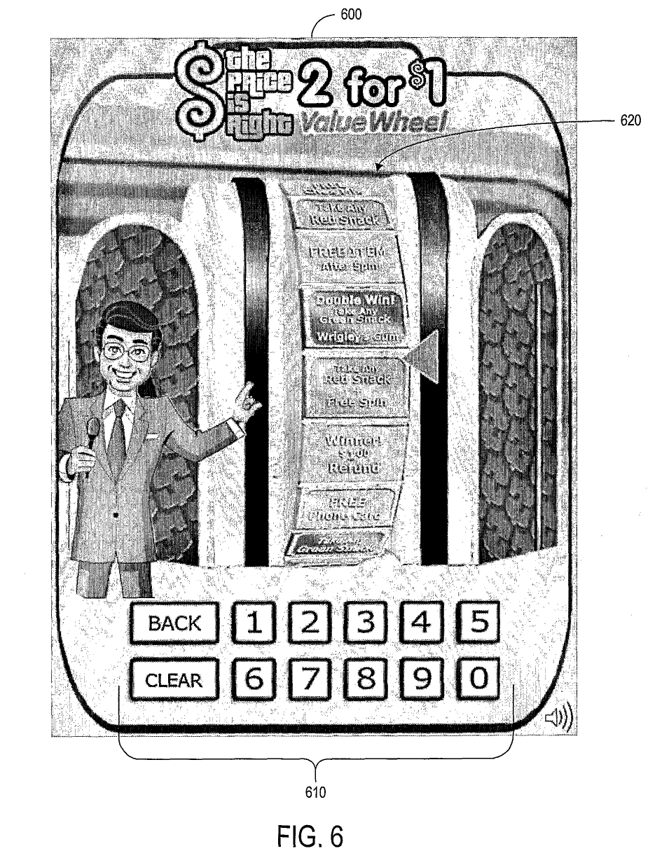

Various embodiments of the present invention are characterized by different sets of steps. For example, in some embodiments (certain “product entitlement” embodiments), a customer purchasing a “package deal” selects a first product (a component product), and is then entitled to select at least one additional component product to form the package. In such embodiments, the vending machine may determine and display to a customer, in conjunction with a presentation having a game theme, an offer for a benefit. The offer may specify (i) a particular additional component product to be provided to the customer, (ii) an inventory group from which the customer may select at least one additional component product, and/or (iii) one or more general benefits that may be offered in addition to a product. The offer for the benefit may be determined based on product data and/or stored profit management rules. Example displays which may be presented during such an embodiment are depicted in FIGS. 5 and 6, each with reference to customer directions and customer input buttons.

As an example of such a “product entitlement” embodiment, a customer may deposit $1.00 into a “2-for-$1” package vending machine (e.g., two products in a package that sells for a dollar). The customer selects a first component product of the package (e.g. Doritos® tortilla chips), and then a vending machine control system can (i) access data about products available for sale by the vending machine (“product data”) (such data indicating, e.g., number available, prices, costs, expiration dates), (ii) determine (e.g., based on stored profit management rules and the accessed data) to output a offer for a benefit, which comprises a specific inventory group (set of products) from which one additional component product may be selected (e.g., by the customer, by the vending machine), (iii) output a game-themed presentation that indicates the offer for the benefit (e.g. on a display device, an animated “prize wheel” that spins and stops on a game result such as “Take any blinking green item as your second product!”, on another output device), and (iv) provide the benefit (e.g. by receiving the customer's selection of a Milky Way® candy bar—under which a green LED had been actuated to blink and dispensing the bag of Doritos® tortilla chips and Milky Way® candy bar).

In such an embodiment, the benefit to the customer may be in allowing that customer to select (i) from a wider variety of products, and/or (ii) a product at a discount that, if sold for its retail price, would have required the customer to deposit more money. For example, in a 2-for-1 purchase wherein the sum of the retail prices of each product (i.e. the sum being known as the “package price”) is more than $1.00, the customer can be provided with a product benefit in allowing the customer to obtain “better” or more expensive products than otherwise possible (i.e. if the products were sold for their retail prices).

Accordingly, during vending machine transactions wherein customers are entitled to receive at least one component product of a package deal (i.e. a product benefit), various processes disclosed herein may function to (i) establish increased customer loyalty and goodwill (e.g. by entertaining customers, by providing them with benefits of higher perceived value, by constructing package deals that typically result in net savings), and/or (ii) result in increased profits for vending machine operators (e.g. as benefit offers are determined based on profit management rules pursuant to a profit goal).

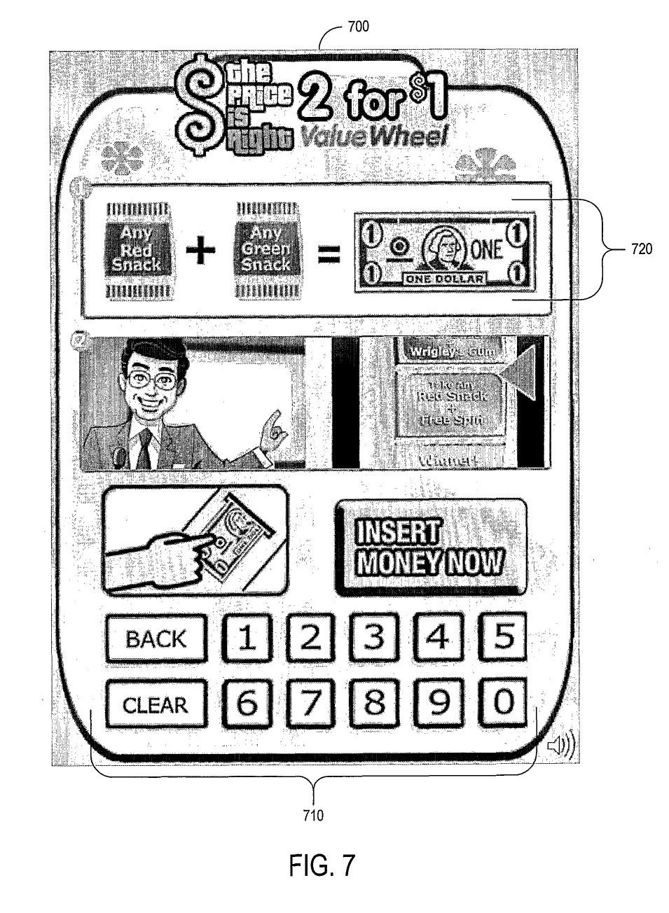

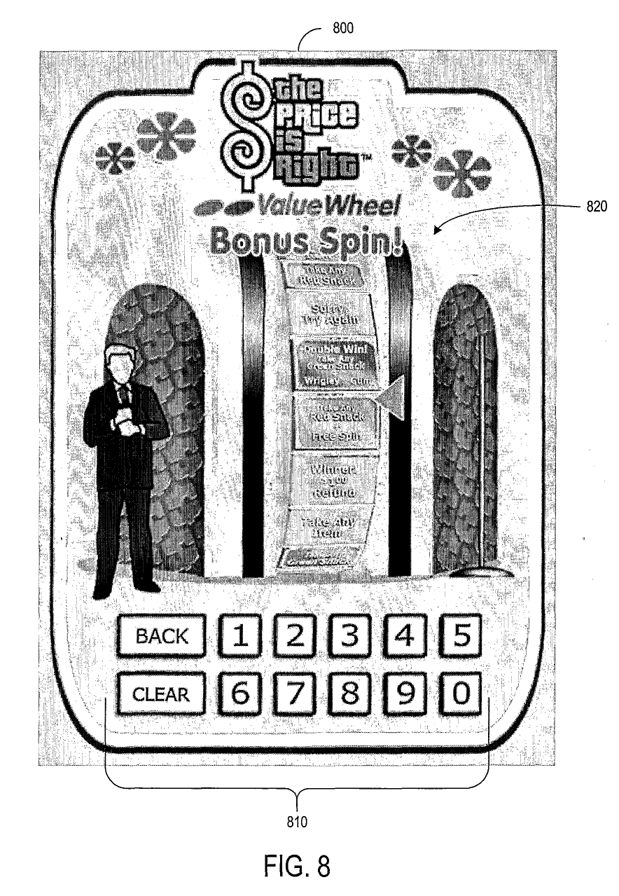

In some embodiments (certain “bonus benefit” embodiments) customers are not necessarily entitled to receive any product benefits. In such embodiments the vending machine may access product data, and one or more benefits may be determined based on stored profit management rules. Such benefits may be offered to customers utilizing a game-themed presentation. For example, a customer may insert payment of $1.00 into a “single product” vending machine, and select a Snickers® candy bar for $0.65. The vending machine (e.g., the vending machine control system) may then (i) access product data, (ii) determine, in light of stored profit management rules and product data, a benefit offer comprising a dynamically-priced upsell offer, (iii) output a game-themed presentation indicating the benefit offer (e.g. a “prize wheel” spins and stops on “Take any blinking green item instead of your change!”), and/or (iv) provide or enable the benefit (e.g. by receiving the customer's selection of a Twix® candy bar as an acceptance of the upsell offer, dispensing the Twix® candy bar and Snickers® candy bar). Example displays which may be presented during such an embodiment are depicted in FIGS. 7 and 8, each with reference to customer directions and customer input buttons.

4. “Product Entitlement” Embodiments

Generally, many embodiments of the invention include limitations in which a customer entitled to receive an additional component product of a package deal (e.g., through a purchase transaction) is provided with a benefit that is communicated through a game-themed presentation.

4.1 Selecting a First Product

A customer purchasing a package deal from a vending machine may select a product that is available for dispensing by the vending machine. Thus, a vending machine may receive a selection of a product (e.g., a first component product of a package deal). As described above, a customer may initially select a first component product via an input device. The vending machine in turn receives a signal indicating the selection of the first component product from the input device.

For example, a customer may enter a position identifier of a product (e.g. “A-1”) on an external keypad in a well-known manner, or select a graphic or icon representing the product using a touch screen display. In some embodiments, payment must be received from a customer (e.g. via a vending machine bill validator or coin acceptor) before a first component item is selected. In other embodiments, payment may be received at any other stage of a vending machine transaction prior to the transaction's completion.

In some embodiments, a customer may select only one first component product (e.g. if the maximum number of component products in a package deal is two, then each purchase of a package deal consists of one first component product and one additional component product). In other embodiments, a customer may select more than one first component product (e.g. transactions of a “3 products for $2” machine may comprise the selection of two first component products). In other words, a certain number of products less than all products in the package may be selected.

In some embodiments, after a customer selects one or more first component products, a “product database” may be updated to reflect changes in product data based in the selection, such as any (i) decrease in inventory (e.g. after one Snickers® candy bar is selected, inventory decreases from 15 to 14 units), (ii) increase in actual sales rate (e.g. after a Snickers® candy bar is selected, the actual sales rate increases, such as from 1.4 units/day to 1.6 units/day), and/or (iii) additional changes to product data as described elsewhere in the present disclosure. In some embodiments, product data may be updated, stored or otherwise recorded on a periodic, substantially continuous and/or event-triggered basis. Further, in various embodiments of the present invention, product data may be recorded during any stage of vending machine transactions (e.g. after transactions are complete, on a periodic basis, etc.).

4.2 Selecting a Second Product

Product data is retrieved to permit evaluation thereof (e.g., in light of stored profit management rules to determine one or more benefit offers pursuant to a profit goal).

In some embodiments, product data may comprise general information relating to the products stored in a vending machine (i.e. general product data).

Further, product data may comprise (i) quantity data (e.g. N units of product type X remain available sale in the vending machine), (ii) cost data (e.g. the unit cost associated with one or more vending machine products), (iii) sales data (e.g. the retail price, actual sales rate, ideal sales rate of one or more vending machine products), (iv) fill period data (e.g. days remaining until the next date the vending machine is restocked) and/or (v) any other practical data which is desirable to evaluate.

In this manner, product data may be retrieved, recorded, stored, updated and/or otherwise accessed at various different times. For example, as a vending machine is filled with products during an initial load process (e.g. performed by a route driver), certain product data may be recorded (e.g. in fields or tables of a product database). For instance, a route driver may proactively program (e.g. via an input device) the retail price, unit cost, ideal sales rate, quantity, etc. of each product he loads into a machine. Such an agent may also indicate a date and/or time at which the machine is to be restocked. Various techniques and methods of remotely (e.g. in network embodiments, a machine is programmed from a central location) and/or automatically (e.g. as RFID-tagged products are loaded, a receiver transmits product data to a control system) programming, recording, or updating product data are also contemplated within the scope of the present invention.

Further, as the products of a vending machine are sold (e.g. during a vending machine fill period), product data may be further updated on a periodic, substantially continuous, or event-triggered basis. For instance, in some embodiments the actual sales rate of a given product may be calculated by the following formula:

$$ACTUAL SALES RATE = \frac{UNITS OF PRODUCT SOLD}{TIME ( DAYS )}$$

Therefore, the actual sales rate for Snickers® candy bars may dynamically fluctuate in accordance with product sales (e.g. after each transaction in which a Snickers® candy bar is sold, the “actual sales rate” field of a product database may be updated as a processor receives a product selection signal from an input device or a product signal from a dispensing device). For example, if one Snickers® candy bar is sold every day for the first four days of a vending machine fill period (i.e. the actual sales rate is 1.0/day), then the actual sales rate will change if during the fifth day two Snickers® bars are sold (i.e. the actual sales rate increases to 1.2/day based on the average sales during the five days).

As discussed, in some embodiments, product data may be stored in a product database, maintained within a vending machine or otherwise accessible by a vending machine control system (e.g. in network embodiments, a vending machine control system may access a remotely stored product database).

A graphic representation of an exemplary product database at a particular point in time is shown below in Table 1.

TABLE 1

| | | | | | | | Days |
|---|---|---|---|---|---|---|---|
| | Unit | Retail | | Units in | Actual Sales | Target Sales | until |
| Product | Cost | Price | Margin | Inventory | Rate | Rate | Restock |
| Snickers ® | $.55 | $.75 | $.20 | 7 | 1.15/day | 1.0/day | 10 |
| candy bar | | | | | | | |
| Milky | $.50 | $.65 | $.15 | 15 | .75/day | 1.0/day | 10 |
| Way ® | | | | | | | |
| candy bar | | | | | | | |
| Twix ® | $.60 | $.65 | $.05 | 21 | .45/day | 1.0/day | 10 |
| candy bar | | | | | | | |
| Dentyne ® | $.10 | $.35 | $.25 | 24 | .30/day | 1.0/day | 10 |
| gum | | | | | | | |
| Cheetos ® | $.30 | $.60 | $.30 | 18 | .60/day | 1.0/day | 10 |
| snacks | | | | | | | |
| Doritos ® | $.35 | $.60 | $.25 | 4 | 1.30/day | 1.0/day | 10 |
| tortilla | | | | | | | |
| chips | | | | | | | |

In the above example, product data has been retrieved on the twentieth day of a thirty-day fill period, and thirty units of each product have initially been loaded. Vending machine product data may be evaluated in light of profit management rules (as described further in this disclosure) in order to determine a benefit offer (e.g. an offer for a product benefit) to be presented to a customer (e.g. during the next vending machine transaction). In some embodiments, data may be retrieved periodically (e.g. once per day). In some embodiments, data may be retrieved on an event-triggered basis (e.g. every transaction) allowing different benefit offers to be constructed in a manner that is responsive to changes in supply and demand.

4.3 Determine a Benefit Offer

In some embodiments, a benefit offer may be determined in light of the accessed data and stored profit management rules (e.g., after a vending machine customer has selected at least one first component product of a package deal, and after product data has been accessed). In some product entitlement embodiments, (e.g., in which a customer may be entitled to receive one or more additional component products of a package deal) a benefit offer may comprise: (i) a particular additional component product to be provided, (ii) an inventory group from which at least one additional component product may be selected, and/or (iii) one or more general benefits that may be offered in addition to a product benefit.

In some product entitlement embodiments, a profit management rule may include an instruction to offer a particular product benefit, pursuant to the increase of vending machine profit (e.g. during a fill period). In some embodiments, a profit management rule may be constructed in accordance with increasing the “expected profitability” of a vending machine, which may assume (i) that certain profit management practices (e.g. outputting product benefits characterized by low costs) may generally lead to increased profits, and/or (ii) a probability that one or more given products will sell (e.g. a certain number of units, at a certain actual sales velocity, when offered for a certain price). In this manner, a benefit offer (e.g. an additional component product of a package deal) may be determined so as to increase or otherwise increase the profitability of a vending machine.

In some embodiments, the expected profitability of a vending machine may describe the amount of profit a vending machine (or the individual products thereof) may potentially earn during a given period of time (e.g. fill period) and/or from a specific transaction. Generally, the profit per fill period of a vending machine may be increased by (i) increasing the profit margin of vending machine transactions (e.g. by selling items with lower unit costs and/or for higher retail prices during those transactions); (ii) increasing the actual velocity of items sold (e.g. profit management rules may determine that expected profitability during a period of time increases if products are sold at a lesser profit margin, but with a sufficiently offsetting increase in sales volume); (iii) establishing, increasing, or promoting the overall customer loyalty and/or goodwill associated with one or more machines (e.g. customers who receive benefits and/or entertainment outputs may perceive certain vending machines to be valuable, and therefore may return to those vending machines for future transactions); and/or (iv) any other method or set of steps described herein.

In various embodiments, determining the expected profitability may involve consideration of one or more of: (i) the unit cost of one or more products, (ii) the retail price of one or more products, (iii) the profit margin of one or more products, (iv) the actual sales rate of one or more products, (v) the ideal sales rate of one or more products, (vi) the quantity of one or more products remaining in a vending machine, (vii) the amount of time (e.g. in days) left until a vending machine restock date, (viii) the expiration date of one or more products, (ix) the probability that one or more products will be sold (e.g. during a given period of time), (x) the historic “acceptance rate” of one or more benefit offers (e.g. comprising one or more products), (xi) the opportunity cost and/or potential for dilution associated with a benefit offer (e.g., and accounting for probable or expected acceptance of such offers), and/or (xii) the goodwill (or consumer loyalty) generated by distribution of one or more products via a benefit offer.

Accordingly, in light of retrieved product data and stored profit management rules, one or more benefit offers may be determined so as to increase expected profitability. Increased profitability may be determined with reference to one or more profit management rules. Such profit management rules may be stored in a vending machine “profit management rules database” or otherwise accessible (e.g., via a remotely accessible server) by a vending machine control system in order to make such determinations.

For example, for a particular transaction, a profit management rule may determine that expected profitability will be increased by offering the product benefit characterized by the lowest unit cost. In response, product data may then be accessed to determine the product having the lowest unit cost, and that product may then be presented to a customer in the context of a benefit offer (e.g. an additional component product of a package deal).

In some product entitlement embodiments, a benefit offer may define at least one particular additional component product. In such embodiments, a variety of different profit management rules may be utilized in conjunction with retrieved product data so as to select a particular product to be offered (i.e. in order to increase expected profitability).

For instance, an exemplary profit management rules database for determining at least one product to be presented in the context of a benefit offer (e.g. an additional component product of a package deal) may define a plurality of rules, as depicted in Table 2 below.

TABLE 2
To increase expected profitability, offer the product with the:

| | |
|---|---|
| 1. | Lowest unit cost |
| 2. | Lowest actual velocity |
| 3. | Lowest actual velocity as a percentage of target velocity |
| | (actual velocity/target velocity) |
| 4. | Most units of inventory currently in stock |
| 5. | Lowest average profit per day (margin × actual velocity) |

Thus, in some product entitlement embodiments wherein a first component product has been selected, it can be beneficial to define/construct profit management rules which, when employed appropriately as described herein, help assure that the selected additional component product (which satisfies a customer's entitlement and completing a package deal transaction) has certain desirable characteristics that are reflected in the product data.

A plurality of rules, as illustrated in Table 2 above, may be collectively employed to select a product (or other benefit) based on criteria such as profitability. In some embodiments, the product (or other benefit) that satisfies the most profit management rules may be selected as a benefit offer (e.g. an offer defining an additional component product). In other embodiments, a product (or other benefit) that satisfies at least one particular profit management rule (e.g., the “most important” rule) may be selected. In further embodiments, rules may be defined/constructed so as to “break ties” if more than one product satisfies a particular profit management rule. For example, a rule may state, “If more than one product satisfies Rule #1, select the product that also satisfies Rule #2.” It may be noted that any combination of rules referencing any of the expected profitability considerations described herein may trigger/be employed in a benefit offer and are within the scope of the present invention.

In some embodiments, profitability can be increased by selecting an additional component product that has a low unit cost. For example, since at a 2-for-$1 machine revenue amount in a transaction is most often $1.00, the revenue per transaction at a 2-for-$1 machine is approximately $1.00. Accordingly, profit per fill period may be expected to increase by reducing the cost of many transactions (or every transaction).

In other embodiments, selecting a product that is selling at a less-than-desirable actual velocity (e.g. less than target velocity, substantially less than target velocity) may increase expected profitability. In some embodiments, a product may be sold for a lesser profit margin if a sufficiently offsetting increase in actual velocity would lead to increased overall profit (e.g. rather than sell three units at a margin of $0.10 each, a rule may determine to offer twenty units at a margin of $0.05 each).

In further embodiments, selecting a product with a relatively large number of units in stock may increase profitability. For example, in an embodiment in which vending machine inventory that remains in stock too long (e.g., until the end of a fill period, expires and must be disposed of at cost to an operator) earns no revenue, a profit management rule may determine to offer the product with the most units remaining as a restock date approaches (e.g. even if the unit is sold at less than unit cost because anticipated losses may be mitigated by any revenue whatsoever).

In another embodiment, selecting an additional component product that has produced relatively little profit (e.g., its profit is below a threshold, its profit is in the bottom tenth of all products' profits) during a certain time period (e.g. since the vending machine has been operating, since the last refill date, between the beginning of a fill period and the time product data is retrieved) may increase expected profitability. For example, if product data is retrieved after twenty days of a thirty-day fill period, and during that twenty-day time period the machine has sold a total of three units of Mounds® candy bars at a profit margin of $0.15 each, then during that twenty day period (i) the total profit earned by Mounds® sales is only $0.45, and (ii) the average profit per day from Mounds® candy bars is slightly greater than $0.02. Thus, if profit management rules determine to offer the product with the lowest total profit earned and/or average profit per day, Mounds® candy bars may be offered and thus potentially increase the expected profitability. Such rules may increase expected profitability because (i) the resulting sale may lead to an increase in the actual velocity of Mounds® candy bar, and/or (ii) a vending machine may recognize the opportunity to “push” (e.g. promote via benefit offers) items that otherwise contribute poorly to a vending machine's profit.

In yet another embodiment, a profit management rule may dictate that an additional component product should be a product with a high profit margin. Ensuring that customers select such items as additional component products of package deals may reduce behavior which is “diversionary” (in that it diverts from the most profitable behaviors). If products having greater profit margins are “pushed” (offered frequently, aggressively and/or exclusively) in lieu of items with lesser profit margins, diversion may be reduced.

The exemplary product database depicted in Table 1 above is referenced in the following example in order to determine a benefit offer (defining an additional component product) that increases expected profitability. For example, Dentyne® gum, which has (1) the lowest unit cost ($0.10) of the six products, (2) the lowest actual sales rate (0.30 units/day), (3) the most inventory in stock (24 units) and (4) the lowest retail price ($0.35) would satisfy “Rule #1,” “Rule #2,” “Rule #4” and “Rule #6” of the rules depicted in Table 2 above. Twix® candy bar, which thus far has produced an average profit per day of only $0.02, would satisfy “Rule #5.”

Further, in some embodiments, the determination of an additional component product may comprise a probability measure, which may evaluate the likelihood of selling one or more products (e.g. selling a certain number of units, selling at a given velocity) during a given period of time (e.g. a fill period). In some embodiments, the expected profitability of a vending machine may be increased by selecting additional component products that (e.g. at retail price) are considered (or determined to be) “unlikely to be sold” during routine vending machine transactions and/or selected by customers as first or additional component products of a package deal. As discussed, since products that are unlikely to sell are also unlikely to produce any revenue or profit, such products may be sold at a reduced retail price, provided there is also a sufficiently offsetting increase in velocity, so that overall vending machine profit is increased.

For example, in some embodiments, the probability that a product will be sold (or not be sold) may be estimated (e.g., based on historic product data). For example, if product data is retrieved on the twentieth day of a 30-day fill period, a product with an actual sales rate of 1.5 units/day for the first twenty days may be expected to sell at the same rate during the final ten days (unless other aspects are considered to alter that estimate).

In some embodiments, a product benefit determination may comprise an expected profitability or expected value calculation which may be used to determine an amount of profit that one or more vending machine products may be expected to earn during a given time period (e.g., during the next fill period). Thus, referencing the ongoing example, to determine the expected profitability of a Cheetos® snack during a given period of time (e.g. one day), an expected value may (in one embodiment) be calculated by multiplying the profit margin of the product by the number of units of the product which is likely to sell (i.e. a probabilistic measure, or “expected value”). In an embodiment in which probability or expected sales is estimated based on historic sales data (i.e. actual velocity), an expected value calculation for Cheetos® snacks (denoted with the subscript “C”) may be defined as follows:
EXPECTED VALUE PER DAY_{C}=MARGIN_{C}×ACTUAL VELOCITY_{C}

Accordingly, based on historic data, Cheetos® snacks may be expected to earn $0.18/day in profit ($0.30 margin at an actual sales rate of 0.60 units/day). Thus, if product data has been retrieved on the twentieth day of a 30-day fill period, the “total expected profitability” of Cheetos® snacks for the remainder of the fill period may be $1.80 (Cheetos® snacks will earn $0.18/day for ten days). In this manner, (i) an expected value of velocity may be calculated for each product of a vending machine, (ii) products (and corresponding data) may be sorted according to the result of the calculation (e.g. products are sorted from greatest to smallest total expected profitability), and (iii) a product benefit may be determined based on a profit management rule (e.g. “Offer the product with the highest total expected profitability”).

It may be noted that in some product entitlement embodiments involving 2-for-1 vending machines, the probability that a given product is likely to sell may refer to (or be based on) the likelihood that the product is selected as a first component product of a package deal. In other product entitlement embodiments, wherein 2-for-1 machines may process routine, non-package transactions in addition to offering package deals, the probability that a given product is likely to sell may refer to the probability of the product being (i) selected as a first component product of a package deal, and/or (ii) sold during a routine, non-package transaction. In some embodiments, at the beginning of a fill period (and/or at other times) a control system may determine a product's actual velocity to be zero (since no sales data for that period has yet been collected). Accordingly, in some embodiments a control system may access data from a prior fill period to determine or estimate actual velocity.

In some embodiments, the determination of a product benefit may comprise an analysis of the potential for dilution associated with the provision of one or more products (e.g. at a given price). For example, if it is determined that a product has a high probability of being sold at its retail price (e.g. has a high actual sales rate), selling the product at less than its retail price (e.g. as an additional component product of a package deal) may cause dilution, and thus the product should not be promoted in conjunction with a benefit offer.

In other product entitlement embodiments, a benefit offer may define an inventory group from which at least one additional component product may be selected. For example, a customer may be presented with three products (which define the inventory group), and only one product may be selected from the three products. An exemplary profit management rules database for use in such embodiments may include rules as illustrated in Table 3 below.

TABLE 3
To increase expected profitability, offer an inventory group comprising
the three products with the:

| | |
|---|---|
| 1. | Lowest unit cost |
| 2. | Lowest actual velocity |
| 3. | Lowest actual velocity as a percentage of target velocity |
| | (actual velocity/target velocity) |
| 4. | Most units of inventory currently in stock |
| 5. | Lowest average profit per day (margin * actual velocity in fill period) |
| 6. | Lowest retail price |

Accordingly, in one 2-for-$1 product entitlement embodiment, customers may be presented with a group of three different products (i.e. benefit offers) from which one additional component product may be selected. In this manner, customers can benefit from having a greater number of options from which to select one or more benefits, while operators may benefit by presenting inventory groups constructed in a manner such that expected profitability may be increased. For example, in an embodiment wherein expected profitability is increased by instituting “Rule #1” in Table 3 above, the exemplary product database provided above may be sorted by unit cost as illustrated by Table 4 below:

TABLE 4

| | | | | | | | Days |
|---|---|---|---|---|---|---|---|
| | Unit | Retail | | Units in | Actual Sales | Target Sales | until |
| Product | Cost | Price | Margin | Inventory | Rate | Rate | Restock |
| Dentyne ® | $.10 | $.35 | $.25 | 24 | .30/day | 1.0/day | 10 |
| gum | | | | | | | |
| Cheetos ® | $.30 | $.60 | $.30 | 18 | .60/day | 1.0/day | 10 |
| snacks | | | | | | | |
| Doritos ® | $.35 | $.60 | $.25 | 4 | 1.30/day | 1.0/day | 10 |
| tortilla | | | | | | | |
| chips | | | | | | | |
| Milky | $.50 | $.65 | $.15 | 15 | .75/day | 1.0/day | 10 |
| Way ® | | | | | | | |
| candy bar | | | | | | | |
| Snickers ® | $.55 | $.75 | $.20 | 7 | 1.15/day | 1.0/day | 10 |
| candy bar | | | | | | | |
| Twix ® | $.60 | $.65 | $.05 | 21 | .45/day | 1.0/day | 10 |
| candy bar | | | | | | | |

Thus, in this example, it may be determined that an inventory group comprising Dentyne® gum, Cheetos® snacks and Doritos® tortilla chips is to be presented to a vending machine customer pursuant to “Rule #1”. A selection of any of these three products will produce a transaction characterized by relatively low cost, thus potentially increasing overall expected profitability of the vending machine in accordance with profit management practices.

In further embodiments, rather than construct an inventory group comprising a specific number of products (e.g. three products), the number of products to be presented as part of an inventory group may be determined in other manners. Table 5 illustrates a set of exemplary profit management rules constructed to determine such inventory groups.

TABLE 5
To increase expected profitability, offer an inventory group
comprising any products wherein:

| | |
|---|---|
| 1. | Actual sales rate < target sales rate |
| 2. | ≧20 units in stock |
| 3. | Unit cost ≦$.20 |
| 4. | Actual sales rate ≦.5 units/day |
| 5. | Margin ≦$.10 |

In still further embodiments, an inventory group may comprise any number of products of a certain (i) type or category (e.g. “chips,” “gum,” “soda,” etc., such that additional component products may be complimentary to first component products), (ii) location within a machine (e.g. the bottom shelf), and/or (iii) subset as displayed, determined or otherwise communicated to vending machine customers in light of profit management rules. In yet another embodiment, a customer may be presented with at least two inventory groups, and the customer selects one (or more than one) product from each group. An offer for such an embodiment may be, e.g. “Pick any item from ‘Group A’ and any item from ‘Group B’!”.

In some embodiments, additional stored rules may be used to decide whether to offer (i) a particular additional component product, or (ii) an inventory group from which one or more additional component products may be selected. For instance, in one embodiment, a profit management rule may define, in general, “Present one or more products with low unit costs.” Accordingly, an “inventory group vs. single product rules database” may be consulted to determine whether to present “one” or “more” products (e.g. a single product benefit, or an inventory group from which one may be selected). Table 6 below illustrates one example of such a database.

TABLE 6

| | Then present benefit offer |
|---|---|
| If: | comprising: |
| Two or more products have a unit cost | Inventory group of those |
| below $0.20 | products |
| Only one product has a unit cost below | That product |
| $0.20 | |

In still further product entitlement embodiments, in addition to providing one or more additional component products (e.g. so as to satisfy a product entitlement), a general benefit may also be determined and provided. For example, a product entitlement benefit offer may comprise (i) an inventory group from which one additional component product may be selected, and (ii) a coupon for a further vending machine transaction (e.g. a benefit offer is “Pick any blinking green item AND get a third product free during your next package purchase!”). Determinations for providing various types of general benefits (e.g. upsells, discounts) are described further herein.

Additionally, in some product entitlement embodiments wherein at least one additional component product of a package deal may be determined in accordance with product data and profit management rules, additional “restriction rules” may place limitations on the types of additional component products offered as benefits. In some embodiments, restriction rules may consider a selected first component product and/or machine inventory status. In some embodiments, if a product benefit offer is determined in light of profit management rules, the offer may then be checked against a set of restriction rules to determine if any rules are violated. An offer which violates a restriction rule may be lower in priority or eliminated as a possibility.

In other embodiments, restriction rules may be consulted before profit management rules are considered (so as to reduce a set of potential product benefits and thereby reduce computational processing). For example, an example of a restriction rules database is illustrated in Table 7 below.

TABLE 7

| | Then additional component |
|---|---|
| If: | product must: |
| First component product is Doritos ® | Not be Juicy Fruit ®, |
| chips, Cheetos ® snack or Lays ® Potato | Dentyne ® or |
| Chips | Wrigley's ® gum |
| First component product is a “snack” | Be a “drink” |
| Machine has ≦10 total units of “chips” | Not be a bag of “chips” |
| in stock | |
| First component product is not a | Be a Mars ™, Inc. product |
| Mars ™, Inc. product | |
| Machine has ≧50 units of “gum” in | Be either Juicy Fruit ®, |
| stock | Dentyne ® or |
| | Wrigley's ® gum |

In such an embodiment, restriction rules may ensure that determinations for additional component products are not exclusively based on profit management rules, but rather may consider various marketing and promotional strategies as well.

4.4. Output a Game-Themed Presentation

In some product entitlement embodiments, once a benefit offer is determined, it may be indicated to a vending machine customer as the result of a game-themed presentation.

In some embodiments, a game-themed presentation may be outputted to a customer via one or more vending machine output devices described herein. For example, a presentation may comprise a game-themed animation depicted on an LCD display and sound effects emitted via audio speakers. Additionally, a game-themed presentation may incorporate various other types of machine hardware (e.g. LED price displays) or output devices, as described further herein.

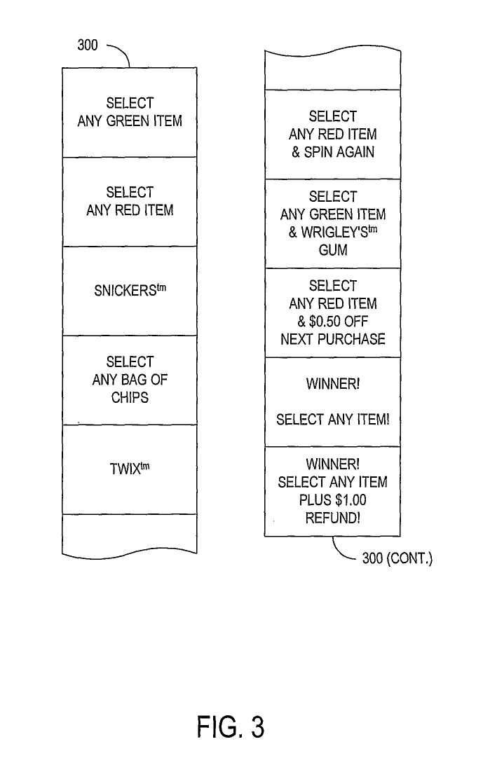

In various product entitlement embodiments wherein a benefit offer has been determined, game-themed presentations may take one or more of several different forms so as to indicate a determined benefit offer. FIG. 3 illustrates an example of some potential product entitlement game results. Any means of communicating a determined benefit offer as the result of a game-themed presentation are within the scope of the present invention, such means including but not limited to (i) text, (ii) audio, (iii) graphics, photographs or other icons, and/or (iv) any combination thereof.

In some embodiments, a game-themed presentation may comprise a “prize wheel” theme. In such embodiments, once a benefit has been determined, an animated prize wheel, which may be divided into several “wheel sections,” each representing a potential game result (i.e. benefit offer), may automatically “spin” and conclude (e.g. stop spimling, so that an arrow points to a particular, predetermined game result indicating a benefit offer). In some embodiments, a prize wheel theme may comprise a roulette wheel. In some embodiments, the wheel sections of an animated roulette wheel each represent a row position identifier (e.g. “B-1”) corresponding to a vending machine product, such that a game result (e.g. as an animation concludes, a ball “lands” on a particular row position identifier) can indicate a determined benefit offer (e.g. a customer may then receive the Snickers® candy bar in row position “B-1”). Some embodiments may involve a theme based on the television game show “The Price is Right™”. FIGS. 5-8 illustrate exemplary input/output device screenshots of such a theme, each with reference to customer directions and customer input buttons. Another theme is one based on the game show “Wheel of Fortune™”.

In other embodiments, a game-themed presentation may comprise a “concealed prize” theme. In such embodiments, one or more curtains, doors, or other (animated or animatable) objects displayed via an output device may conceal indications of one or more benefits. In some embodiments, an animation sequence may reveal a concealed benefit offer by removing a concealing object (e.g. a door is lifted during an animation sequence). In some embodiments, a benefit offer may be viewable before it is concealed (e.g. during a first animation sequence), and then once again revealed (e.g. during a second animation sequence). In other embodiments, a customer may be shown several benefit offers which are then concealed (e.g. an animation shows three curtains covering three different prizes), only a certain number of which are then revealed as determined benefit offers (e.g. one of the three curtains rises to show a “Pick any green item!” benefit offer). In further embodiments, a concealed benefit offer may be revealed by “flipping over,” “scratching off” or otherwise animating an object as to expose an icon or text describing a benefit offer. In still further embodiments, concealing objects may be shuffled before a benefit offer is revealed (e.g. a “shell game” wherein three objects each covering a benefit offer are shown in an initial position, animated so as to “shuffle” between positions, rest and ultimately reveal one or more benefit offers). Further, some concealed prize embodiments may comprise a theme based on the television game show “Let's Make a Deal™.”

In further embodiments, a game-themed presentation may comprise a “slot machine” theme. In such embodiments, a presentation (e.g. animation) may mimic the spinning reels of a slot machine in a manner in which (i) symbols displayed on the reels may be representative of benefit offers (e.g. a “Snickers®” symbol instead of a “BAR” symbol), and (ii) game results may be indicative of at least one determined benefit offer (e.g. the reels “spin” and “stop” such that three “Snickers®” symbols land on a “payline”).

In still further embodiments, a game-themed presentation may comprise a “video poker” or “Blackjack” theme. For example, an LCD screen may depict an animation sequence showing a poker hand being dealt to a customer; should the poker hand be of a certain value or higher (e.g. two pair), a benefit may be provided (e.g. a corresponding pay table presents the relationship between various game outcomes and provided benefits). In an exemplary Blackjack game-themed presentation, a customer may be automatically dealt a hand of Blackjack according to standard play. The customer may then be provided with a benefit if the customer's hand is of greater value than a “dealer hand” (i.e. a winning game result) without “busting” (exceeding a value of 21).

In still further embodiments, a game-themed presentation may comprise a “bingo drawing” or “lottery drawing” theme. In some bingo-themed embodiments, an output device may depict a bingo “board” that bears a plurality of “cells.” Further, each cell may correspond to a vending machine position identifier (e.g., “A-1” represents the leftmost product on the highest shelf of a vending machine). In such embodiments, wherein a drawing (e.g. animation sequence) reveals the identity of certain cells of a bingo board, one or more markers may be placed over one or more cells, indicating at least one determined benefit offer (e.g. a marker is placed on “B-3” and a customer may select the Mounds® bar in row position B-3). In other bingo-themed embodiments, wherein each cell may represent a description (e.g. text, graphic) of a benefit offer, markers may be placed (e.g. during an animated drawing sequence) on one or more cells so as to indicate one or more determined benefit offers. In some lottery embodiments, rather than compare the results of an animated drawing sequence to a bingo board, results may be compared to at least one “lottery ticket” (e.g. depicted via one or more output devices, such as a display screen or printer), so as to determine a game result (e.g. if a customer's lottery ticket matches a certain number of drawn numbers, the customer is provided with a benefit offer). In some embodiments, a customer may be provided with at least one lottery ticket, which may comprise any combination of the following “elements”: (i) numbers, (ii) position identifiers, and/or (iii) icons or text representing potential benefit offers. In this maimer, as elements are drawn (e.g. during an animated drawing sequence), they are compared to the numbers indicated by at least one provided ticket to determine a game result (e.g. benefit offer). In another embodiment involving a lottery theme, the row position identifier of a product a customer has selected (e.g. B-3) may be used as lottery number (e.g. “Lottery Number: B-3” is printed on a ticket at the end of the transaction), such that if the same position identifier is selected during a later drawing, the customer may be entitled to receive a benefit.

In this manner, as a determined benefit offer is indicated to a customer as the result of a substantially brief (e.g. not substantially interactive and/or time-consuming) game-themed presentation, the customer may benefit from (i) the entertainment and suspense generated by the presentation and (ii) the provision of a benefit (e.g. an additional component product).

In one embodiment, a vending machines may advertise, as a prize, the ability to win prizes such as all of the machine's revenue for a given period, the cash stored in the machine, an amount equal to all the cash stored in the machine, or some other amount (e.g. a prize amount generated by diverting $0.05 from each transaction into a “prize pool”). The vending machine may determine winners randomly or pseudo-randomly.

Winners may be provided with the prize amount in one of several ways. For example, winners may be issued a machine credit equal to the prize amount, winners may be provided with cash instantly through the coin mechanisms, winners may be provided with a coded voucher or check that can be redeemed at a retailer or bank, or winners may be provided with a coded voucher that can be redeemed through a web site (a winner may enter a code, and a credit may be issued automatically to a financial account associated with the winner or a check may be mailed to the winner by the site operator). The code may contain an internal (cryptographic) reference to the machine's then-current revenue total.

As necessary or desired to support alternate forms of entry (which are required in some states for compliance with gambling and/or sweepstakes laws), the vending machine may permit any person to play (i.e. “no purchase necessary”) by spinning a game wheel, and the like.

In a “subscription vending” embodiment (e.g. where machines sell pre-paid “soda cards” which facilitate redemption of units pursuant to a subscription), subscribers may get an additional chance to win each time they redeem a unit of product.

Further, to encourage redemption of subscription units (which increases sales volume), “drawings” may be held frequently (e.g. twice per day; at 10 AM and 3 PM), and subscribers could be entered into each drawing by redeeming a unit before the schedule drawing time.

It may be noted that any variations or combinations of the themes, output devices and input devices described herein, as well as additional game presentation themes, are within the scope of the present invention and may be employed for the purpose of indicating a determined benefit offer via a game-themed presentation.

In some embodiments of the invention, a promotion is based on the popular television show “Let's Make a Deal” (LMAD). In a LMAD embodiment, customers may receive the ability to make a simple choice that determines or reveals their entitlement to one or more prizes. For example, a customer may receive the ability to select an icon that determines or reveals a prize (e.g. selecting a “door” icon on a touch screen). In another LMAD embodiment, a customer may first receive an entitlement (e.g. a printed coupon) and then be presented with a choice to either keep the first entitlement or return it (e.g. deposit a printed coupon into the machine's bill validator) for the possibility of receiving a second entitlement (e.g. a prize with a greater value). Thus, customers would be able to participate in a game much like television's LMAD, where contestants are asked to choose between keeping low value prizes and risking such low value prizes in hopes of winning high value prizes. For example, a customer could trade a discount coupon for the ability to “spin” a prize wheel and potentially win all the cash then stored in the machine.

4.5 Provide at Least One Benefit

In some embodiments, once a determined benefit has been indicated to a customer via a game-themed presentation, the benefit may be provided without requiring any further input or action from the customer. For example, in an embodiment wherein a determined benefit is a particular additional component product of a package deal (e.g. a prize wheel spins and lands on “Lays® Potato Chips”, thereby defining the benefit), the benefit may be provided in a substantially automatic manner (e.g. one or more vending machine dispensing mechanisms may then receive a signal from a control system, and actuate so as to dispense the bag of Lays® potato chips, without requiring any further commands or instructions from a customer). In further embodiments, a determined benefit may comprise two or more additional component products, which may be provided in a substantially automatic manner (e.g. a vending machine dispenses a Snickers® bar, then a bag of Doritos® chips without any further customer input).

In other embodiments, a determined benefit may only be provided after receiving further input from a customer (e.g. via one or more input or input/output devices described herein). For example, in an embodiment wherein a determined benefit comprises an inventory group (e.g. comprising Reese's® candy, Milky Way® candy bar and Mounds® candy bar) from which a customer may select one or more additional component products of a package deal, a further selection, decision, command and/or instruction may be required from a customer before a determined benefit is provided (e.g. from the aforementioned inventory group, a customer selects a Reese's® icon displayed on a touch screen input/output device, and the candy is then dispensed).

In some product entitlement embodiments, a benefit offer (e.g. product benefit) may be dispensed via a product delivery system (e.g. a delivery bin or chute) in accordance with any distribution functions or dispensing mechanisms (e.g. dual helices) described herein and/or known in the art. In other product entitlement embodiments, wherein in addition to a product benefit, a determined benefit offer comprises a general benefit (e.g. a coupon), the general benefit may be dispensed by any output device (e.g. a printer) as detailed elsewhere herein.

As stated, in some embodiments, a customer of 2-for-$1 machine may elect not to purchase a package deal. In such embodiments, a vending machine may not necessarily provide the corresponding benefit of a determined benefit offer. For example, a customer may (i) insert payment (e.g. of $1.00), (ii) select a first product (e.g. with a retail price of $0.65), (iii) elect not to purchase a second product (e.g. by pressing a “no thanks” button of an input device), (iv) receive the first product, and (v) receive change due (e.g. $0.35).

In this manner, upon evaluating profit management rules, restriction rules and/or product data, a benefit offer (defining at least one product benefit which the customer is entitled to receive) may be indicated to a vending machine customer in conjunction with a game-themed presentation, and provided to the customer. It should be noted that any processes, determinations, concepts and/or rules disclosed with respect to product entitlement embodiments can be applicable to the other embodiments and processes disclosed elsewhere herein.

5. “Bonus Benefit” Embodiments

In certain embodiments, a vending machine customer is not be entitled to receive a product benefit during a transaction at a vending machine.

5.1 Receive a Customer Selection of a Vending Machine Product

In some “bonus benefit” embodiments in which vending machine customers are not necessarily entitled to receive any products (e.g. additional component products of package deal). In such embodiments, product data may be retrieved in light of stored profit management rules, and one or more benefit offers (i.e. general benefits) may be determined and presented to customers as the result of a game-themed presentation.

For example, if a customer (i) approaches a single product vending machine, (ii) inserts payment of $1.00 and (iii) selects a Snickers® candy bar which has a price of $0.65, a vending machine control system may (a) access product data, (b) determine, in light of stored profit management rules and product data, a benefit offer comprising a dynamically priced upsell, (c) output a game-themed presentation indicating the benefit offer (e.g. a “prize wheel” spins and lands on “Take any blinking green item instead of your change!”), and/or (d) provide or enable the benefit (e.g. by receiving the customer's selection of a Twix® candy bar as an acceptance of the dynamically-priced upsell, and dispensing the Twix® and Snickers® candy bars).

Thus, in some bonus benefit embodiments, a vending machine customer may first select at least one product in a manner detailed previously (e.g. by inputting payment and pressing “A-1” on an external vending machine keypad). Additionally, as described above, product data may be updated and/or recorded to reflect any changes associated with the selection of a product (e.g. a decrease in inventory, increase in actual sales rate).

5.2 Access Product Data

In some bonus benefit embodiments, the vending machine may access product data after a customer has first selected at least one product. In various embodiments, product data may be recorded, updated and/or retrieved at various times. Further, various types of product data may be stored in one or more vending machine databases or in any manner such that data may be otherwise accessible by a vending machine control system (e.g., stored on a remotely accessible server).

In some bonus benefit embodiments, a general benefit may comprise (i) a “bonus” product (e.g. a benefit offer to a customer of a single product vending 30 machine, who has selected a Twix® candy bar as a first product, may be: “Winner! One free Snickers® bar!”), and/or (ii) an opportunity to purchase one or more vending machine products at less than their respective retail prices (e.g. a benefit offer may be a dynamically-priced upsell, such as: “Select any blinking green item to receive instead of your change!”).

Accordingly, in some embodiments, retrieved product data may comprise any data associated with the inventory of a vending machine as described herein (general product data). Various descriptions of such data and visual examples depicting hypothetical databases thereof are described herein.

Additionally, in some embodiments, retrieved data may comprise “machine status data,” which may consider (i) aggregate machine sales data (e.g. a machine has X total units of product in stock, has made a total of Y in profit during the current fill period, has sold an average of Z units/day during the current fill period), (ii) the current date and time, (iii) the amount of time remaining until a restock date, (iv) the amount of coins (e.g. number of units of each denomination) stored in a vending machine currency storage device, and/or (v) any other data related generally to a specific vending machine. Table 8 below illustrates an example of a “machine status database” according to one embodiment.

TABLE 8

| | | Total | | Average | | | |
|---|---|---|---|---|---|---|---|
| Total Units | Total | Profit | Average | Velocity | Total | Days | |
| Initially | Units | (in fill | Profit | (Units | Coins | Until | |
| Stocked | Remaining | period) | per Day | per Day) | Remaining | Restock | Date/Time |
| 180 | 30 | $37.50 | $1.88 | 7.5 | $12.70 | 10 | Sunday, |
| | | | | | | | 10/04/05, |
| | | | | | | | 8:00 p.m. |

Still further, in some embodiments (e.g. wherein a general benefit comprises a product benefit or an opportunity to purchase a product at a reduced price), retrieved product data may comprise “benefit acceptance data,” which may indicate the acceptance rate of one or more previously determined and offered general benefits. In some embodiments, the acceptance rate of a general benefit which has been previously offered (e.g. outputted as the result of a game-themed presentation) may be expressed by the following formula:

$$ACCEPTANCE RATE = \frac{\# OF ACCEPTANCES}{\# OF PRESENTATIONS}$$

For example, if a specific general benefit (e.g. a dynamically-priced upsell for a Snickers® candy bar in lieu of change) is offered as the result of fifty game-themed presentations (e.g. offered to fifty different customers during fifty separate transactions), and is “accepted” thirteen times (e.g. thirteen different customers chose receive a Snickers® bar instead of their change), an acceptance rate (e.g. 13/50=“0.26” or “26%”) may then be associated with the general benefit offer.

Further, in some embodiments, wherein a general benefit offer provides an opportunity for a customer to purchase an additional product at a discounted price, each of different “discount amounts” associated with the provision of the same additional product may be represented as a unique benefit offer. For example, one offer may be for Doritos® chips to be sold at a first price, and another offer may be for Doritos® chips to be sold at a second price.

A discount amount may be defined by the difference between an amount a product is offered for sale for (i.e. the “sale price”) and the product's retail price. For example, if the retail price of Doritos® chips is $0.55, and a unit of Doritos® chips is offered for $0.40 as the result of a first fixed-price upsell, the first fixed-price upsell may represent a unique general benefit with a discount amount of $0.15. If a unit of Doritos® chips is offered for $0.50 as the result of a second fixed-price upsell, the second fixed-price upsell may represent a unique general benefit with a discount amount of $0.05.

Such “discount amounts” may be embodied in a coupon having a face value that corresponds to the discount amount. Different coupons (e.g., coupons for the same product but different discount amounts) may be considered different offers.

It can be advantageous to determine the acceptance rate for different offers. For example, if general benefit offers are defined by a coupon for a unit of Twix® candy bar, a different acceptance rate may be determined for each Twix® candy bar coupon value (e.g. such that an acceptance rate for a “$0.25 off Twix®!” coupon may be 30%, whereas an acceptance rate for a more attractive “$0.50 off Twix” coupon may be 70%). Table 9 illustrates an exemplary “benefit acceptance database” which records benefits and corresponding acceptances.

TABLE 9

| Benefit | Benefit | Discount | Presen- | Accep- | Acceptance |
|---|---|---|---|---|---|
| Offered | Type | Amount | tations | tances | Rate |
| Snickers ® | Dynamic | $0.30 | 50 | 35 | 70% |
| candy bar | Upsell | | | | |
| Snickers ® | Dynamic | $0.25 | 50 | 27 | 54% |
| candy bar | Upsell | | | | |
| Snickers ® | Coupon | $0.10 | 50 | 4 | 8% |
| candy bar | | | | | |
| Twix ® | Dynamic | $0.25 | 50 | 29 | 58% |
| candy bar | Upsell | | | | |
| Twix ® | Coupon | $0.30 | 50 | 17 | 34% |
| candy bar | | | | | |
| Twix ® | Fixed | $0.05 | 50 | 7 | 14% |
| candy bar | Upsell | | | | |
| Dentyne ® | Fixed | $0.05 | 50 | 3 | 6% |
| gum | Upsell | | | | |
| Doritos ® | Full | $0.60 | 50 | 50 | 100% |
| chips | refund | | | | |
| Cheetos ® | “Free” | $.60 | 50 | 44 | 88% |
| snack | product | | | | |

Employing a structure to store data such as that stored in Table 9, benefit acceptance data may be retrieved and analyzed in light of stored profit management rules in order to facilitate the determination of a general benefit offer (e.g. which defines a product benefit or an opportunity to purchase one or more products at a discounted price). Further, as general benefits are accepted and rejected, the benefit acceptance data may be updated on a periodic or event-triggered basis (e.g. so as to reflect a change in an acceptance rate).

In further bonus benefit embodiments, a general benefit may comprise an opportunity to receive or purchase at a discount one or more products not sold during routine vending machine transactions (e.g. “non-food products” or services, such as a phone card, via a food vending machine). Accordingly, in such embodiments, retrieved data may comprise “non-food product data,” which may describe (i) the number of units of one or more non-food products in inventory, (ii) the acceptance rate associated with one or more non-food products, (iii) the unit cost of one or more non-food products, (iv) subsidy information pertaining to one or more non-food products (e.g. a third-party phone card manufacturer pays a premium to a vending machine operator for each phone card that is provided to a customer as a general benefit), (v) operator-programmed promotion instructions (e.g. during this fill period, provide every customer with a “third-party sweepstakes entry” general benefit), and/or (vi) any other data relevant to one or more non-food products.

Such products not sold during routine vending machine transactions may be stored in one or more rows of vending machines, which are stocked with transparent containers, each containing a prize (e.g. digital watches, $20 bills, phone cards). The vending machine control system may be programmed to only dispense items from such “prize rows” when a customer has won a prize. Thus, such prize rows would not be selectable by customers who attempt to purchase a prize from a prize row.

In this manner, various types of product data (i.e. general product data, machine status data, benefit acceptance data and/or non-food product data) may be retrieved (e.g. accessed by a vending machine control system) pursuant to the process of determining of one or more general benefit offers in light of stored profit management rules.

5.3 Determine Whether to Offer at Least One Benefit

In some embodiments, after a customer has selected at least one vending machine product (e.g. during a transaction of a single product vending machine), and data has been accessed, one or more general benefit offers may be determined in light of the accessed data and stored profit management rules. In some embodiments, only one type of product data may be accessed (e.g. only general product data). In other embodiments, more than one type of product data may be accessed (e.g. a vending machine control system may access a product database and a machine status database for analysis in light of stored profit management rules) so as to determine one or more general benefit offers.

In various embodiments, a general benefit may comprise one or more of: (i) a discount or “promotional price” for one or more products (or a group thereof), (ii) a refund of the cost (or portion thereof) of one or more already-selected products, (iii) a dynamically priced upsell, (iv) a fixed price upsell, (v) free or discounted alternate, non-food products (e.g. a phone card not sold during routine machine transactions), (vi) a sweepstakes or contest entry, (vii) a free or discounted vending machine subscription or membership, (viii) an opportunity to procure additional benefits (e.g. a free spin of a prize wheel game-themed presentation), (ix) one or more bonus products, and/or (x) any other entitlements whose provision may lead to an increase in expected vending machine profitability.

In some embodiments, a general benefit may comprise a bonus product which is provided subject to vending machine “status” data. For example, after a customer of a single product vending machine has inputted payment and selected a Diet Coke® soda, a general benefit offer may entitle the customer to a free, additional product (e.g. the result of a game-themed presentation is “Winner! One free A&W Root Beer®!”). In such embodiments, a vending machine control system may access (i) general product data, (ii) machine status data and/or (iii) benefit acceptance data, in light of one or more stored profit management rules in a manner such that one or more particular product benefits (free products) may be determined. In some embodiments, a vending machine control system may first retrieve machine status data to determine whether or not a vending machine's “status” warrants the provision of one or more free products (e.g., the provision of one or more free products may increase expected profitability). One or more stored profit management rules may then be used to make such a determination. Table 10 below illustrates an example of a “machine status rules database”, including several exemplary rules.

TABLE 10
To increase expected profitability, offer a free product to a customer when:

| | |
|---|---|
| 1. | Machine actual velocity > machine ideal velocity |
| 2. | Total profit in fill period ≧$50.00 (target profit already exceeded) |
| 3. | There is at least one product in which: actual velocity/ideal |
| | velocity ≧2 |
| 4. | There is at least one product in which: total profit in fill period |
| | ≧$10.00 (target profit already exceeded) |
| 5. | Transaction occurs on Sunday between 5:00 P.M. and 11:00 P.M. |
| 6. | There are ≧100 total units in stock AND ≦2 days remaining in |
| | fill period |

Utilizing such a machine status rules database, profit management rules may be used to determine whether and how the status of one or more particular vending machines permits the provision of a free product in a manner which increases expected profitability. Typically, the provision of one or more free products may increase overall machine expected profitability due to increased customer satisfaction, goodwill and/or loyalty (e.g. by encouraging repeat visits and future transactions). Thus, several circumstances may arise wherein a profit management rule may determine that a vending machine should offer one or more free products.

As demonstrated by the exemplary database in Table 10 above, such rules may determine that (i) the machine has already reached a suitable profit and/or velocity threshold, as in “Rule #1” and “Rule #2,” such that a machine may provide a free product yet still expect to accrue sufficient or target profit during a fill period; (ii) one or more specific products have reached or exceeded a target velocity, as in “Rule #3” and “Rule #4,” such that one or more units of those products may be provided for free because the products have already contributed significantly toward overall machine profit; (iii) as in “Rule #5,” the time of day and/or date is such that should a free product be provided, a further transaction during a specific time period may be encouraged during a time period which is typically low sale volume (e.g. by offering free products during “off-peak” or “low-traffic” hours, customers may return during such times), (iv) a vending machine may not be likely to sell one or more products by the end of a fill period, and thus one or more products may be offered for free (e.g. if products will expire soon and possibly be thrown out anyway, provide those products for free so as to increase customer satisfaction).

Accordingly, once it has been determined that one or more free products (i.e. product benefits) may be provided (e.g. to a customer of a single product vending machine), a determination may then be made (using general product data and/or benefit acceptance data and stored profit management rules) as to which specific product to provide for free. For example, as described herein, a profit management rule may be constructed in accordance with general product data so as to select one or more products characterized by (i) low unit cost, (ii) low profit margin, (iii) a large number of units currently in inventory, etc. Additionally, one or more profit management rules may, in light of retrieved benefit acceptance data, indicate to select one or more products characterized by a high benefit acceptance rate (e.g. Snickers® candy bar has the highest acceptance rate of all products offered for free as a general benefit), such that the benefit offer has a high likelihood of being accepted by a customer (e.g. if expected profitability may be increased by increasing customer satisfaction, then select the product most likely to satisfy a customer).

In other bonus benefit embodiments, a determined benefit may comprise an opportunity to purchase one or more vending machine products at less than retail price (i.e. at a discount). For example, if a customer has selected at least one first vending machine product, a general benefit offer may comprise an opportunity to (i) purchase a second vending machine product at a discount during the same transaction (e.g. a benefit offer is a dynamically-priced upsell, such as “Pick any bag of chips instead of your change,” wherein the amount of change due is less than the retail price of any bag of chips), and/or (ii) purchase a second vending machine product at a discount during a later transaction (e.g. a benefit offer is a “$0.15 off a Snickers® candy bar Tuesday through Thursday” coupon).

In such embodiments, a vending machine control system may first analyze machine status data in light of stored profit management rules in order to determine whether, given the status of the vending machines, providing a discounted product may increase expected profitability. Such a determination of machine status may be made in a maimer substantially similar to bonus product embodiments described above. Accordingly, once it has been determined that machine status is such that outputting a general benefit offer comprising an opportunity to purchase one or more vending machine products at a discount may potentially increase expected profitability, a general benefit may be determined by analyzing general product data and/or benefit acceptance data in light of additional stored profit management rules.

In some bonus benefit embodiments, in which a customer has selected at least one first vending machine product, a general benefit offer may comprise an opportunity to purchase a second vending machine product at a discount during the same transaction. Such a general benefit offer may comprise one or more of, but is not limited to, (i) a dynamically-priced upsell or “round-up offer,” wherein the customer may purchase an additional product in exchange for an amount of change due (typically less than the product's retail price) as the result of selecting at least one first product, and/or (ii) a fixed-price upsell or “promotional price” that enables the customer to purchase an additional product for a discount (e.g. at a price that is less than full price, but that is not necessarily the amount of change due to the customer as the result of a first selected product).

In some embodiments wherein a general benefit offer comprises a dynamically-priced upsell, one or more profit management rules may be constructed in accordance with general product data and/or benefit acceptance data so as to determine one or more particular general benefit offers. Table 11 illustrates an exemplary “dynamically-priced upsell rules database” including several exemplary rules.

TABLE 11
To increase expected profitability, offer a dynamically-priced upsell
to a customer wherein:

| | |
|---|---|
| 1. | The corresponding product's unit cost is ≦$0.15 |
| 2. | The corresponding product's actual velocity is ≦0.50 units/day |
| 3. | The amount of change due > the corresponding product's unit cost |
| 4. | The acceptance rate of the benefit offer (comprising corresponding |
| | product) is ≧70% |

Product data and/or benefit acceptance data may be analyzed in light of such stored dynamic upsell rules in order to determine one or more particular dynamically-priced upsells to offer to a customer pursuant to an increase in expected profitability. For example, a rule similar to “Rule #1” may be executed so as to select a corresponding product (i.e. if a benefit offer is “Get a Snickers® bar instead of your change!”, Snickers® candy bar is the corresponding product) in a manner that reduces cost. “Rule #2” promotes the sale of corresponding products that are not selling well; “Rule #3” assures that a dynamically-priced upsell is profitable; “Rule #4” may assure that a dynamically-priced upsell offer has a high likelihood of being accepted. Any variations and/or combinations associated with these and other such rules are within the scope of the present invention.

In other embodiments, a rule may determine that the status of a vending machine is such that a general benefit comprising an opportunity to purchase one or more items at a discount may be offered (e.g. during the same transaction in which a first item is purchased at a single product vending machine). Thus, a general benefit may comprise a fixed-price upsell or promotional price (i.e. a discounted price for one or more products, specific to a particular transaction). In such embodiments, one or more profit management rules may be utilized to determine one or more specific fixed-price upsells to be presented to a customer as a benefit offer. A “fixed-price upsell rules database” may contain such profit management rules; a hypothetical depiction of such a database follows:

TABLE 12
To increase expected profitability, offer a fixed-priced upsell to a
customer wherein:

| | |
|---|---|
| 1. | The corresponding product's unit cost is ≦$0.15 |
| 2. | The corresponding product's actual velocity is ≦0.50 units/day |
| 3. | The fixed price > the corresponding product's unit cost |
| 4. | The acceptance rate of the benefit offer (comprising corresponding |
| | product) is ≧70% |
| 5. | The fixed price < the retail price |

It may be noted that several rules referencing product data and/or benefit acceptance data (e.g. “Rule #1,” “Rule #2” and “Rule #4”) may be applicable to both dynamic- and fixed-price upsell determinations pursuant to the increase of expected profitability. Moreover, certain rules (e.g. “Rule #3”) may be utilized so as to specifically assure the profitability of fixed-price upsell benefit offers. In this manner, a fixed-price upsell may (i) enable a customer to purchase one or more vending machine products at less than full price, and (ii) be constructed in accordance with one or more profit management rules so as to increase the expected profitability of a vending machine.

In other bonus benefit embodiments (e.g. wherein a customer has selected at least one first vending machine product during a transaction of a single product vending machine), a general benefit offer may comprise an opportunity to purchase a second vending machine product at a discount during a later transaction (e.g. a benefit offer is a “$0.15 off Snickers® candy bar Tuesday through Thursday” coupon). Accordingly, should the status of a machine (e.g. as determined by a profit management rule) be such that a benefit offer may comprise an opportunity to purchase one or more additional products at a discount during a later transaction, one or more profit management rules may be constructed in accordance with general product data and/or benefit acceptance data so as to determine a benefit offer that increases a vending machine's expected profitability.

In such embodiments, a benefit offer may comprise a coupon provided via a vending machine output device (as is well known), enabling a customer to redeem a discount during a later transaction. In some embodiments, a coupon may be tangible (e.g. including a paper or other substrate that is outputted via a printer). In other embodiments, a coupon may be intangible (e.g. rather than print a tangible coupon, a vending machine display device outputs a code which a customer may then input via a keypad during a later transaction). Accordingly, in some embodiments, a coupon may comprise a means for validation (e.g. a barcode, a machine-readable substrate), such that valid redemption requests (e.g. issued, non-duplicate codes) may be honored upon a customer's return visit to one or more machines.

Accordingly, various profit management rules may be constructed in accordance with general product data and/or benefit acceptance data so as determine a coupon (e.g. general benefit offer), which may then be presented to a customer (e.g. in conjunction with a game-themed presentation) so as to increase a vending machine's expected profitability. Such profit management rules may be stored in a “coupon rules database,” a hypothetical example of which is illustrated in Table 13 below.

TABLE 13
To increase expected profitability, offer a coupon to a customer wherein:

| | |
|---|---|
| 1. | The corresponding product's unit cost is ≦$0.15 |
| 2. | The corresponding product's actual velocity is ≦ target velocity |
| 3. | The coupon may only be redeemed 5:30 P.M.-9:00 P.M. |
| 4. | The acceptance rate of the benefit offer (coupon) is ≧70% |
| 5. | The discount amount is ≦$0.15 |
| 6. | The corresponding product is Cheetos ® snack |
| 7. | The sale price > unit cost |

A profit management rule may determine to offer a coupon such that (i) one or more specific products are promoted (e.g. a product with a low unit cost), (ii) customers may be driven to transact at vending machines during certain times (e.g. “off-peak” or “low-traffic” periods), (iii) the coupon has a high likelihood of being accepted (e.g. high acceptance rate), and/or (iv) expected profitability may be increased in any manner described herein.

Any combination of rules may be used to determine a benefit offer involving a coupon. For example, if a determined coupon is “$0.15 off your next Dentyne® gum purchase Friday 5:00 P.M. to Monday 9:00 A.M.,” then multiple profit management rules may have been utilized to construct the offer such that (i) the unit cost of the product is low, (ii) the product has been selling at a less-than-desirable velocity, (iii) the customer may be driven to transact during off-peak hours, (iv) the discount amount is relatively low, etc.

In various bonus benefit embodiments, a profit management rule may indicate to offer an inventory group (e.g. of coupons for discounted products) from which at least one may be selected by a customer as detailed previously herein (see product entitlement embodiments).

In further embodiments wherein a benefit offer may comprise an opportunity to purchase one or more products at a discounted price, a general benefit may comprise a refund of at least one first-selected item. For example, if a customer (i) approaches a single product vending machine, (ii) inserts $1.00 into a bill validator and (iii) selects Sprite® soda for $0.75, a game-themed presentation may occur in a manner such that (i) the result of the presentation is a general benefit offer comprising a refind (“Winner! $0.75 refund!”), (ii) the first-selected product is provided (a unit of Sprite® soda is dispensed) and (iii) payment for the first-selected product is returned to the customer (e.g. four quarters are provided via a change dispenser). Refunds for one or more particular first-selected products may be determined based on profit management rules that consider machine status data and product data as described herein (e.g. in a manner substantially similar to embodiments involving the provision of free or discounted products).

In further bonus benefit embodiments, a general benefit may comprise a product not typically available for sale at the vending machine (e.g., a non-food product benefit at a food vending machine). In some embodiments, a non-food product benefit (e.g., at a food vending machine) may comprise a free product (and/or service, such as a pre-paid phone card) and/or an opportunity to purchase such a non-food product at a discount. In some embodiments, a non-food product benefit may be determined and offered to every customer of a vending machine (e.g. at the conclusion of every transaction). In other embodiments, a non-food product benefit may be determined and offered in accordance with one or more machine status rules as described herein (e.g. if total machine profit in fill period exceeds a threshold, offer a non-food product benefit). Additionally, a vending machine control system may, in light of retrieved machine status data, non-food product data and/or at least one first selected product, determine to offer one or more non-food product benefits based on one or more stored rules, which may be stored in a “non-food product rules database.” Table 14 illustrates such a database.

TABLE 14
To increase expected profitability, offer a non-food product to a
customer wherein:

| | |
|---|---|
| 1. | The non-food product has ≧20 units in stock |
| 2. | The margin of first selected product is ≧$0.20 |
| 3. | The manufacturer of first selected product is Mars ™ |
| 4. | The acceptance rate of the benefit offer (non-food product) is ≧70% |

Utilizing such data, one or more non-food product benefits may be determined and offered to vending machine customers in a manner such that expected profitability may increase (e.g. if a third-party pays a vending machine operator a bounty for each non-food product distributed, then customers receiving non-food products from vending machines are likely to return to those machines for future transactions).

In still further bonus benefit embodiments, a general benefit may comprise a subscription to one or more vending machines. Such a subscription may provide a customer with an opportunity to procure a certain number of products during a certain time period and/or at certain frequencies (e.g. “One Diet Coke® soda per week during the month of June”).

In some embodiments, a general benefit may comprise a free subscription. In other embodiments, a general benefit may comprise an opportunity to purchase a subscription at a discount (e.g. “Get nine cans of Sprite® soda for $5.00—redeem by April 1”). Since a subscription may effectively provide a customer with one or more free or discounted products (depending on the subscription price compared to aggregate retail prices of all units in the subscription), determinations for providing subscriptions may be made in a manner substantially similar to determining benefit offers comprising free or discounted products (discussed in previous bonus benefit embodiments). For example, a vending machine control system may (i) execute a stored machine status rule determining to offer a free product as part of a subscription, (ii) determine, in light of product data, benefit acceptance data and/or or more stored “subscription rules” to offer a discounted subscription (e.g. a subscription may be “Four bags of Doritos® tortilla chips for $2” if Doritos® have low unit cost and are not selling at a desired velocity).

Additionally, a determination to provide a subscription may consider (be based at least in part on) at least one first-selected product. For example, if a customer selects a Snapple® Lemon Iced Tea during a transaction of a single product vending machine, a vending machine control system may determine to offer a subscription including Snapple® products. A general benefit comprising a subscription may additionally comprise a means for redeeming the subscription during later transactions (as discussed in “coupon” embodiments). Subscription offers are described at length in Applicant's patents: U.S. Pat. No. 6,298,972, entitled METHOD AND APPARATUS FOR ESTABLISHING AND MANAGING VENDING MACHINE SUBSCRIPTIONS, issued Oct. 9, 2001; U.S. Pat. No. 6,085,888, entitled METHOD AND APPARATUS FOR ESTABLISHING AND MANAGING VENDING MACHINE SUBSCRIPTIONS, issued Jul. 11, 2000; and U.S. Pat. No. 5,988,346, entitled METHOD AND APPARATUS FOR ESTABLISHING AND MANAGING VENDING MACHINE SUBSCRIPTIONS, issued Nov. 23, 1999. The entirety of each of these patents is incorporated by reference herein.

In still further bonus benefit embodiments, a general benefit offer may comprise an entry to a contest or sweepstakes (e.g. “Winner! You've been entered in a drawing for a Ford Explorer!”). In some embodiments, machine status data and associated rules may determine whether or not to present a sweepstakes or contest entry as a general benefit offer to one or more vending machine customers. In some embodiments, winners of such a sweepstakes may be entitled to receive one or more vending machine products (e.g. a contest winner gets one of each product of a vending machine); such products may be determined as discussed previously (e.g. bonus product embodiments). In other embodiments, winners may receive non-food products (e.g. a contest winner receives an Apple iPod® music player) at a food vending machine. Such non-food product benefits may be determined as discussed previously (i.e. non-food product embodiments). For example, applicant's co-pending patent application, entitled SYSTEM FOR VENDING PHYSICAL AND INFORMATION ITEMS, Ser. No. 09/713,001, filed Nov. 17, 2000, incorporated herein by reference, discusses the vending of music files and other information.

Further, in some embodiments, a vending machine control system may determine to offer a sweepstakes or contest entry to a limited number of vending machine customers (e.g. only 1,000 entries will be allowed). In other embodiments, every customer of a vending machine may be presented with a benefit offer comprising a sweepstakes or contest entry. In still further embodiments, a customer may only be provided with a benefit offer comprising a sweepstakes or contest entry if various customer data is provided, as discussed further herein (e.g. customers provide an e-mail address via a vending machine input device so that winners may be notified upon the completion of a sweepstakes or contest drawing).

In yet further bonus benefit embodiments, a general benefit offer may comprise an opportunity to receive additional benefit offers (e.g. a benefit offer is a free spin of an animated prize wheel game-themed presentation). Such benefit offers may be determined (i) based on machine status data (e.g. if a machine has met a profit goal, a general benefit may comprise a free spin), (ii) based on at least one first-selected product (e.g. if the margin of at least one first-selected product is larger than a predetermined threshold, a general benefit offer may comprise a free spin), (iii) randomly (e.g. a vending machine control system receives a signal from a random number generator which indicates that a free spin should be presented to a customer), and/or (iv) in a any other manner.

Various other types of benefit offers are contemplated within the scope of the present invention, so long as such benefit offers may increase expected profitability by (i) increasing the profit margin of vending machine transactions (e.g. by selling items with lower unit costs and/or higher retail prices), (ii) increasing the actual velocity of items sold (e.g. in some embodiments, profit management rules may indicate that expected profitability increases if products are sold at a lesser profit margin, but with a sufficiently offsetting increase in volume), (iii) establishing, increasing, or promoting the overall customer loyalty and/or goodwill associated with one or more machines (e.g. customers who receive benefits may perceive machines to be valuable and/or entertaining, and therefore may return to machines for future transactions), and/or (iv) any other method described herein. Additionally, any combination of benefit offers may be determined and presented in any manner described herein (e.g. a benefit offer may comprise a dynamically-priced upsell as well as an opportunity to receive additional benefit offers: “Take any green item instead of your change—AND spin again!”).

Additionally, in some embodiments wherein a general benefit may comprise a product benefit and/or an opportunity to purchase a product at a discount, one or more restriction rules may be utilized in determining whether or not a particular general benefit may be offered. As discussed in relation to product entitlement embodiments, a restriction rule may determine that a certain product benefit may or may not be offered depending on at least one first selected product.

For example, during a transaction of a single product (non-package deal) vending machine, if a customer chooses a bag of chips as a first selected product, a restriction rule may dictate that a product benefit comprising a pack of gum may not be offered to the customer.

In this manner, general product data, machine status data, benefit acceptance data and/or non-food product data may be analyzed in accordance with various profit management rules so as to determine a general benefit offer to be presented to a customer as the result of a game-themed presentation.

5.4 Output a Game-Themed Presentation

In some bonus benefit embodiments, once a general benefit offer is determined, it may be indicated to a vending machine customer employing a game-themed presentation.

In some embodiments, a game-themed presentation may be outputted to a customer via one or more vending machine output devices as previously described. For example, a presentation may comprise a game-themed animation depicted on an LCD display with accompanying sound effects emitted via audio speakers. Additionally, in some embodiments, a game-themed presentation may incorporate various other types of machine hardware (e.g. LED price displays) as described further herein.

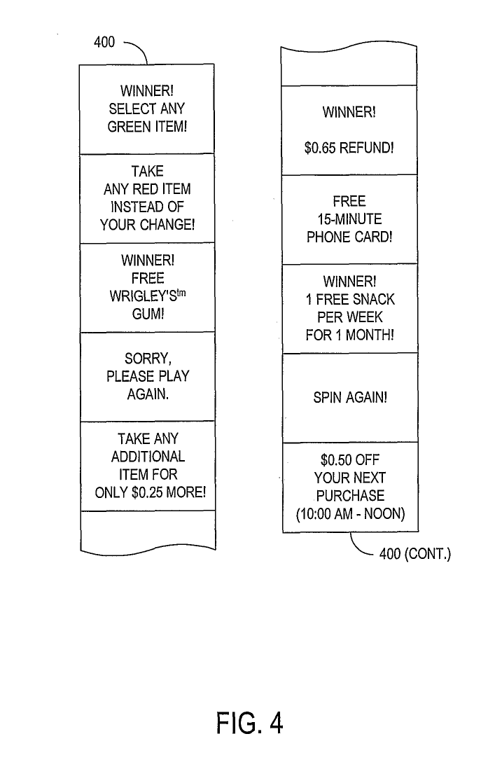

In various product entitlement embodiments wherein a general benefit offer has been determined, game-themed presentations may comprise one or more of several different themes so as to indicate a determined benefit offer as the result of such a presentation (FIG. 4 illustrates by way of example some potential bonus benefit game results). Several examples of such themes are described herein. Any means of communicating a determined benefit offer as the result of a game-themed presentation are within the scope of the present invention, such means including but not limited to (i) text and/or numerals, (ii) audio, (iii) graphics, photographs or other icons, and/or (iv) any combination thereof.

Additionally, in some embodiments wherein a general benefit offer comprises an opportunity to receive additional benefit offers (e.g. a free spin of a prize-wheel game), more than one game-themed presentation may be outputted to a customer (e.g. an animated prize wheel spins, lands on “Spin Again!”, animates once more, and lands on “Take a pack of Dentyne® gum instead of your change!”). In some embodiments, after viewing a first game-themed presentation, further input may be required from a customer before a second game-themed presentation is outputted (e.g. a customer must press a “Spin Again!” button of an input/output device). In other embodiments, a second game-themed presentation may be outputted automatically (e.g. upon the conclusion of a first game-themed presentation, a prize wheel automatically animates once again).

5.5 Provide at Least One Benefit

In some embodiments, once a determined general benefit has been indicated to a player as the result of a game-themed presentation, the benefit may be provided in a manner such that no further input or action is required from a customer. For example, in an embodiment wherein a determined general benefit comprises a free product (e.g. a prize wheel spins and lands on “Winner! Free Lays® Potato Chips!”), the benefit may be provided in a substantially automatic manner (e.g. one or more vending machine dispensing mechanisms may then receive a signal from a control system, and actuate so as to dispense the bag of chips, without requiring any further commands or instructions from a customer).

In other embodiments, a determined benefit may only be provided after receiving further input from a customer (e.g. via one or more input or input/output devices described herein). For example, in an embodiment wherein a determined general benefit comprises an opportunity to purchase one or more discounted vending machine products during a first transaction, (e.g. a benefit offer comprises a dynamically-priced upsell offer: “Take a Snickers® bar instead of your change!”), a further selection, decision, command and/or instruction may be required from a customer before the benefit is provided (e.g. a customer selects an “OK—Give me the Snickers® Bar!” button displayed on a touch screen input/output device, the candy is dispensed, and the customer's change is routed internally to a machine coin storage device rather than to a change dispenser). Further, input regarding a selection of at least one product from at least one inventory group (e.g. “Take any blinking green item instead of your change!”) may be required and received in any manner as discussed previously. In contrast, in some bonus benefit embodiments (e.g., wherein a game-themed presentation concludes in the presentation of a general benefit offer), a vending machine customer may provide further input so as to, e.g., reject a benefit offer (e.g. a customer presses a “No thanks—Just give me my change!” button).

In some bonus benefit embodiments, a general benefit comprising a vending machine product (e.g. provided for free or at a discount) may be dispensed via a product delivery system (e.g. a delivery bin or chute) in accordance with any distribution functions or dispensing mechanisms (e.g. dual helices) described herein and/or known in the art.

As stated, in other bonus benefit embodiments, a general benefit may comprise an opportunity to purchase one or more vending machine products at a discount during a later transaction (e.g. a benefit offer comprises a coupon printed via a vending machine output device). In such embodiments, before a corresponding product is provided for a discounted price, it may be necessary to validate a requested discount. Several methods for validating discounts (e.g. coupons) are contemplated and described herein. For example, a vending machine control system may first receive a “coupon identifier,” such as by (i) scanning a barcode of a physical coupon, (ii) receiving a numeric “coupon code” via an input device (e.g. external vending machine keypad), and/or (iii) receiving encoded information via a plastic card with a magnetic strip, etc. A vending machine control system may then (i) access a “coupon database” to determine if the identifier is valid (e.g. the code has been outputted but not yet redeemed), and if so (ii) make a record in the coupon database reflecting the redemption of the coupon, and/or (iii) enable that one or more corresponding products be purchased at a discount (e.g. for one transaction, the price of a corresponding product is reduced by a discount amount from full price to a sale price, a credit balance is increased by a discount amount).

Further, in an embodiment wherein a general benefit comprises a subscription, a corresponding product may only be provided if a customer's request to receive the product is valid (e.g. the customer has not redeemed every unit of Diet Coke® to which he was entitled per the terms of his subscription, the specific product requested by the customer is valid in light of the terms of the subscription). Subscription offers are described at length in Applicant's U.S. Pat. No. 6,298,972, entitled METHOD AND APPARATUS FOR ESTABLISHING AND MANAGING VENDING MACHINE SUBSCRIPTIONS, issued Oct. 9, 2001; U.S. Pat. No. 6,085,888, entitled METHOD AND APPARATUS FOR ESTABLISHING AND MANAGING VENDING MACHINE SUBSCRIPTIONS, issued Jul. 11, 2000; and U.S. Pat. No. 5,988,346, entitled METHOD AND APPARATUS FOR ESTABLISHING AND MANAGING VENDING MACHINE SUBSCRIPTIONS, issued Nov. 23, 1999. The entirety of each of these patents is incorporated by reference herein.

Still further, in an embodiment where a general benefit offer comprises a refund of payment rendered in purchasing at least one first selected product, the refund may be provided in any manner such that the purchase amount of a first selected product (e.g. $0.65) is returned to the customer (e.g. an inputted bill is returned via a bill validator, change is output via a change dispenser).

Still further, in embodiments wherein general benefit offers comprise non-food products or services not typically available for sale via the vending machine, such general benefits may be provided by any appropriate means. Methods of providing non-food product benefits may include, but are not limited to (i) a physical product (e.g. a phone card) is dispensed via a vending machine distribution function, (ii) a discount redeemable for a non-food product (e.g. a “10% off at The Gap” coupon with an accompanying redemption code) is provided via an output device (e.g. a printer), (iii) customer data is collected such that a free or discounted non-food product may be provided at a later time (e.g. in network embodiments, a customer fills in his contact information via a vending machine input device connected to a third-party Web site), and/or (iv) any other practical means.

In this manner, in light of profit management rules, restriction rules and various data, a general benefit offer may be indicated to a vending machine customer as the result of a game-themed presentation, and provided to the customer. Any processes, determinations, concepts and/or rules disclosed with respect to bonus benefit embodiments may be applicable to any other embodiments disclosed elsewhere herein.

Various additional or alternative embodiments may be included as well. Some of these embodiments ameliorate the detrimental affect that game-theme presentations may have on multiple customers awaiting transactions with a vending machine.

In some embodiments, one or more sensory device may be utilized to detect one or more external vending machine conditions, such as (i) the length (e.g. measured in seconds) of one or more vending machine transactions, and/or (ii) the approximate number of customers waiting (e.g. in a line) to transact with a vending machine. For example, a sensor may comprise a motion, weight and/or infrared sensor equipped so as to detect the presence of a person in proximity to one or more vending machines (e.g. a customer standing substantially close to the front of a vending machine cabinet is detected by a vending machine sensory device).

In various embodiments, such sensory devices may be utilized in communication with a vending machine control system so as to alter a game-themed presentation (or characteristic thereof) in light of external vending machine conditions. For example, a vending machine sensory device may detect the formation of a long line at a vending machine, and thus (i) decrease the length of one or more game-themed presentations (e.g. rather than take five seconds to resolve, a prize wheel animation concludes immediately), (ii) eliminate the chance that a game result comprises a “free spin,” and/or (iii) reveal a benefit offer without first outputting a game-themed presentation. In this manner, a vending machine may be equipped to output game-themed presentations in a maimer such that external vending machine “traffic conditions” are considered, thereby reducing the likelihood that prospective customers are discouraged from transacting with the vending machine (e.g. customers are not forced to wait in long lines as game-themed presentations are not substantially lengthy).

Various methods for detecting and marketing to prospective vending machine customers are described at length in Applicant's U.S. Pat. No. 6,324,520, entitled METHOD AND APPARATUS FOR COLLECTING AND APPLYING VENDING MACHINE DEMAND INFORMATION, issued Oct. 1, 1998, the entirety of which is incorporated by reference herein.

In another embodiment, an internal vending machine timer may be utilized to measure the time elapsed (e.g. in seconds) during one or more vending machine transactions. For example, an input device and/or sensory device may receive a signal indicating the “beginning” of a transaction (e.g. a customer inserts a dollar into a bill validator). Upon the receipt of such a signal, a vending machine processor may instruct a vending machine timer to begin measuring the time elapsed during the transaction. In some embodiments, should the length of a transaction meet or exceed a predefined threshold of time (e.g. thirty seconds or more), a vending machine may alter a game-themed presentation or result thereof (e.g. by outputting a shorter presentation, determining to offer a particular benefit as opposed to a selection of a product from an inventory group).

The “beginning” and “end” of a transaction may be represented by various events (e.g. a transaction begins when a weight sensor detects a customer in front of a machine, and ends when the weight sensor no longer detects the customer; a transaction begins upon the receipt of payment and ends upon the actuation of a dispensing mechanism). In this manner, a customer need not prevent further customers from transacting with a vending machine by unnecessarily lengthening a particular transaction (e.g. by taking too long to decide whether or not to accept a benefit offer, select a particular product from an inventory group, etc.).

In some embodiments, should situations arise wherein sensor-detected “traffic” is light (e.g. few people walk past a vending machine), a profit management rule may indicate to output bonus benefits at a higher frequency (or benefits of greater perceived value), so as to entice more customers to transact with a vending machine. Additionally, it may be determined that such “low-traffic” periods are an ideal time for presenting “attraction sequences” via vending machine display devices (e.g. an LCD screen depicts a loop of a “sample” game-themed presentation so that it is viewable to passers-by).

In some embodiments, a vending machine control system may output a game-themed presentation to a customer who has not selected or purchased any product during the transaction (e.g. a first component product of a package deal or a first selected product of a single product vending machine). Such a game-themed presentation may indicate a determined benefit offer. For example, a vending machine control system may determine, in light of machine status data, general product data, benefit acceptance data and/or corresponding stored rules, to offer a free or discounted product (as described herein). Accordingly, a vending machine may (i) continually output game-themed presentations to prospective vending machine customers (e.g. when idle or not engaged in a transaction, a vending machine outputs game-themed presentations as “attraction sequences”), and/or (ii) output game-themed presentations upon the detection of one or more prospective customers (e.g. one or more sensory devices detects a favorable “traffic condition” or person in proximity to a machine).

In some embodiments, a vending machine may output instructions to customers (e.g. via a display device) for obtaining a chance to receive benefits without first purchasing one or more vending machine products (e.g. obtain a free spin of a prize wheel game). For example, a customer may be instructed to send a self-addressed, stamped envelope to a particular address requesting a free spin. In such an example, a physical game piece indicating a “game entry code” may then be sent to the customer, such that a customer may enter the code (e.g. via an external vending machine keypad) and receive a game result without first purchasing a vending machine product.

In some embodiments, a customer may be required to pay a fee (in addition to a purchase price of a product) in order to initiate a game. Such an embodiment is particularly suitable for profit-managed, non-package vending machines. Payment further could be requested at particular times, for example, after the customer tenders currency and selects a first item, the payment of a fee for a game could be a fixed price or dynamically-priced upsell (e.g., “Instead of your change, play a game to win one or more items!”. In another embodiment, a customer can play a game without (i) depositing currency and (ii) selecting at least one product provided they pay a fee. For example, a customer could be prompted to “Insert $0.25 to win a green item!”

In some product entitlement embodiments, wherein a customer may be entitled to receive a first component product and at least one additional component product of a 2-for-$1 package deal, a vending machine control system may output a game-themed presentation indicating (i) a specific first component product and a specific additional component product, and/or (ii) one or more inventory groups from which all component products may be selected. Such game results (i.e. product benefits) may be determined based on product data and profit management rules as described herein. In this manner, any or all component products of a package deal may be determined and presented to customers as the result of game-themed presentations as detailed herein.

In some embodiments, a game-themed presentation may incorporate various machine hardware or devices, including but not limited to (i) colored “product LEDs” corresponding to each row position of a vending machine (e.g. the shelf section underneath each product of a vending machine has both a green and a red LED corresponding to that particular product), (ii) digital price displays underneath each product of a vending machine (e.g. an LED price display underneath each product displays a price for that product, e.g. $0.65), and/or (iii) any other hardware, such as dispensing mechanisms, keypads, delivery bin doors, etc.

For example, a game-themed presentation may comprise a product LED “chasing sequence,” in which adjacent product LEDs may turn on and off sequentially (e.g. so as to create the illusion that LEDs are “chasing” each other), ultimately indicating a determined benefit as the game result (e.g. the sequence “stops” such that the LED under a particular product is lit). Such a game-themed presentation may additionally comprise a roulette theme (e.g. an LCD screen depicts an animated roulette wheel that spins while the product LEDs chase each other).

A bingo-themed game presentation may also incorporate product LEDs. As detailed previously, a vending machine output device (e.g. LCD screen) may display a bingo-themed animation that may reveal one or more row positions corresponding to a determined product benefit (e.g. an animated bingo ball depicts “A-1”). Accordingly, product LEDs corresponding to such identified row positions may be actuated in accordance with the presentation (e.g. the green LED for row position A-1 is lit).

A promotional price-themed game presentation may incorporate one or more digital pricing displays. For example, in an embodiment wherein a determined benefit is a transaction-specific discount for a particular product (e.g. a promotional price or fixed-price upsell), the digital pricing display, which may have previously been used to display the retail price (e.g. $0.65) of the corresponding product, may blink, light, animate and/or otherwise change so as to alert the customer to the new, discounted sale price (e.g. $0.50).

Such embodiments incorporating various devices (e.g., vending machine peripherals) may also be utilized in accordance with game-themed presentations indicating benefit offers comprising one or more inventory groups from which one or more products may be selected. For example, the result of a game-themed presentation may comprise a “green inventory group” from which one product may be selected (e.g. a green product LED underneath each product in the determined inventory group is actuated such that a customer may easily discern all products belonging to the inventory group). Further, in an embodiment where a machine's products can be divided into two inventory groups—“red” and “green”—the green and red spaces of a roulette wheel may be used to represent such groups during game-themed presentations (e.g. if an animation depicts a ball landing on a green space, a customer may select a product from the green group). Inventory groups are described in detail in Applicant's co-pending U.S. patent application Ser. No. 10/902,397, filed on Jul. 29, 2004, which is incorporated by reference herein for all purposes.

Additionally, various vending machine devices or hardware may be utilized for the purpose of receiving promotional codes, coupon codes and/or coupon identifiers discussed herein. For example, to activate a discount (e.g. provided as the result of a game-themed presentation during a previous transaction), a vending machine customer may input an alphanumeric code via an external vending machine keypad (e.g. “90A1B75”) in a known manner. Further, the first digit of such a code may be used to identify that a promotional code, and not a product selection, is being received (e.g. if a code is “90A1B75,” a vending machine processor may recognize that an input comprising the first digit “9” applies to receiving promotional codes and not product selections). U.S. Pat. No. 5,924,078, entitled CONSUMER-PROVIDED PROMOTIONAL CODE ACTUABLE POINT-OF-SALE DISCOUNTING SYSTEM, discusses methods of accepting promotional codes from customers using a point-of-sale keypad, and is incorporated by reference herein.

In some embodiments, various alphanumeric codes may be provided via one or more vending machine output devices (e.g. a code is printed on a coupon, displayed on an LCD screen, etc.). In other embodiments, a promotional code may be provided via various other devices. For instance, in one embodiment, a promotional code may be output and received in the following manner: (i) a vending machine display device prompts a customer with the message, “To receive your discount, just remember the following sequence of products,” (ii) several product LEDs may then actuate in sequence (e.g. an LED underneath Twix® candy bar product row blinks, followed by those for Snickers® candy bar and finally Mounds® candy bar), (iii) the customer remembers and later returns to the vending machine to input the sequence (e.g. by selecting icons representing the products via an LCD input/output device, inputting the row position identifiers of the products via a keypad), and (iv) the corresponding benefit (e.g. free product) is provided to the customer.

Additionally, in further embodiments, a game-themed presentation may result in the provision of a physical “game piece” to a vending machine customer. For example, a printer may output a paper “lottery ticket” or “bingo card” which a customer may use during a later transaction to potentially redeem one or more benefits. For instance, the customer may (i) return to a vending machine at a later time, (ii) input a “lottery ticket” (e.g. comprising a machine-readable barcode and human-readable “lottery numbers”), (iii) receive an indication of a determined benefit (e.g. an animation sequence portrays a lottery drawing and the result: “3 numbers correct! Take any green item at half price!”), and (iv) receive one or more determined benefits. In other embodiments, a game piece may require further action on behalf of a customer (e.g. a customer must first visit an operator-maintained Web site and input a code printed on the game piece before receiving a promotional code useable to redeem a benefit offer of one or more vending machines). In still further embodiments, a “scratch-off” game piece may comprise a description of a benefit offer and/or a redemption code that may not be visible to a customer until, for example, a latex-based material concealing such information is removed (e.g. the customer “scratches off” a concealed area with a coin).

In some embodiments, a vending machine customer may have the ability to influence the result of a game-themed presentation. For example, a customer may (i) command a spinning prize wheel to “stop” (e.g. by pressing a “Stop!” button of an LCD screen), (ii) choose to remove an object concealing a particular benefit offer when presented with more than one concealing object (e.g. when presented with “Door #1,” “Door #2” and “Door #3,” the customer selects “Door #2”), (iii) select specific lottery numbers, a particular bingo card, etc., (iv) partake in any game of skill (e.g. answering trivia questions, selecting an appropriate icon after it has been “shuffled” via an animation sequence, remembering the location of concealed icons such as in a “memory” game, etc.), and/or (v) command, input, or interact with a vending machine game-themed presentation in any way so as to influence the game result. In some embodiments, in accordance with stored data and profit management rules as described herein, a vending machine control system may determine a unique pool of potential benefit offers relative to such “customer influence” embodiments before outputting a game-themed presentation (e.g. such that when a customer “stops” a prize wheel, a particular determined benefit offer may still increase expected profitability as all sections of the prize wheel represent benefit offers determined in such a manner).

In other embodiments, a vending machine customer may be provided with the perception of influence over the result of a game-themed presentation, however the game result may be determined regardless of the customer's input or actions. For example, a customer may command an animated, spinning prize wheel to “stop,” providing the customer with the illusion that they have influenced the result of the game-themed prize wheel presentation, however the result may have already been determined (e.g. “Pick any green item instead of your change!”).

In one embodiment, a group of customers who live (or work, attend school, etc.) in proximity to one or more particular vending machines (e.g. residents of an apartment building, laborers in the same office complex, etc.) may work collaboratively toward a game result. For example, a vending machine LCD touch-screen may output a crossword puzzle game, wherein each customer may have an opportunity to enter a word. If the puzzle is solved completely before a certain deadline, each customer (or, e.g., resident) may be entitled to a discount or other benefit. Further, a particular customer might work cumulatively (e.g. tracked over the course of several vending machine transactions) toward solving a puzzle or achieving a certain game result.

In some embodiments in which customers influence game results through player skill, “high scores” or other player achievements may be output via a vending machine display device. In this manner, customers may enjoy the psychological benefit of their name or initials being displayed in association with a particular game achievement.

In some embodiments, a benefit may comprise an increase in a vending machine customer's credit balance (money available for making purchases). For example, if a customer approaches a single product vending machine and inputs payment of $0.55, a game-themed presentation may indicate a balance increase before a first product is selected (e.g. “Winner! $0.10 toward your purchase!”), such that a customer may purchase a more expensive item than planned.

Such balance increases may be determined in any manner detailed herein referencing stored data (e.g. machine status data) and associated profit management rules. In some embodiments, a customer may only use a balance increase in purchasing one or more vending machine products (e.g. during a specific transaction, else the balance increase is forfeited). In other embodiments, a customer may “cash out” such a balance increase (e.g. no purchase is required). In further embodiments, balance increases may only be redeemed for certain products (e.g. those determined by stored profit management rules referencing product data).

Further, in some embodiments, a benefit offer may comprise an opportunity for a customer to increase his balance by inputting currency (e.g. coins) of a particular denomination (e.g. as the result of a game-themed presentation, a customer may be presented with a benefit offer stating, “Double your money! Every dime you insert is worth $0.20!”). In some embodiments, such balance increases may only be redeemed for certain products (e.g. those determined by stored profit management rules referencing product data). Additionally, in other embodiments, the particular denomination of currency (e.g. dimes) may be determined by one or more rules referencing machine status data (e.g. a particular vending machine maintains an unacceptably low number of dimes in inventory; thus, a machine's inventory of dimes may increase as customers are motivated to input more of such a denomination than they otherwise would have).

In a still further embodiment, a customer may be provided with a benefit for depositing a certain amount of currency. For example, a customer may be provided with a benefit if a machine's credit balance is more than $20.00.

In some embodiments, a benefit offer determination may consider “customer data,” which may be recorded, stored and/or updated in a “customer database” in any manner detailed herein. For example, each customer of a vending machine may (i) partake in a registration process (e.g. performed at a vending machine or at an operator-maintained Web site), (ii) be assigned a unique alphanumeric customer identifier (e.g. “1285732”), (iii) be provided with a means for indicating the customer identifier to a vending machine (e.g. a customer may key in an alphanumeric code via an external vending machine keypad, swipe a plastic “customer card” comprising a magnetic stripe encoding the customer identifier), (iv) indicate the customer identifier before a particular vending machine transaction, and (v) be presented with various benefit offers based on the received identifier, customer data and stored “customer rules.” Customer data may describe various purchase behavior associated with one or more particular customer identifiers. For example, a customer rule may indicate that if a customer has purchased fewer than two items during the current fill period, a determined benefit offer should comprise a dynamically-priced upsell. In another example, a customer rule may indicate that if a customer has purchased more than one Diet Coke® soda during the current week, a determined benefit offer should comprise a coupon for Diet Pepsi® soda. In this manner, individual customers of a vending machine may be marketed to in a manner such that determined benefit offers may (i) more accurately reflect customer tastes, and thus (ii) have a higher probability of being accepted, thereby having a positive effect on expected profitability.

In some embodiments, after being presented with a benefit offer, a vending machine customer must first meet one or more further requirements (e.g., perform a specified task) before a benefit is provided. For example, in an embodiment wherein a benefit offer states, “Free Snickers® candy bar! Just enter your e-mail address!”, a customer must first provide his e-mail address (e.g. via a vending machine keypad, operator-maintained Web site, etc.) before being provided with a Snickers® bar (the product benefit). In another embodiment, a customer must first purchase a certain amount of products from one or more vending machines before a benefit is provided (e.g. “Buy nine sodas, get the tenth free!”).

In some embodiments, game-themed presentations and the results thereof may be output via a display screen of a user device, such as a personal computer, PDA, cellular phone or the like. For example, a customer may use a personal computer to access a Web site maintained by a vending machine operator, elect to play a game and be presented with a benefit offer (e.g. as the result of an interactive game or game-themed presentation). In such embodiments, a benefit offer may comprise not only a description of the benefit, but also (i) a redemption code that must be keyed in to receive the benefit (e.g. 9-12345), and/or (ii) an identification of at least one particular vending machine at which the benefit must be redeemed (e.g. “The machine in the lobby of 5 High Ridge Park, Stamford, Conn., 06905”).

In some embodiments, a customer may signal via an input device to begin a game-themed presentation. Exemplary input devices of such embodiments include, but are not limited to buttons, keys, levers, biometric inputs and the like.

In some embodiments, various other output devices (e.g. flashing lights, spotlights, audio speakers, bells, whistles, etc.) may be actuated upon the output a one or more particular game results. In this manner, the excitement a customer may experience by winning a benefit may be enhanced (e.g. as lights flash and audio speakers emit an emphatic “Winner!” voice recording).

An embodiment of the invention includes a method comprising:

retrieving, from a database, data that represents vending machine products;

determining, based on the retrieved data, at least one benefit;

outputting a presentation which indicates the at least one benefit, in which the presentation is output employing a game theme;

providing the at least one benefit.

The text of U.S. patent application Ser. No. 10/902,397, filed on Jul. 29, 2004, is below:

Definitions and Exemplary Usage of Certain Terms Below

Actual Product Velocity, Actual Sales Rate—The actual rate at which a given product is sold by a vending machine during a sales period. The actual rate may be expressed in various forms, including units sold per time, sales revenue per time, and gross profit per time.
Component Product—a product, of which a unit may be sold (e.g., pursuant to an offer) along with at least one other unit of the same or another product.
Fill Period, Sales Period—The period of time between restock dates.
Full Price, Retail Price—In some embodiments, the price that is normally charged for the purchase of one unit of a given product when purchased alone, (i.e. not as a component product).
Ideal Product Velocity, Target Product Velocity, Ideal Sales Rate, Target Sales Rate, Target Velocity—The desired rate at which a given product should be sold by a vending machine during a period of time, such as a sales period. The desired rate can help achieve various goals, including a desired profit, sales, inventory level and/or amount of transactions. Moreover, such goals can be represented as, e.g., a value to be achieved by a certain time, or as a value averaged over a period of time. Thus, in some embodiments, an ideal velocity may be set or calculated for each inventoried product indicating the rate at which products must be sold in order to deplete the vending machine's inventory to a certain level by the end of a given sales period (i.e. by the restock time/date or an expiration time/date). For example, an ideal product velocity may be calculated by a vending machine control system after an operator inputs a restock date and a desired remaining inventory for the restock date (e.g. an operator may wish to have only one unit of each product remaining at the restock date so that the machine sells as many units as possible without completely selling out and thereby disappointing customers). Thus, if an operator (a) stocks 50 units of Soda A, (b) inputs a restock date fourteen days away, and (c) indicates that only one unit of Soda A should remain at the restock date, the control system may divide 49 by 14 to conclude that, on average, 3.5 units of Soda A must be sold per day within the sales period in order to realize the ideal product velocity. As discussed herein, a vending machine control system may periodically, substantially continuously, or otherwise evaluate the difference between a product or products' actual product velocity and ideal product velocity for the purpose of making package offer decisions (e.g. in proactive inventory grouping embodiments, determining which products to assign to a certain inventory group). The actual rate at which a given product should be sold may be expressed in various forms, including units of the product sold per time, sales revenue from sales of units of the product per time, and profit from sales of units of the product per time.
Income Contribution Factor, Profit Contribution Factor—A measure of the revenue or profit realized due to the sale of a particular product. In some embodiments, a product's income contribution factor may be defined by the total amount of revenue or the total amount of profit generated by the product during a certain time period (e.g. during a fill period, between certain dates, every twenty four hours). In other embodiments, a product's income contribution factor may be represented as a percentage, such as that which may be calculated by dividing the amount of profit generated by the product in a certain period of time by the total amount of profit generated by some or all products sold through the vending machine in the time period. For example, if a vending machine realized $100 in total profit during a fill period, and a certain product was responsible for generating $12 of the profit, that product's income contribution factor could be represented as the percentage ‘12%’. In some embodiments, an income contribution factor may be used for the purpose of determining how to allocate a product to one or more inventory groups.
Inventory Group, Package Group—A set of products. An inventory group may include a single product, or more than one product. In many embodiments, a customer may select a component product from an inventory group. In certain proactive inventory grouping embodiments, pursuant to a package offer, customers may select at least two component products, a component product selected from each of at least two inventory groups, for a single price. In reactive inventory grouping embodiments, pursuant to a package offer, customers may select a second component product from an inventory group that is revealed after a first component product is selected from a first inventory group. In one or more embodiments, inventory groups may be communicated to customers through colored LEDs located proximately to inventoried products (e.g. products in a “red” group may be communicated via proximately located red LEDs; products in a “green” group may be communicated via proximately located green LEDs). In proactive and reactive inventory grouping embodiments, inventory groups may be “reactively? Automatically?” determined by a vending machine control system during a sales period. In other embodiments, inventory groups are not determined reactively? Automatically? (as in proactive or reactive inventory grouping embodiments), but are rather determined prior to a sales period by an operator or other person, and are stored (e.g., as rules in a database) accessible to a vending machine control system.
Operator—The owner (or employee or agent thereof) of a vending machine.
Package Offer, Package Deal, Combination Deal, Combination Offer, Combination Product Offer, “Load-up ” Deal, Value Combo Deal, Combo Deal—An offer enabling a customer to purchase at least two products. In many embodiments the at least two products are sold for a single price. In many embodiments, the two products are dispensed to the customer essentially simultaneously (e.g., within seconds of each other). Typically, package offers are configured so the price of the at least two products is less than the sum of the prices of the two products, and thus the customer saves money compared to the sum of the individual component products' retail prices.
Package Instance, Potential Package—A combination of specific component products according to a package offer. Thus, a package offer defines one or more (but typically many) package instances. In some embodiments, package instances are constructed and compared to other package instances for the purpose of determining which products may be made available for selection by a customer pursuant to a package offer. In some proactive inventory grouping embodiments, package instances are constructed and compared in order to determine how to apportion inventory between two inventory groups. In some reactive inventory grouping embodiments, package instances are constructed and compared in order to determine the composition of an inventory group from which a customer may select a second component product after a first component product has been selected.
Package Price—The price that is charged (typically in a single transaction) for the units of products purchased pursuant to a package offer. Typically, package prices reflect a net-savings to the customer when compared to the sum of the respective retail prices of the individual component products.
Product Cost, Item Cost, Cost—The cost to the operator of a unit of selling a given product. The product cost may reflect the fixed cost and/or the variable cost in selling a unit of the product. In some embodiments, stored rules may instruct a vending machine control system to not sell a product or products unless the cost of the product(s) is equal to or less than a certain price (e.g., a retail price, a package price). In other embodiments, stored rules may instruct a vending machine control system to sell a product or products even though the cost of the product or products is greater than a retail price or package price, as may be the case where the product or products' actual sales rates are above a certain threshold (e.g. where actual sales rates exceed target sales rates).
Product, Item—A good or service provided by (e.g., sold by, dispensed by, handled by) a vending machine. Examples of goods provided by vending machines include beverages (e.g. cans of soda) and snacks (e.g. candy bars).
Restock Date, Restock Time—The time and/or date that a vending machine is scheduled to be restocked by an operator (or agent thereof) of a vending machine.

Various embodiments, including products and processes, are disclosed for facilitating the sales of combinations of units of products. The disclosed embodiments are particularly suitable for use in one or more vending machines or like apparatus.

According to an embodiment, a vending machine or other apparatus is configured to increase sales and/or profitability through novel processing of sales data, cost data and/or other data available to the vending machine.

In particular, various embodiments allow groups of products to be defined according to various criteria. Customers are prompted to purchase products from the groups. Thus, appropriate definition of the groups can lead to benefits such as increased profits per time.

According to a “proactive inventory grouping” embodiment of the present invention, on a periodic, substantially continuous or event-triggered basis, sales and/or cost data is monitored and evaluated against stored rules for the purpose of determining how to apportion inventory among at least two inventory groups from which, pursuant to a package offer, a customer may select and purchase at least two products for a single price. In determining how to apportion inventory to the different inventory groups, a vending machine may consider a value rating of one or more products. For example, products having a relatively high value rating may be allocated to a first inventory group, while products having a relatively low value rating may be allocated to a second inventory group. Thereafter, package offers encouraging the purchase of at least two products (e.g., at least one product from each of at least two inventory groups) may be output to prospective customers through one or more output devices. For example, a scrolling light emitting diode (LED) display may read “Pick any item from the red group and any item from the green group for $1.00!”, and shelf-mounted LED displays located adjacent to the various qualifying products may contemporaneously flash in red and/or green to indicate the products' inventory grouping statuses (i.e. green or red). The vending machine may be further configured to process package offer transactions in accordance with such advertised package offers by (i) receiving, through an input device, an indication of customer acceptance and (ii) dispensing a combination of products consistent with the advertised package offer.

According to a “reactive inventory grouping” embodiment, a customer is offered the ability to purchase a combination of products for a single price by the customer selecting a first product from a first group of inventoried products, and then the customer picking a second product from a second inventory group that is revealed to the customer after the first product is selected. In determining which inventoried products will be included in the second inventory group, a vending machine may consider a value rating of one or more products.

Further, according to some embodiments, a value rating of one or more products may be determined by considering one or more of (i) the time remaining until a restock date, (ii) the time remaining until an expiration date of a product or products, (iii) an actual sales rate of a product or products, (iv) a target or ideal sales rate of a product or products, (v) the cost of a product or products, (vi) the retail price of an individual unit of a product or products, (vii) the profit margin of a product or products at a given sale price such as the retail price, (viii) the historical acceptance rate of package instance comprising a given combination of products, and/or (ix) one or more products' income or profit contribution factor(s) (e.g., measures of one or more products' historic success in the marketplace).

Package Offer Rules and Execution Thereof

1. General Description

Applicants have recognized many effects that, when exploited according to many disclosed embodiments, can significantly increase the profit per time period realized by a vending machine. Applicants have recognized that by, for example, selling products at a lower margin, but at a higher velocity or volume, the overall profitability of a vending machine can be increased. Accordingly, in some embodiments, the vending machine may define, output and process package offers enabling customers to purchase a combination of products (from one or more vending machines) for a single price.

By encouraging the sale of at least two products (particularly for a single price, for a discounted price, or with a single payment) according to various disclosed embodiments, both vending machine operators and customers can benefit.

As customers are encouraged, through package offers, to purchase more products than they otherwise would, operators can benefit through increased sales volume. Operators further can benefit from the increased profitability (e.g., per time period, per transaction, per customer interaction) that results when such increases in sales volume sufficiently offset any discount from the packaged products' individual retail prices. Additionally, operators may economically configure machines to accept alternative payment forms that have higher transaction costs (e.g. credit cards) than conventional payment forms (e.g. cash) because of the higher per-transaction revenue and profit that results from selling combinations of products. Such alternate payment forms can prompt customers to spend more than they would have spent otherwise.

Customers can benefit through (i) the net-savings that often results when package prices are compared to the sum of the individual component products' retail prices, and/or (ii) the added convenience gained from the ability to purchase several products in a single transaction. Further, as vending machines may be configured to economically offer alternate payment forms, customers may benefit from the flexibility provided by an increased number of payment options.

2. Process Steps of Various Embodiments

According to some embodiments, a memory stores instructions that, when executed by a processor, direct a vending machine or other apparatus to identify, output and/or process package offers.

Several embodiments of advantageous processes are described below to illustrate the wide breadth of the disclosed invention. Many of the embodiments below are described as being performed wholly by a vending machine. However, it will be readily apparent to one of ordinary skill in the art that these processes may be performed, in whole or part, by a vending machine, by components of a vending machine, and/or by a device in communication with a vending machine.

Further, although the description herein refers to a vending machine as dispensing units of products, a plurality of vending machines may cooperate to provide units of products. Typically, more than one vending machine may be employed to provide units of different types of products (e.g., a first vending machine which sells snack food and a second vending machine which sells carbonated beverages).

Although one or more embodiments are described herein as enabling the sale of packages comprising two component products, it should be understood that package offers may provide for the sale of any number of component products, including three, four and five component products.

According to one embodiment, a vending machine defines at least one inventory group, which includes at least two products that are available for sale by the vending machine. For example, the vending machine may define an inventory group that includes three specific products (e.g., Snickers® candy bar, Milky Way® candy bar and Twix® candy bar). The vending machine may define an inventory group by storing appropriate data in a database or other memory structure. For example, the Table immediately below discloses one manner of defining an inventory group.

TABLE 1
Example Definition of an Inventory Group

| | Products Included in the Inventory |
|---|---|
| Inventory Group Identifier | Group |
| G001 | P34 |
| G001 | P35 |
| G001 | P17 |
| G001 | P22 |

In the Table above, the group identified by code “G001” includes the four products identified by codes P34, P35, P17 and P22, respectively. One of ordinary skill in the art will readily understand any other ways to define an inventory group.

In an embodiment, an inventory group may include one or more products. Furthermore, in an embodiment, a product may be included in more than one group. Furthermore, in an embodiment, a product may be included in no group.

For example, in an embodiment, the vending machine defines at least two inventory groups, and each of the at least two inventory groups includes at least one respective product that is available for sale.

As described in detail herein, there are many ways to advantageously determine which products are included in which groups.

According to an embodiment, the vending machine outputs an indication of products that the at least one inventory group includes. For example, in an embodiment the vending machine may control an output device to communicate (e.g., to a potential customer near the vending machine) the products that the at least one inventory group includes. When there is more than one inventory group, the vending machine may output, for each of the inventory groups, an indication of products that the respective inventory group includes.

If employed, an output device may comprise a flat panel monitor, cathode ray terminal (CRT), liquid crystal display (LCD) or a like device that displays text and/or images (e.g., still graphics, animated graphics) as directed by the vending machine (e.g., that a group includes “any candy bar” or “anything in the top row”). Alternatively or additionally, the output device may comprise an audio output device such as a speaker that is operated by the vending machine to output the appropriate sounds (e.g., synthesized sound, pre-recorded sound), typically verbal instructions/offers to potential customers. Sounds may be output with reference to one or more data files (e.g., wave tables, MP3 files).

Alternatively or additionally, the output device may comprise a plurality of colored lighting devices (e.g., LEDs, light bulbs, LCD panels), in which each colored lighting device is located proximate to one product column. The vending machine could selectively illuminate the plurality of colored lighting devices to indicate the products that a particular inventory group includes. For example, each product column may have proximate thereto a pair of LEDs, each a different color (e.g., red and green respectively). To indicate the products that a first inventory group includes, the vending machine could illuminate only the red LEDs that are proximate to the product columns of those included products. To indicate the products that a second inventory group includes, the vending machine could similarly illuminate the appropriate green LEDs.

Several variations may be readily made to the above-described method for indicating an inventory group. For example, each product column may include more than two LEDs. Similarly, each product column could include a single LED that is capable of displaying more than one color, or otherwise indicating more than one inventory group, as directed by the vending machine.

In an embodiment, the products that are included in an inventory group may be indicated by any means for denoting product columns. For example, a sticker, sign, flag or the like could be applied to certain product columns to indicate that the products of that column are included in an inventory group.

In an embodiment, the products that are included in an inventory group may be indicated by any means of communicating product information to a customer. For example, a sign (e.g., located atop a vending machine) or advertising (displayed or communicated to the customer in any manner whether or not proximate to the vending machine) may inform a customer that an inventory group includes, e.g., all products of a certain type (e.g., candy bars, snack food, Mars® products), all products of a certain location (all products in the top row of the vending machine, any product from the right hand vending machine of a connected pair of vending machines, any product in any machine on the fourth floor of a building) and/or certain products by name (e.g., a Snicker's® candy bar).

In some embodiments, the indication of inventory groups may be advantageously combined with the provision of an offer to the customer. For example, the vending machine may provide, to the customer, an offer to sell to the customer, for one predetermined price, (i) at least one unit of any product that is included in a first inventory group, and (ii) at least one unit of any product that is included in a second inventory group.

As is well known, offers may be output via many types of devices, such as via a flat panel monitor, cathode ray terminal (CRT), liquid crystal display (LCD) or a like device that displays text and/or images as directed by the vending machine (e.g., that a group includes “pick any candy bar and any beverage”). Alternatively or additionally, the output device may comprise an audio output device such as a speaker that is operated by the vending machine to output the appropriate sounds (e.g., synthesized sound, pre-recorded sound), typically verbal instructions/offers to potential customers. Sounds may be output with reference to one or more data files.

In an embodiment, an offer may be provided by any means for communicating information to a customer. For example, a sign (e.g., located atop a vending machine) or advertising (displayed or communicated to the customer in any manner whether or not proximate to the vending machine) may include an offer to sell to the customer, for one predetermined price, (i) at least one unit of any product that is included in a first inventory group (e.g., all candy bars), and (ii) at least one unit of any product that is included in a second inventory group (e.g., all products in a second vending machine).

The offer may be provided at various times. For example, the offer may be provided in response to receiving payment or receiving any input (e.g., a touch screen has been pressed). Alternatively or additionally, an offer may be provided after receiving a first selection of a product but before receiving a second selection of a second product.

The offer is particularly enticing, and thus is more likely to be accepted, if the offer provides the customer with a discount or other benefit. For example, the vending machine could provide, to the customer, an offer to sell to the customer, for one predetermined price, (i) one unit of any product that is included in a first inventory group, and (ii) one unit of any product that is included in a second inventory group. The predetermined price could reflect a discount over the retail prices of the component products. In other words, the predetermined price could be less than the sum of (a) a price of one unit of any product that is included in the first inventory group, and (b) a price of one unit of any product that is included in the second inventory group.

An “acceptance” of an offer may include payment and/or selection of product(s) which correspond to the offer.

According to an embodiment, the vending machine may receive from a customer (whether or not in response to an offer) a selection of a first product that the at least one inventory group includes. For example, the vending machine may indicate that all candy bars are included in a first inventory group, and a customer may in response indicate that select a Snickers® candy bar (which the first inventory group includes).

In an embodiment, the vending machine may receive, from a customer, a selection of (i) a first product that one of the inventory groups includes, and (ii) a second product that another one of the inventory groups includes.

In such an embodiment, the selection of products may be received simultaneously (e.g., “pressing a single button”). Alternatively, the vending machine may receive, from the customer, a first selection of a first product, and then a second selection of a second product.

As is well known, selection of products may be made in many ways. Customers may press certain combinations of buttons (e.g., “A1” indicates a particular product column, so the customer may press an “A” button and then press a “1” button on the vending machine). Such buttons may be physical buttons (e.g., composed of plastic and appropriately in communication with a processor of the vending machine). Such buttons may additionally or alternatively be “soft buttons” (e.g., graphically displayed on a touch-screen device, and responsive to pressure resulting from the customer pressing the appropriate areas of the touch screen). Many other ways of selecting one or more products are readily understood by one of ordinary skill in the art.

According to an embodiment, the vending machine may process a sale of (i) a unit of the first product selected by the customer, and (ii) a respective unit of at least one additional product, for a single price. In processing the sale, the vending machine will typically await sufficient payment, dispense the appropriate units of the appropriate products, and/or provide change if any change is due the customer.

The at least one additional product may have been explicitly selected by the customer, for example, by pressing appropriate buttons that indicate the additional product(s). Additionally or alternatively, the at least one additional product may have been selected “for” the customer in various manners. For example, the at least one additional product may be a product which is, by default, added to an order by a customer. In another embodiment, the at least one additional product may be offered to a customer (“would you like a stick of gum for an extra ten cents?”) and “selected” by the customer when the customer accepts the offer (e.g., pressing an “OK” button).

According to an embodiment, the vending machine may process a sale of a unit of the first product and a unit of the second product upon receiving from the customer one payment of at least a predetermined price. For example, the vending machine may receive from the customer a single payment (e.g., a dollar bill is inserted, a credit card account is charged) which constitutes the predetermined price. Alternatively, the vending machine may receive from the customer a single payment which exceeds the predetermined price. The vending machine would typically provide change to the customer in such a situation.

In addition to the features and embodiments described above, it is highly advantageous to define inventory group(s) according to various processes and/or utilizing various information. Accordingly, many embodiments for defining inventory groups are described in detail immediately below.

Proactive Inventory Grouping Embodiments

In “proactive inventory grouping” embodiments, various data (e.g., product sales data, product cost data) may be employed to determine how to apportion inventory among inventory groups (typically at least two inventory groups) before a customer selects any product. After the apportioning of products to inventory groups is complete, package offers encouraging the purchase of at least two products from at least two inventory groups may be output by a vending machine to prospective customers.

Of course, steps performed in a proactive inventory grouping embodiment does not imply that those steps may only be performed in a proactive inventory grouping embodiment.

A proactive inventory grouping process by which one or more inventory groups are each defined to include one or more respective products may be initiated periodically, substantially continuously or after an event (e.g., a transaction, a restocking, a power-up). It can be desirable that customers throughout each day will receive the same ability to purchase products from the same inventory groups (e.g. one customer will not be offered the ability to select products from a more or less favorable inventory grouping than that which was provided to another customer that day). Thus, in embodiments where the process is initiated periodically, it may be desirable to set the time interval between process executions (i.e. defining inventory groups) so that the process is executed at convenient times (e.g., every 24 hours starting at midnight).

Alternatively or additionally, in embodiments where the process is executed after a triggering event such as a transaction with a customer, it may be desirable that the process is initiated a number of minutes after a transaction, when no intervening transaction has been processed (e.g. the process is initiated 30 minutes after a transaction, provided no intervening transaction has been consummated). In this manner, it may be safe to assume that the machine is experiencing a lull in sales, and that customers accordingly may not witness any change of inventory groupings/apportionments (i.e. a customer is unlikely to walk up to the machine and witness any reallocation of inventory from a “red” group to a “green” group).

According to one proactive inventory grouping embodiment, which is illustrated by FIG. 2, the illustrated proactive inventory grouping process functions to, among other things, allocate products available for sale to inventory groups based on (1) the relative value ratings of the products, and (2) stored rules for determining, among other things, whether products should be included in package offers. A description of the steps of FIG. 2, which provides a flow chart for such a proactive inventory grouping process, follows:

Step 100: Determine Value Rating of Each Inventoried Item.

At Step 100, the vending machine may determine a value rating of products by, for example, accessing an inventory database to determine, among other things, products in inventory and characteristics thereof.

The value ratings of products may be used to determine the products which various inventory groups include. For example, each product that a first inventory group includes may have a rating that is not less than a rating of any product that the second inventory group includes. As another example, a first inventory group may include a certain portion of the highest rated products (e.g., the products with the five highest value ratings; the highest 50%, by value rating, of all products).

The Table immediately below describes an example inventory database:

TABLE 2
Example Inventory Database

| | | | | | | Quantity at | | | | |
|---|---|---|---|---|---|---|---|---|---|---|
| | Row | | | | | Beginning | | | Actual | Ideal |
| Product | Position | Product | Retail | | | of Fill | Quantity | Restock | Sales | Sales |
| Name | Identifier | Category | Price | Cost | Margin | Period | Remaining | Date | Rate | Rate |
| Coca-Cola ® | A1 | Beverage | $.75 | $.35 | $.40 | 20 | 8 | Jun. 30, 2003 | 1.2/day | 1.3/day |
| Diet Coke ® | A2 | Beverage | $.75 | $.30 | $.45 | 20 | 6 | Jun. 30, 2003 | 1.4/day | 1.3/day |
| A&W | A3 | Beverage | $.65 | $.35 | $.30 | 20 | 9 | Jun. 30, 2003 | 1.1/day | 1.3/day |
| Root | | | | | | | | | | |
| Beer ® | | | | | | | | | | |
| Doritos ® | B1 | Snack | $.50 | $.30 | $.20 | 25 | 11 | Jun. 30, 2003 | 1.4/day | 1.6/day |
| Lay's ® | B2 | Snack | $.75 | $.30 | $.45 | 25 | 7 | Jun. 30, 2003 | 1.8/day | 1.6/day |
| Potato | | | | | | | | | | |
| Chips | | | | | | | | | | |
| Cheetos ® | B3 | Snack | $.60 | $.30 | $.30 | 25 | 17 | Jun. 30, 2003 | 0.8/day | 1.6/day |
| Double- | C1 | Chewing | $.35 | $.20 | $.15 | 40 | 18 | Jun. 30, 2003 | 2.2/day | 2.6/day |
| Mint ® | | Gum | | | | | | | | |
| Juicy | C2 | Chewing | $.35 | $.20 | $.15 | 40 | 23 | Jun. 30, 2003 | 1.7/day | 2.6/day |
| Fruit ® | | Gum | | | | | | | | |
| Dentyne ® | C3 | Chewing | $.40 | $.20 | $.20 | 40 | 36 | Jun. 30, 2003 | 1.1/day | 2.6/day |
| | | Gum | | | | | | | | |

As the above inventory database illustrates, for each product, a corresponding product category, retail price, cost, margin, quantity at the beginning of the fill period, quantity remaining as of the current date/time, restock date, actual sales rate and ideal sales rate. The data stored by such a database may be entered by an operator (e.g., who restocks the vending machine), determined by the vending machine with its peripheral devices (e.g., data indicating that a product has been sold, that an amount of money has been received), set randomly, and/or calculated from available data (e.g., other data stored by the inventory database or another database).

The exemplary data in the above inventory database assumes that the beginning of the fill period was Jun. 15, 2003, and that the current date is Jun. 25, 2003 (i.e. 10 days into the fill period). Further, the exemplary data in the above inventory database will be referred to throughout the remaining discussion of this process to illustrate steps of the example proactive inventory grouping embodiment in which the value rating of individual products are considered. For the purpose of this ongoing example, it shall be assumed that a package offer to a customer will define two products which may be purchased together for $1.00, in which one product is included in a first (“green”) inventory group, and one product is included in a second (“red”) inventory group.

At Step 100 of FIG. 2, a value rating is determined for each inventoried product. There are many ways that value ratings could be represented and many ways that value ratings could be determined.

A value rating may be represented as a numerical quantity, a set of numerical quantities (e.g. a vector, a matrix), or any other quantity that may be used for purposes of comparison and/or evaluation. A value rating may also be qualitative, such as “high”, “medium”, or “low”. In one or more embodiments, the value rating of one or more products may be determined by considering one or more of (i) the time remaining until a restock date, (ii) the time remaining until an expiration date of a product or products, (iii) an actual sales rate of a product or products, (iv) a target or ideal sales rate of a product or products, (v) the cost of a product or products, (vi) the retail price of an individual unit of a product or products, (vii) the retail profit margin of a product or products when sold for the retail price, (viii) the historical acceptance rate of a package instance comprising a given combination of products, and/or (ix) one or more products' income or profit contribution factor(s).

Thus, a value rating may be determined using a formula in which any of the above criteria (i) through (ix) may serve as variables. For example, in one embodiment, a value rating is determined by identifying a product's retail profit margin (as determined by subtracting the product's cost from the product's retail price). For example, following the exemplary data in the above inventory database, the vending machine control system would determine that a Diet Coke® soda has a margin of $0.45. The value rating of each product margin may be that product's margin, some proportion of the margin, or some other variation of the margin.

In another embodiment, value ratings may be determined by multiplying a product's margin by its actual sales rate expressed as a percentage of the product's ideal sales rate. By using a product's actual sales rate as a basis for predicting future sales, the vending machine control system can determine the likelihood (e.g. as a percentage) that the particular product will sell at the product's ideal sales rate. In turn, by multiplying this percentage by the product's margin, a value rating can be determined. (Note, however, at the beginning of a fill period, a vending machine may determine a product's sales rate to be zero, as no sales data for that period has yet been collected, or may determine the product's sales rate based on data obtained from a prior fill period.) The table immediately below illustrates such an embodiment in the context of the ongoing example. In the illustrated embodiment, the value rating of each product (as described above in the inventory database) is calculated by multiplying each product's margin by a percentage that reflects the product's actual sales rate divided by the product's ideal sales rate:

TABLE 3
Values calculated based on Actual and Desired Sales Rates

| | | | | Actual | |
|---|---|---|---|---|---|
| | | | | Sales | |
| | | | | Rate as | |
| | | | | percent of | |
| | | Actual Sales | Ideal Sales | ideal sales | Value |
| Product | Margin | Rate | Rate | rate | Rating |
| Coca-Cola ® | $.40 | 1.2/day | 1.3/day | 92% | $.37 |
| Diet Coke ® | $.45 | 1.4/day | 1.3/day | 107% | $.48 |
| A&W Root | $.30 | 1.1/day | 1.3/day | 85% | $.26 |
| Beer ® | | | | | |
| Doritos ® | $.20 | 1.4/day | 1.6/day | 88% | $.18 |
| Lay's ® | $.45 | 1.8/day | 1.6/day | 113% | $.51 |
| Potato | | | | | |
| Chips | | | | | |
| Cheetos ® | $.30 | 0.8/day | 1.6/day | 50% | $.15 |
| Double- | $.15 | 2.2/day | 2.6/day | 85% | $.13 |
| Mint ® | | | | | |
| Juicy | $.15 | 1.7/day | 2.6/day | 65% | $.10 |
| Fruit ® | | | | | |
| Dentyne ® | $.20 | 1.1/day | 2.6/day | 42% | $.08 |

In various embodiments, products can be scored, sorted and/or ranked based on their relative value ratings, and such data can be stored in RAM pending Step 200, below, at which point the scoring, sorting and/or ranking may be considered in the allocation of products to inventory groups. Thus, following the ongoing example (in which the value rating of each product in the above inventory database was calculated by multiplying each product's margin by its actual sales rate as a percentage of its ideal sales rate), inventoried products can be sorted in descending order based on their relative value ratings, as illustrated by the table immediately below:

TABLE 4
Values calculated based on Actual and Desired Sales Rates

| | | | | Actual | |
|---|---|---|---|---|---|
| | | | | sales | |
| | | | | rate as | |
| | | | | percent of | |
| | | Actual Sales | Ideal Sales | ideal sales | Value |
| Product | Margin | Rate | Rate | rate | Rating |
| Lay's ® | $.45 | 1.8/day | 1.6/day | 113% | $.51 |
| Potato | | | | | |
| Chips | | | | | |
| Diet Coke ® | $.45 | 1.4/day | 1.3/day | 107% | $.48 |
| Coca-Cola ® | $.40 | 1.2/day | 1.3/day | 92% | $.37 |
| A&W Root | $.30 | 1.1/day | 1.3/day | 85% | $.26 |
| Beer ® | | | | | |
| Doritos ® | $.20 | 1.4/day | 1.6/day | 88% | $.18 |
| Cheetos ® | $.30 | 0.8/day | 1.6/day | 50% | $.15 |
| Double- | $.15 | 2.2/day | 2.6/day | 85% | $.13 |
| Mint ® | | | | | |
| Juicy | $.15 | 1.7/day | 2.6/day | 65% | $.10 |
| Fruit ® | | | | | |
| Dentyne ® | $.20 | 1.1/day | 2.6/day | 42% | $.08 |

In embodiments where value ratings of products are determined based on profit contribution factors, such products might be ranked or sorted according to their relative profit contribution percentages. For example, if a vending machine which sold only products A, B and C during a fill period realized a total of $100 in profit, $45 of which was generated through the sale of product A, $40 through product B and $15 through product C, then the products would be sorted in the order of A (45% of the total profit), B (40% of the total profit) and C (15% of the total profit). Further, in some embodiments, only those products that remain in inventory (i.e. are available for sale) at the time when Step 100 is executed are considered in the ranking or sorting, and thus, in the subsequent allocation procedure of Step 200, which defines one or more inventory groups.

Step 200: Determine Allocation of Products to Inventory Groups Based on Value Rating Determination and Stored Rules.

The value rating associated with each product may be used in assigning products to inventory groups.

In one embodiment, an inventory group may define a given number of component product “slots”, or a designated number of products that may be allocated to that inventory group. In other words, an inventory group is defined in part according to how many products the inventory group should include.

For example, a vending machine may be configured to have two inventory groups, such as “green” group and “red” group, in which the red group has three component product slots and the green group has six component product slots. Thus a customer might be offered to select one component product from the three red slots (i.e. select one product from three possible products) and one component from the six green slots (i.e. select one product from six possible products). The slots of a group may be “filled” according to value ratings of products. For example, the five products having the highest profit contribution factors may be allocated to the “green” inventory group, and the six with the lowest profit contribution factors may be allocated to the “red” inventory group. As described above, two or more groups may include the same product, and no group may include certain products. Thus, where a green group includes five products and a red group includes six products, there may be eleven products available for sale, or more or less than eleven.

In another embodiment, a predetermined percentage of the products (or of only the products which are available for sale) may be allocated to each group so that, for example, 50% of the products will be allocated to the “red” group and the remaining 50% of products will be allocated to the “green” group. In particular, it can be advantageous to allocate similar products to a group. For example, the top 50% (by value rating) of products are allocated to one group, and the remaining products are allocated to another group.

In another embodiment, all products having a value rating over a certain threshold (e.g. over $0.25) may be placed in a particular inventory group (e.g. in the “red” inventory group).

Each inventory group may be associated with a rule (e.g., a stored value rating-based allocation rule) defining the products that are allocated to the inventory group. For example, in an embodiment where three component product slots are “red” and six component product slots are “green”, a profitability-based allocation rule may provide that (1) the three inventoried products having the highest value ratings are to be allocated to the “red” inventory group, and (2) the six inventoried products having the lowest value ratings are to be allocated to the “green” inventory group. Thus, continuing with the ongoing example, Lay's® Potato Chips, Diet Coke® and Coca-Cola® would be allocated to the red inventory group; and A&W Root Beer®, Doritos®, Cheetos®, Double-Mint®, Juicy Fruit® and Dentyne® would be allocated to the green inventory group. Accordingly, a package offer may provide that a customer may purchase one product from the red group and one product from the green group for $1.00.

In an alternate embodiment, rather than having a fixed number of inventory slots or a percentage-based division of products among inventory groups, the number of slots in each inventory group may be determined randomly and/or pursuant to a genetic algorithm, whereby a given slot configuration is tested randomly and evaluated against other configurations.

Further, a set of package offer rules may also be employed in determining how to allocate products to different inventory groups. An exemplary Package Offer Rules Database is represented by the Table immediately below:

TABLE 5
Package Offer Rules Database

| Package | |
|---|---|
| Offer Rule | |
| Number | Rule |
| 1 | Products from “beverage” category cannot be in same |
| | inventory grouping as products from “chewing |
| | gum” category. |
| 2 | Total margin of package instance based on $1.00 package |
| | price cannot be equal to or less than 50% of the sum |
| | of the individual component products' margins. |
| 3 | Do not allocate to inventory groups those products selling |
| | at ≧110% of target sales rate. |
| 4 | Cheetos ® must be both in red and green |
| | inventory groups |

Although rules may be represented as being stored in a database for reference, such rules may be implemented in an wide variety of manners, such as (i) “hard coded” into software and/or hardware, and (ii) coded in software/hardware with reference to parameters which are stored in a database or other memory structure.

As illustrated, a database may provide one or more rules that govern the allocation of products to inventory groups, whether or not with reference to the value ratings of the products. The exemplary data in the above database of Table 5 depicts several rules. For example, as demonstrated by Package Offer Rule Number 1, a package offer rule may provide that products from certain categories may or may not be packaged with products from other categories. Such a rule may be desirable to ensure that only certain combinations of products are offered and/or so that certain combinations of products are not offered. For example, it may be decided (e.g. by an operator) that certain products complement each other, as may a beverage and a snack. Conversely, it may be decided (e.g. by an operator) that certain products should not be included in a package offer (e.g., as in Package Offer Rule Number 1, “beverages” cannot be included in package offers with “chewing gum”). Products that are affected by such rules (e.g., whether a product is a “beverage”) can be determined by appropriate notation or data stored in an inventory database. For example, all products that are “beverages” can be indicated as such by a flag in the corresponding record of the product. Alternatively, the rule which refers to beverages can in fact directly refer to a specific plurality of products (e.g., each identified by a respective product code).

Further, as demonstrated by Package Offer Rule Number 2, a package offer rule may provide that the total margin of a package instance, based on a given package price, cannot be equal to or less than a certain percent of the sum of the individual component product's margins (based on their respective individual retail prices).

Similarly, a package offer rule may provide that the total margin of a package instance, based on a given package price, cannot be less than the margin that would result from a sale of the individual products at their retail prices, unless a threshold volume of sales (e.g., as measured by units sold, or units sold per time period) for one or more of the component products is likely to be achieved. Such a rule may be desirable to ensure that any discounts offered by way of package offers are sufficiently offset by an increase in sales volume. For example, by requiring that a certain package instance have a certain historic acceptance rate, operators can rest assured that a discount offered for the products by virtue of a package price that is less than the sum of the component products' individual retail prices will not likely result in a decrease in profits.

Further still, a package offer rule may provide that products selling above or below a given actual sales rate may or may not be included in certain inventory groups (or in any inventory group). For example, Package Offer Rule Number 3 illustrates a rule that provides that a product having an actual sales rate above a certain threshold is not to be included in inventory groups (e.g., t any inventory group which might be used in a package offer). Such a rule can be useful in preventing price dilution that may otherwise result when very popular products are sold on promotion through package offers. As is known, price dilution generally involves the negative effect on profitability that can ensue when a product is sold for a price lower than a customer otherwise would have paid for the product.

Some embodiments can reduce or eliminate the effects of dilution that may otherwise result when package prices are less than the sum of the individual component products' retail prices. In other words, because very popular products are highly likely to sell at their current retail prices, it may be decided (e.g., by an operator) that very popular products should not ever be sold at a discount, even for purposes of promoting the sale of additional (relatively less popular) products through package offers. Alternatively, it may be desirable to package together only products having actual sales rates above a certain threshold with products having actual sales rates below a certain threshold. In this manner, an operator may attempt to leverage the popularity of a given product to sell additional, relatively less popular products.

Further still, an inventory group may be defined to include a particular set of products based on a what product the customers first selects (e.g. if product A1 is selected, then the second inventory group is defined to include products B1, B2 and B3).

Moreover, a rule may provide that particular products are to be included in some, all or no inventory groups. For example, Package Offer Rule Number 4, above, illustrates an example rule that requires Cheetos® to be included in both green and red inventory groups, regardless of value rating.

Thus, continuing with the ongoing example, the table immediately below illustrates the effect of Package Offer Rules 1, 3 and 4 on the inventory group allocations:

TABLE 6
Effect of Package Offer Rules

| | | | | | | | Relevant |
|---|---|---|---|---|---|---|---|
| | | | | | Preliminary | | Package |
| | | | | Actual | Inventory | Inventory | Offer |
| | | | | Sales | Grouping | Grouping | Rule |
| | | | | Rate as | (i.e. before | after | (from |
| | | | | percent | application | considering | Package |
| | | | | of ideal | of Package | Package | Offer |
| | Product | Retail | | sales | Offer | Offer | Rule |
| Product | Category | Price | Margin | rate | Rules) | Rules | Database) |
| Lay's ® | Snack | $.75 | $.45 | 113% | Red | None | 3 |
| Potato | | | | | | | |
| Chips | | | | | | | |
| Diet Coke ® | Beverage | $.75 | $.45 | 107% | Red | Red | N/a |
| Coca-Cola ® | Beverage | $.75 | $.40 | 92% | Red | Red | N/a |
| A&W ® | Beverage | $.65 | $.30 | 85% | Green | None | 1 |
| Root | | | | | | | |
| Beer | | | | | | | |
| Doritos ® | Snack | $.50 | $.20 | 88% | Green | Red | N/a |
| Cheetos ® | Snack | $.60 | $.30 | 50% | Green | Green, Red | 4 |
| Double- | Chewing | $.35 | $.15 | 85% | Green | Green | N/a |
| Mint ® | Gum | | | | | | |
| Juicy | Chewing | $.35 | $.15 | 65% | Green | Green | N/a |
| Fruit ® | Gum | | | | | | |
| Dentyne ® | Chewing | $.40 | $.20 | 42% | Green | Green | N/a |
| | Gum | | | | | | |

As shown, Package Offer Rule 3, which functions to prevent packaging of products which have sales rates greater or equal to 110% of their target sales rates, precludes the inclusion in any package offer of Lay's® potato chips, which has an actual sales rate of 113% of its target sales rate. Further, pursuant to Package Offer Rule 4, Cheetos® are allocated to both the red and green inventory groups, despite the initial value rating-based allocation of Cheetos® solely to the green inventory group. Additionally, considering Package Offer Rule 1, A&W Root Beer®, a beverage, cannot be included in the green inventory grouping because chewing gum products preliminarily exist in the green inventory grouping as a result of the above-illustrated allocation based on value rating.

Thus, without yet considering Package Offer Rule 2, the possible combinations of component products (i.e. the package instances) are illustrated in the table immediately below:

TABLE 7
Possible Combinations

| Product 1 | Product 2 |
|---|---|
| Diet Coke ® | Cheetos ® |
| Diet Coke ® | Double-Mint ® |
| Diet Coke ® | Juicy Fruit ® |
| Diet Coke ® | Dentyne ® |
| Coca-Cola ® | Cheetos ® |
| Coca-Cola ® | Double-Mint ® |
| Coca-Cola ® | Juicy Fruit ® |
| Coca-Cola ® | Dentyne ® |
| Doritos ® | Cheetos ® |
| Doritos ® | Double-Mint ® |
| Doritos ® | Juicy Fruit ® |
| Doritos ® | Dentyne ® |
| Cheetos ® | Cheetos ® |
| Cheetos ® | Double-Mint ® |
| Cheetos ® | Juicy Fruit ® |
| Cheetos ® | Dentyne ® |

However, considering Package Offer Rule 2, which provides that the total margin of a package instance based on a $1.00 package price cannot be equal to or less than 50% of the sum of the individual component product's margins, it becomes apparent that the package instance where Coca-Cola® and Cheetos® are purchased together for the package price of $1.00 violates Package Offer Rule 2. The table immediately below shows, for each potential instance in the ongoing example, whether or not that package instance violates Package Offer Rule 2:

TABLE 8
Violation of Package Offer Rule 2

| | | | | | | | | Total | | |
|---|---|---|---|---|---|---|---|---|---|---|
| | | | | | | | | Margin of | | |
| | | | | | | | | Package | | |
| | | | | | | | | Instance | Sum of | |
| | | | | | | | | at $1.00 | Product 1 | |
| | | | | | | | | Package | Margin at | |
| | | | | | | | | Price | Retail | |
| | | | | | | | | (i.e. $1.00 − | Price + | Violates |
| | | | Product 1 | | | | Product 2 | (Cost | Product 2 | Package |
| | Product 1 | | Margin at | | Product 2 | | Margin at | Product 1 + | Margin at | Offer |
| | Retail | Product 1 | Retail | | Retail | Product 2 | Retail | Cost | Retail | Rule |
| Product 1 | Price | Cost | Price | Product 2 | Price | Cost | Price | Product 2) | Price | 2? |
| Diet Coke ® | $.75 | $.30 | $.45 | Cheetos ® | $.60 | $.30 | $.30 | $.40 | $.75 | No |
| Diet Coke ® | $.75 | $.30 | $.45 | Double- | $.35 | $.20 | $.15 | $.50 | $.60 | No |
| | | | | Mint ® | | | | | | |
| Diet Coke ® | $.75 | $.30 | $.45 | Juicy | $.35 | $.20 | $.15 | $.50 | $.60 | No |
| | | | | Fruit ® | | | | | | |
| Diet Coke ® | $.75 | $.30 | $.45 | Dentyne ® | $.40 | $.20 | $.20 | $.50 | $.65 | No |
| Coca-Cola ® | $.75 | $.35 | $.40 | Cheetos ® | $.60 | $.30 | $.30 | $.35 | $.70 | Yes |
| Coca-Cola ® | $.75 | $.35 | $.40 | Double- | $.35 | $.20 | $.15 | $.45 | $.55 | No |
| | | | | Mint ® | | | | | | |
| Coca-Cola ® | $.75 | $.35 | $.40 | Juicy | $.35 | $.20 | $.15 | $.45 | $.55 | No |
| | | | | Fruit ® | | | | | | |
| Coca-Cola ® | $.75 | $.35 | $.40 | Dentyne ® | $.40 | $.20 | $.20 | $.45 | $.60 | No |
| Doritos ® | $.50 | $.30 | $.20 | Cheetos ® | $.60 | $.30 | $.30 | $.40 | $.50 | No |
| Doritos ® | $.50 | $.30 | $.20 | Double- | $.35 | $.20 | $.15 | $.50 | $.35 | No |
| | | | | Mint ® | | | | | | |
| Doritos ® | $.50 | $.30 | $.20 | Juicy | $.35 | $.20 | $.15 | $.50 | $.35 | No |
| | | | | Fruit ® | | | | | | |
| Doritos ® | $.50 | $.30 | $.20 | Dentyne ® | $.40 | $.20 | $.20 | $.50 | $.40 | No |
| Cheetos ® | $.60 | $.30 | $.30 | Cheetos ® | $.60 | $.30 | $.30 | $.40 | $.60 | No |
| Cheetos ® | $.60 | $.30 | $.30 | Double- | $.35 | $.20 | $.15 | $.50 | $.45 | No |
| | | | | Mint ® | | | | | | |
| Cheetos ® | $.60 | $.30 | $.30 | Juicy | $.35 | $.20 | $.15 | $.50 | $.45 | No |
| | | | | Fruit ® | | | | | | |
| Cheetos ® | $.60 | $.30 | $.30 | Dentyne ® | $.40 | $.20 | $.20 | $.50 | $.50 | No |

As shown in the above example, the package instance including Coca-Cola® and Cheetos® is impermissible according to Package Offer Rule 2. Thus, the vending control system may make an adjustment to the inventory group allocations so that Coca-Cola® is not offered with Cheetos®. Because, in this example, Rule 4 provides that Cheetos® must be included in both the green and red inventory groups, Coca-Cola® may be removed from the red inventory group so that Coca-Cola® cannot be selected by a customer along with Cheetos®, a green inventory product, pursuant to a package offer. Thus, in this ongoing example, Coca-Cola® would not be assigned to either inventory group. Accordingly, Coca-Cola® would not be included in an offer that is defined solely by inventory groups, and thus could not be selected by a customer as a component product pursuant to such a package offer.

Thus, after preliminarily allocating the inventoried products in the ongoing example to red and/or green inventory groups based on their relative value ratings and then considering all the package offer rules in the exemplary Package Offer Rules Database, the possible package instances, and the component products' inventory groupings in each instance, are shown in the table immediately below:

TABLE 9
Package Instances

| | Inventory | | Inventory |
|---|---|---|---|
| Product 1 | Grouping | Product 2 | Grouping |
| Diet Coke ® | Red | Cheetos ® | Green |
| Diet Coke ® | Red | Double-Mint ® | Green |
| Diet Coke ® | Red | Juicy Fruit ® | Green |
| Diet Coke ® | Red | Dentyne ® | Green |
| Doritos ® | Red | Cheetos ® | Green |
| Doritos ® | Red | Double-Mint ® | Green |
| Doritos ® | Red | Juicy Fruit ® | Green |
| Doritos ® | Red | Dentyne ® | Green |
| Cheetos ® | Red or Green | Cheetos ® | Green or Red |
| Cheetos ® | Red | Double-Mint ® | Green |
| Cheetos ® | Red | Juicy Fruit ® | Green |
| Cheetos ® | Red | Dentyne ® | Green |

Step 300: Output Package Offer.

According to the described embodiment, after the inventoried products have been allocated to the inventory group(s), the vending machine may output a package offer to customers via one or more output devices. For example, an LCD display may read “Pick one red product and one green product for $1.00!”, and LED displays located proximately to several products may illuminate or flash in red and/or green as determined by the inventory groups. Following the ongoing example, the LED Cheetos®, Double-Mint® and Juicy Fruit®.

Many methods are contemplated for communicating offers via output devices. For example, in one embodiment, package offers may be communicated entirely through an LCD display (e.g. through digital icons representing the qualifying products). Alternatively, in another embodiment, a package offer may be communicated through a combination of static displays (e.g. painted or printed signage reading “Pick one red product and one green product for $1.00”) and LED displays located proximately to qualifying component products (e.g. LEDs next to qualifying products may flash in red and/or green as appropriate).

Step 400: Process Transaction in Accordance with Package Offer.

After a package offer is output to a customer, a customer may accept such a package offer. Accordingly, at Step 400, the vending machine may receive, through an input device, an indication of a customer's acceptance of a package offer. Such an indication may comprise the receipt of payment (e.g., currency, a payment identifier such as a credit card number) through payment processing mechanisms such as coin acceptors, bill validators and/or card readers.

In embodiments where a customer has prepaid for products, the “receipt of payment” for the offered products may comprise a command by the customer to redeem prepaid credit, units or the like. For example, the customer could enter, via a touch screen, a code which uniquely identifies his previous prepayment for a certain number of products (e.g., five units of any product, six units of any beverage). Additionally or alternatively, the prepayment could be evidenced by a magnetic strip card or bar code which is read by a peripheral of the vending machine.

Alternatively or additionally, an indication of acceptance of the offer may comprise a signal, received through an input device such as a keypad or touch screen, indicating that the customer desires to purchase a combination of products pursuant to a package offer (e.g., clicking a “YES” button on a touch screen).

In accordance with Step 400, a customer selects at least one product from each of at least two inventory groups. Thus, a customer may select a product from a first inventory group by inputting, into a keypad or touch screen, an indication of a product that the first inventory group includes (e.g., a “red” product). Following the ongoing example, a customer may select from the red inventory group either Diet Coke®, Doritos®, or Cheetos® by inputting into a keypad his or her selection of Row Position Identifier A2, B1 or B3, respectively. After the customer selects a first product from the first inventory group, the customer may be instructed to and the customer may indeed select a second product from a second inventory group. Following the ongoing example, a customer may select, from the green inventory group, Dentyne®, Cheetos®, Double-Mint®or Juicy Fruit® by inputting into a keypad his or her selection of Row Position Identifier C3, B3, C1 or C2, respectively.

In some embodiments, a default time for selecting the second product is provided such that if the customer does not select a second product from the second inventory group within the default time, the vending machine may (1) consummate the transaction as if the first selected product was purchased at its retail price by dispensing a unit of the product and providing change, if appropriate; (2) prompt the customer with a reminder message via an output device; or (3) automatically identify and dispense, as the second component product, a unit of a “default” product that the second inventory group includes (e.g. a stored rule may provide that the product in the second inventory group having the highest retail profit margin is automatically dispensed).

In some embodiments, if the customer does not select an appropriate second product but rather selects an inappropriate product (e.g. selects a product that is not allocated to the second inventory group), then the vending machine may output, through an output device, an error message prompting the customer to select a product from the appropriate (second) inventory group.

At Step 400 the vending machine may also process payment in a conventional manner such as by (i) detecting an amount that is deposited/rendered/provided, comparing that amount to a (package) price, and dispensing change due if appropriate, or (ii) requesting a credit authorization from a remote computer, such as a computer operated by a credit card transaction processing company (e.g. First Data Corp.).

Payment may have been previously rendered (e.g., $5 was previously paid for the right to purchase five pairs of products in the future). If so, and if the products pursuant to such prepayment are being redeemed in the transaction, many well known processes may be employed to debit the prepaid account for the redeemed products.

Further, at Step 400, depending on which products were selected by the customer, the vending machine control system may, in a manner known in the art, transmit one or more signals to a product dispensing apparatus to dispense the at least two products. In one embodiment, dispensing signals are sent to corresponding product dispensing actuators/motors after the customer selects all component products. In another embodiment, such dispensing signals are sent to corresponding product actuators/motors substantially immediately after each component product is selected, so that products are made available immediately following selection.

Step 500: Record Results in Database.

At Step 500, the vending machine records results of the transaction in a database or similar memory structure. Step 500 may include the step of (1) updating one or more inventory records in an inventory database to reflect the vending of products (i.e. the quantity available of products sold is decreased to account for sales of units of the products), and/or (2) updating an acceptance or sales rate associated with a product or products to reflect the sale of a product or products (e.g., recording the units sold, the time of the sale and/or the date of the sale). Following the ongoing example, assuming that a customer on Jun. 25, 2003 purchased, for a $1.00 package price, one can of Diet Coke® and one package of Double-Mint® gum, then the above inventory database would be updated to reflect that five units of Diet Coke® and seventeen units of Double-Mint® gum remain in inventory and available for sale. Likewise, the actual sales rates of Diet Coke® would be updated from 1.2/day to 1.3/day; the actual sales rate of Double-Mint® gum would be updated from 2.2/day to 2.3/day. Thus, through the package promotion, Diet Coke® would have reached its ideal sales rate of 1.3/day, and the actual sales rate of Double-Mint® gum would have moved significantly closer to its ideal sales rate of 2.6/day.

Updating inventory amounts and sales rate data advantageously provides the vending machine with updated market data (e.g., supply and demand data) that can be fruitfully exploited in subsequent executions of the processes of various embodiments. In other words, such updated inventory amounts and sales rates can be referenced subsequently by the vending machine control system in subsequently making definitions of inventory group (see Steps 100 and 200, supra).

### Reactive Inventory Grouping Embodiments

In “reactive inventory grouping” embodiments, a customer is offered the ability to purchase a combination of products for a single price by selecting a first product from a first group of inventoried products, and then picking a second product from a second inventory group which is revealed to the customer only after the first product is selected.

Such an embodiment can be desirable because it can provide customers with an entertaining way of interacting with a vending machine. In other words, because in this embodiment the second inventory group is not revealed to the customer until a first product is selected, customers may experience feelings of hopeful anticipation until such a second inventory group is revealed. This feeling may be analogous to the excitement and exhilaration some customers receive when gambling or playing a chance-based game.

Thus, in some embodiments, game-themed messages may be output through the one or more output devices prior to the revealing of the second inventory group, thereby incorporating a game-like feel into the customer's experience with the vending machine. In other words, in some reactive inventory grouping embodiments, output devices may be configured to output game-themed animations, such as spinning slot machine reels, roulette wheels, or the like, before a second inventory group is revealed to the customer. Accordingly, such machines can present customers with the appearance that a (randomly determined) resolution or outcome of a game determines the products which the second inventory group includes. In this manner, the second inventory group may be presented as a “prize showcase” from which customers may select a prize.

Further, in some embodiments, reactive inventory grouping may be less computationally intensive or otherwise require less computing resources than, e.g., certain types of proactive inventory grouping, and accordingly can be more desirable to some vending machine operators (particularly in certain hardware environments).

A description of FIG. 3, which provides a flow chart illustrating a reactive inventory grouping process, follows. Of course, steps performed in a reactive inventory gr

[symbol]

Step 100: Output Package Offer.

At Step 100, the vending machine outputs a package offer to the customer regarding the availability of a package deal. For example, an LCD display may output a message reading “Pick 2 items for $1. Pick any item, and then a group of items will flash. Pick any flashing item as your second item.” Alternatively, such a message may be provided through a static means (e.g. painted or printed signage).

Step 200: Receive Customer Selection of First Product from First Inventory Group.

At Step 200, the vending machine control system receives, via one or more input devices, a signal indicating a customer's selection of a first product, and that product is determined to be included in a first inventory group. In some embodiments, this step may be accompanied or preceded by payment processing steps, including the receipt of currency.

According to some embodiments, the selection of a product by a customer may be determined to not be included in the requisite inventory group. If so, then subsequent steps of the instant process might not be performed.

According to one embodiment, the first inventory group may comprise all inventoried products. Thus, according to such an embodiment, a customer may select any product in inventory as the first product. Thus the product selected might make no difference as to which products are included in the second inventory group.

However, according to another embodiment, the first inventory group may not include all products. In one embodiment, such a subset may be predetermined (e.g. defined by an operator and/or stored in a memory accessible to the vending machine control system). In another embodiment, the first inventory group may be determined (e.g., determined dynamically) to include products according to sale and/or cost data (and possibly stored rules or other logic mechanisms). Thus, for example, stored rules may provide that only those products selling at or less than a particular actual sales rate are to be included in the first inventory group. In this manner, the vending machine may be programmed to promote certain products in package promotions (e.g., upon selection of a product which is not selling as well as desired).

Step 300: Determine Second Inventory Group Based on Selection of First Product.

At Step 300, the vending machine defines a second inventory group based the customer's selection of a first product. In some embodiments, the vending machine employs one or more rules (e.g., stored package offer rules) to determine which products are potentially eligible to be included in the second inventory group based on the first product (which was selected by the customer). For example, a package offer rule may provide that products from competing manufacturers cannot be purchased together pursuant to a package offer. Accordingly, the second inventory group would not include products which are manufactured by competitors of the manufacturer of the first, selected product. Alternatively or additionally, another package offer rule may provide that the second inventory group includes only products from categories that are “complementary” to the category of the first product. For example, if a customer were to select a beverage as his first product, the vending machine second group may only include products from the snack and gum categories.

Further, a package offer rule may provide that, if the first selected product's actual sales rate is above a certain threshold, only products selling at or less than a predetermined actual sales rate are to be included in the second inventory group. In this maimer, vending machines according to various embodiments may exploit the popularity of a well-selling product to promote the sale of (relatively) less popular products.

Conversely, a package offer rule may provide that, if the first selected product's actual sales rate is below a certain threshold, only products selling above a predetermined actual sales rate are to be included in the second inventory group. In this manner, vending machines according to various embodiments may prompt customers to choose a less popular product in the hopes of a good deal on a more popular product, with an element of chance involved.

Alternatively or additionally, a value rating of each possible second product may be considered, as described above. For example, the vending machine control system may determine the value rating of one or more products and determine, based on stored rules, that only the five products having the highest value ratings may be included in the second inventory group. As in the case of the above-described proactive inventory grouping embodiments, the value rating of each possible second product may be determined, e.g., based on: (1) the product's margin, and/or (2) the product's margin multiplied by its actual sales rate expressed as a percentage of its ideal sales rate.

In an embodiment, the second inventory group may determined before the customer selects the first product, but the second inventory group is only revealed to the customer after the first product is selected.

In an embodiment, a plurality of second inventory groups may be determined. Thus, selection of a product included in any of the second inventory groups would be acceptable. Depending on which of the second groups the second selected products is included in, different actions may be taken (e.g., awarding bonus products or credits, providing entertaining displays or sounds). Thus an entertaining set of interactions can result from differentiating between acceptable second selections.

Step 400: Output Indication of Second Inventory Group to Customer Via Output Device(s).

After the second inventory group is determined, an indication of the products included in the second inventory group is output at Step 400 to the customer via one or more output devices. For example, LEDs located proximately to the products may illuminate or flash. Alternatively or additionally, an LCD may output graphical icons representing the qualifying products included in the second inventory group.

Step 500: Determine whether Customer Selected Second Product from Second Inventory Group and Process Transaction Accordingly.

At Step 500, it is determined whether the customer selected the second product from the second inventory group. If the customer has selected a second product from the second inventory group by, for example, transmitting a signal to the vending machine processor via an input device such as a keypad, then the vending machine processor may actuate product dispensing apparatus to dispense units of the first and second selected products. (Alternatively, the vending machine control system may dispense a unit of the first product upon its selection at Step 200, and dispense a unit of the second product at Step 500 once it has been determined that the customer has selected a product from the second inventory group.)

In some embodiments, this step may be accompanied by payment processing steps, such as the receipt of payment and the dispensing of appropriate change (e.g. based on the difference between any payment tendered and the package price). It should be noted that such an embodiment would allow customers to select first products before depositing any currency, and then see which products are available as second products before committing to purchase any products whatsoever. In this manner, any anxiety caused to customers by virtue of the uncertain composition of the second inventory group can be reduced or eliminated.

In some embodiments, if the customer has selected a product that is not included within the second inventory group, the vending machine control system may output, through an output device, an error message. For example, an LCD may output a message that reads “Sorry, but the item you have selected is not eligible for the package deal. Please select a flashing item to continue or press “no thanks” to purchase your first selection at its retail price.”

In some embodiments, the vending machine control system may be configured to monitor the time starting, e.g., with a customer's initial selection of a first product. If the customer does not select a second product within a predetermined period of time, the vending machine may be configured to, e.g., consummate a transaction for the first product at its retail price, thereby assuming that the customer does not wish to select a second product from the second inventory group and accept a package offer.

Alternatively, at the end of such a predetermined period of time, the vending machine may automatically select and dispense a second product (e.g., a second product selected according to stored rules), and thereby complete a transaction at a package price. For example, stored rules may provide that the product in the second inventory group with the highest/lowest margin is automatically dispensed if no second product is selected within the predetermined period of time. Alternatively, stored rules may provide that the most/least popular product in the second inventory group (e.g. as indicated by its actual sales rate) is automatically dispensed if no second product is selected within the predetermined period of time.

If any products are dispensed at Step 500 (or earlier in the process, according to some embodiments), the vending machine may, as described above, record results of the transaction in a database or similar memory structure (e.g., update inventory records).

### MISCELLANEOUS ALTERNATE AND ADDITIONAL EMBODIMENTS

### Alternate Proactive Inventory Grouping Embodiment—Expected Profitability of Possible “Allocations” Considered

In another proactive inventory grouping embodiment, products are allocated to inventory groups based on the expected or predicted profitability of each possible “inventory allocation”. In other words, unlike the previously-described embodiments in which there are a predetermined or fixed number of product “slots” in each inventory group (e.g., per a stored rule), this embodiment allocates products to inventory groups by evaluating the expected profitability of each possible allocation of products (e.g., to at least two inventory groups).

For example, in a vending machine configured to sell four products (e.g. products A, B, C and D) in package deals from two inventory groups (e.g. red and green), in which all products are allocated to exactly one inventory group and an inventory group must contain at least one product, there are fourteen possible inventory allocations, as illustrated by the table immediately below:

TABLE 10
Allocations

| Allocation | Products in Red Group | Products in Green Group |
|---|---|---|
| 1 | A | B, C, D |
| 2 | A, B | C, D |
| 3 | A, C | B, D |
| 4 | A, D | B, C |
| 5 | A, B, C | D |
| 6 | A, B, D | C |
| 7 | A, C, D | B |
| 8 | B | A, C, D |
| 9 | B, C | A, D |
| 10 | B, D | A, C |
| 11 | B, C, D | A |
| 12 | C | A, B, D |
| 13 | C, D | A, B |
| 14 | D | A, B, C |

As stated, the expected profitability of each possible allocation would be determined. Then, the vending machine control system would select the possible allocation with the highest expected profitability, and communicate a package offer accordingly. For example, if it was determined that Allocation 14 (in which product D is in the red inventory group and products A, B and C are in the green inventory group) is expected to be the most profitable, the vending machine may flash LEDs proximately located to each of the corresponding products in the appropriate colors to indicate that allocation of products to the two inventory groups.

There are many ways that the expected profitability of an allocation may be determined. According to one embodiment, the expected profitability of a given allocation may be determined by summing the expected profitabilities of each possible combination instance within that particular allocation. Thus, in the allocation in which product D is in the red inventory group and products A, B and C are in the green inventory group, the expected profitability for the instances “D with A”, “D with B”, and “D with C” would be individually determined and then added together to determine the total expected profitability of the allocation.

To determine the expected profitability of each instance within a given allocation, a variety of techniques may be employed. According to one embodiment, the expected profitability of a given instance is determined by multiplying the probability that the instance will be accepted within a given period (e.g. within 24 hours) by the margin of the package instance (e.g. the package price less the cost of the component products). In such an embodiment, the probability that a given instance will be selected may be determined based on a stored, received or calculated “acceptance rate” for the instance.

### Multiple Package Offers in Proactive Inventory Grouping Embodiments

In some proactive inventory grouping embodiments, vending machines may be configured to simultaneously (or substantially simultaneously) output a plurality of package offers. Thus, after inventory groups are defined, the vending machine may output package offers that apply to the inventory groups. For example, for particular inventory groups, an offer may provide customers with the ability to choose which of the following to purchase:
(a) two products for a first inventory group for a first package price (e.g. two products from the “green” inventory group for $1.50),
(b) one product from a first inventory group and one product from a second inventory group for a second package price (e.g. one product from the green inventory group and one product from the red inventory group for $1.25), or
(c) two products from a second inventory group for a third package price (e.g. two products from the red inventory group for $1.00).
Any number of offers may be output simultaneously or substantially simultaneously.

In an embodiment, offers are not output simultaneously, but are instead triggered by an event. For example, a single offer may be output after a customer provides payment (e.g., inserts currency). If the customer does not select any product within a certain amount of time (e.g., within 20 seconds of inserting currency, within 20 seconds of the offer being provided) then additional offers may be provided. In such an embodiment, the initial offer may be the most profitable but possibly less desirable to the typical customer (e.g., a relatively high package price, high margin component products), and subsequent offers are less profitable, but more desirable to the customer (e.g., a relatively low package price, low margin component products)

In an embodiment, different sets of offers may be output at different times, according to various desirable factors described herein.

### Alternative/Additional Ways to Present Package Offers

Many alternate or additional methods or formats for communicating package offers are contemplated.

In a proactive inventory grouping embodiment, a list of specific package instances could be output to customers via an output device, rather than (or in addition to) indicating the inventory grouping status of different products. For example, rather than merely outputting an offer that instructs prospective customers to select any “red” and any “green” product for $1, a vending machine may also group certain package instances of “red” and “green” products and communicate the instances via an LCD display. Following the ongoing example from the above description of proactive inventory grouping embodiments (in which Diet Coke®, Doritos®, and Cheetos® were allocated to the red inventory group and Dentyne®, Cheetos®, Double-Mint® and Juicy Fruit® were allocated to the green inventory group), an LCD may output an offer visually representing a grouping of Diet Coke® with Dentyne®. Thus, rather than communicating all possible instances, only a certain number of instances may be shown through an LCD display (e.g. those with the highest or lowest historic acceptance rates). Further, package instances may be communicated through similarly colored LEDs. For example, a particular package instance comprising Diet Coke® and Dentyne® may be communicated by illuminating purple LEDs next to both Diet Coke® and Dentyne®, indicating that the products together comprise a single package instance.

In a proactive or reactive inventory grouping embodiment, customers may be offered the ability to purchase, for a package price, any combination of products whose retail prices total a certain sum. For example, customers may be offered the ability to purchase, for a $1 package price, any two products having a combined retail price of $1.30. Similarly, customers may be offered the ability to purchase any product having a first retail price (e.g. $0.85) and any product having a second retail price (e.g. $0.25) for a single package price (e.g. $1.00).

Further, in a proactive or reactive inventory grouping embodiment, certain (but not necessarily all) products that an inventory group includes may be given a visual preference (e.g. some red LEDs may flash at faster intervals than other red LEDs; some red LEDs may be illuminated brighter than other red LEDs, etc.). Thus, particular products included in an inventory group may be promoted over other products in the same inventory group. For example, products in an inventory group having a higher value rating may be indicated by brighter LED displays than products in that inventory group having a lower value rating. Alternatively, products that are selling at sales rates below a certain threshold may be indicated by brighter LED displays than products that are selling at sales rates above the threshold. This embodiment would help draw greater customer attention to products that are selling relatively poorly.

In yet another alternate embodiment, inventory groups are not dynamically determined (e.g., as in proactive or reactive inventory grouping embodiments), but are rather determined according to stored rules that govern which products may together comprise packages and which may not. For example, in an embodiment, a vending machine may be configured to allow a customer to pick three products for $1.00, provided that no two products are from the same shelf (row) of the vending machine. Thus, package offers may be communicated with fixed signs or other advertising on or around the shelves or the vending machine. In such embodiments, upon selection of a first product, a vending machine may prevent the selection and dispensing of certain products (e.g. products from the same shelf, row or category) as second products. Alternatively, a warning or other indication may be provided to the customer, and the customer allowed to select another product.

### Cross-Machine Promotions

As stated, various embodiments can be configured to work in conjunction with two or more vending machines. Thus, according to some embodiments, pursuant to a package offer, customers may purchase two or more products for a single price, and may select and/or retrieve products from two or more vending machines.

Thus, a customer may view the inventory of two machines (which may be proximately-located), and may accept an offer output from a first machine or output from a peripheral device. The peripheral device may be stand-alone or integrated with one or more of the vending machines. The peripheral may communicate with one or more of the vending machines in nay of a number of well-known manners.

The vending machine or peripheral device may output a code, password, PIN, receipt or other substantially-unique identifier to the customer. This identifier may be redeemed at a participating vending machine, allowing the customer to retrieve products from one or more of the participating machines.

For example, after allocating inventoried products to at least two inventory groups spanning at least two machines using the above-disclosed methods, a first vending machine may output an offer reading “2 for $1! Select any flashing item from this machine AND any flashing item from the adjoining machine for $1.” LEDs located proximately to the qualifying products may flash. A customer may then, after seeing the flashing products, decide to accept the package offer and deposit $1 into the first machine. The customer may then select a first product from the first vending machine, and the first vending machine may then output a (substantially-unique) bar code on a piece of paper (e.g., printed by an on-board printer, preprinted stock dispensed by a dispensing device). The customer could then be instructed, through the first vending machine's output device, to insert the piece of paper into a reader (e.g., ticket reader, bill acceptor, card reader, bar code reader) which is attached to or in communication with the second machine when the customer is ready to select his second product. Upon presenting the piece of paper (e.g., into the card reader), the second vending machine's processor would validate the code by querying either a local database (e.g., of previously agreed-upon codes) or a remote database (e.g., created and stored by the first machine). The second vending machine could then present to the customer the same inventory group as originally advertised at the time of the offer. Thus, the customer may return to select his second product at a later time (even after the second vending machines inventory has been reallocated to new inventory groupings), and the second vending machine could revert back to or recall the previous inventory grouping in effect at the time of the offer. This would allow the customer to select from the options that were originally presented to him (e.g. the products that were previously flashing in red are returned to red status upon presentment of the bar code identifier).

An apparatus and method for processing the sale of two products from two vending machines for a single price is disclosed with reference to U.S. Pat. No. 6,059,142 (to Wittern, Jr. et al.), the entirety of which is incorporated herein for all purposes.

### Display of Retail Prices

In an embodiment, retail prices are not automatically communicated by output devices to customers. Instead, a customer must affirmatively inquire as to the retail price of a particular product. In this manner, customers are encouraged to accept package offers, which are actively promoted by the vending machine's output devices. However, in other embodiments, the retail prices of the individual products may be communicated contemporaneously with the presentation of package offers.

In an embodiment, customers may be permitted or required to select between various modes, such as “retail” and “package” modes, before transacting with the vending machine. That is, before selecting and purchasing any products, a customer may press a button on a touch screen or otherwise indicate whether the customer would like to (1) purchase a package (e.g., two products for $1.00), or (2) purchase one product for that product's retail price.

### Opt Out of Inventory Groups for a Premium

In an embodiment, customers may be offered the option to pay a premium so that they can purchase two or more products from the same inventory group, rather than one from each. For example, a message on a vending machine's touch screen might read: Want two red items? Add $0.25.″ In essence, such an embodiment would give the customer the ability to buy themselves out of the predefined inventory groups and would thereby ensure that customers are given more choice.

### Periodic Random Allocation of Products to Inventory Groups

In an embodiment, one or more random products are allocated to inventory groups (periodically, after each transaction, at random times). This embodiment would tend to keep the inventory groups new and exciting for vending machines with many repeat customers (e.g., vending machines in office buildings). In such an environment, customers may tend to purchase the same products repeatedly. This embodiment thus may positively influence repetitive inventory grouping/allocation patterns.

### Customers Offered Choice between One or Two Products; Confirmation Screens

In an embodiment, vending machine transactions are limited to a certain price, and customers are given a choice between one higher price product, and two or more products from two or more inventory groups. For example, transactions may be limited to purchases of $1.25 and for $1.25 customers may purchase either (1) one (large) bottle of soda, or (2) two (small) cans of soda. Further, in an embodiment, vending machines may be configured to output “confirmation screens” in response to a customer's selection so that a customer must confirm her selection through an input device (e.g. a button) before such selections are accepted and the transactions are consummated.

### Value-Back “Bonuses”

In an embodiment, customers who select two (or more) products as part of a given single-price package offer (e.g. two products for $5) may be offered a “bonus” (e.g. a third product) upon certain conditions (e.g., if certain rules are satisfied). Thus, in some embodiments, when customers select two (or more) products that together represent more than a threshold amount of realizable profit for the machine, such customers are offered a bonus that may be valued at an amount equal to, less than, or greater than the amount of additional realizable profit beyond the threshold amount. For example, if a customer selects two products from an inventory group typically associated with high-margin products, the machine may “give value back” to the customer in the form of a bonus, in order to bolster the goodwill with the customer and hopefully spur future transactions with the customer and favorable recommendations by the customer. Such an embodiment would work particularly well in situations in which a customer selects two products that having retail prices that, when aggregated, are less than the single package price. Thus, the vending machine would not take advantage of the customer's failure to realize the markup.

Bonuses may take many forms, including: (1) printed vouchers or tickets entitling customers to discounts (e.g. for the amount that surpasses the threshold amount) or free products from one or more vending machines in the future; (2) instant cash rebates (e.g. for the amount that surpasses the threshold amount; such amounts may be dispensed through change dispensing apparatus), and (3) extra product(s) (e.g. products which are valued at approximately the amount that surpasses the threshold amount) from the same vending machine or other vending machines.

In an embodiment, where appropriate (e.g., where one or more rules are satisfied, are not satisfied), bonuses may be selected by the customer. For example, the vending machine may output a message to the customer indicating that the customer may “select any additional ‘red’ flashing product”, and the customer's selection of a red product causes a unit of the red product to be dispensed. Further, a time limit may be imposed so that if the customer does not so select an appropriate product within a threshold amount of time (e.g. two minutes after the offer is presented), the vending machine may automatically issue a cash rebate, or provide no bonus.

In an embodiment, where appropriate (e.g., where one or more rules are satisfied, are not satisfied), bonuses may be communicated to customers through game-themed content or interface. For example, utilizing a “Price is Right®” game theme, customers may be given the opportunity to “spin” a “value wheel” for a bonus product by pressing a button on a touch screen. Once the customer has pressed the button, a wheel icon may be displayed as spinning on the touch screen, ultimately stopping on an indication of a bonus to be awarded (e.g. a particular product). Many other game themes are contemplated, including “Wheel of Fortune®”.

### Subset of Inventory Considered in Allocation Process; “Rounded” Allocations

In an embodiment, the vending machine may only consider products placed in a single “column” or “shelf” of the vending machine when determining how to allocate products to inventory groups. For example, in a snack machine embodiment in which a vending machine has several shelves, products may happen to align in several columns. For example, a machine having four shelves, each capable of storing five products (i.e. ten helixes per shelf in a double helix snack machine), would have five columns. The operator may program the machine so that products stocked in the two rightmost columns are to be allocated to the “red” group, and that products stocked in the two leftmost columns are to be allocated to the “green” group. Thus, in such an embodiment, the vending machine would only determine (e.g., dynamically) how to allocate the inventory stocked in the center column to the different inventory groups (green and red).

The vending machine may determine, for example, that three of the five products in the center column are to be allocated to the “red” inventory group. In such embodiments, the vending machine may be further configured to allocate all products in the column to the group that dominates the column. That is, in this example, all products in the center column would be allocated to the red inventory group because a majority (three of the five) products in the center column were initially allocated to the red group. Such a “rounded allocation” may be desirable in some markets, as it would provide a convenient, user-friendly way to communicate inventory groupings to customers. That is, in such an embodiment, customers may easily see that all products on the right of the machine are “red”, while all products on the left of the machine are “green”.

### Transaction Status Messages/Screens

In an embodiment in which customers are permitted to choose two or more products for a single price, one or more output devices may be configured to communicate the status of a transaction to a customer. For example, after a customer selects a first product, an indication of the first product may be communicated to the customer via an output device (e.g. an icon of the selected first product may appear on an LCD display). Further, instructions regarding the selection of a second product may be communicated through such output devices. That is, after a customer has selected a first product from a first inventory group, a message may be output to the customer instructing the customer to select a second product from a second inventory group. For example, after selecting a product from a first inventory group (e.g. a product on a first shelf; a product indicated by a “green” flashing light), the customer may be instructed to pick a product from a second inventory group (e.g. a product on a second shelf; a product indicated by a “red” flashing light).

### Package Offer Row

In an embodiment, a vending machine may be configured dispense two (or more) products from a particular row or other particular location for a single price. Thus, a row of a vending machine may be designated as a “package offer” row, and the vending machine may be configured to consecutively dispense, from such a row, units of two (or more) products upon tender of a package price and selection of a corresponding row identifier (e.g. “A1” may correspond to a package offer row which provides two units of Snickers® candy bars for $1.00). Further, such “package offer” rows may be configured to prevent the dispensing of single units of product for retail prices (i.e. such rows may be exclusively used for package offers).

A package offer row may be stocked with alternating types of products. For example, a Snickers® candy bar may be followed by a Milky Way® candy bar, which is followed by a Snickers® candy bar, and so on. Thus, purchasing from such a package offer row can allow diverse combinations of products (e.g., “A2” may correspond to a package offer row which provides one unit of Snickers® candy bar and one unit of Milky Way® candy bar for $1.00).

In such embodiments, a vending machine may be configured to dispense two (or more) products from a first row for a single price, while dispensing only one product from a second row for a single price. Alternatively, every row in a vending machine may be configured as a “package offer” row.

We claim:

1. A method, comprising:
receiving, from a customer via a vending machine, a selection of a product available for dispensing, thereby defining a first product;
determining a set of entitlement options;
outputting a presentation which indicates the set of entitlement options, in which the presentation is output employing a game theme;
selecting at least one of the set of entitlement options, thereby defining at least one selected entitlement; and
providing the at least one selected entitlement.

2. The method of claim 1, in which outputting a presentation employing a game theme comprises at least one of:
displaying an animated wheel which spins and which indicates one of a plurality of benefits;
displaying a plurality of objects which each selectively conceal an indication of a benefit; and
displaying a plurality of spinning reels which each bear symbols representative of benefits.

3. The method of claim 1, in which selecting at least one of the set of entitlement options comprises:
receiving, from a customer via a vending machine, a selection of at least one of the set of entitlement options, thereby defining the at least one selected entitlement.

4. The method of claim 1, in which selecting at least one of the set of entitlement options comprises:
selecting at least one of the set of entitlement options based at least in part on an input received from a customer.

5. The method of claim 1, in which selecting at least one of the set of entitlement options comprises:
selecting at least one of the set of entitlement options without regard to any input that is received from a customer after receiving, from the customer, the selection of the product available for dispensing.

6. The method of claim 1, in which determining a set of entitlement options comprises:
determining a set of entitlement options based on the first product.

7. The method of claim 1, in which determining a set of entitlement options comprises:
determining a set of entitlement options based on profit inventory management data.

8. The method of claim 1, further comprising:
vending the first product.

9. The method of claim 1, in which the at least one selected entitlement comprises at least one of:
a particular product to be provided in addition to the first product; and
an inventory group from which at least one component product is selected.

10. The method of claim 1, in which the at least one selected entitlement comprises at least one of:
a discount on a product;
a refund on a payment;
a provision of at least one additional entitlement;
a coupon; and
an increase in a credit balance of the vending machine.

11. The method of claim 1, in which providing the at least one selected entitlement comprises providing a product for free.

12. The method of claim 1, further comprising:
updating inventory data to reflect dispensed products.

13. The method of claim 1, in which outputting a presentation which indicates the set of entitlement options comprises:
determining whether to output a presentation; and
outputting the presentation in response to a determination to output the presentation.

14. A method, comprising:
receiving, from a customer via a vending machine, a selection of a first product that is available for dispensing by the vending machine;
determining, based on profit inventory management data, a set of products that are available for dispensing by the vending machine;
outputting a game to the customer;
receiving, via the game, a selection of a product from the set of products, thereby defining a selected product;
vending the selected product, and
vending the first product.

15. The method of claim 1, in which receiving, via the game, a selection of a product from the set of products comprises:
randomly selecting a product from the set of products.
